(19) United States
(12) Patent Application Publication
(10) Pub. No.: US 2012/0205436 A1
(43) Pub. Date: Aug. 16, 2012

(54) SYSTEM FOR ENHANCED BARCODE DECODING AND IMAGE RECOGNITION AND METHOD THEREFOR

(75) Inventors: Glen Thomas, Seattle, WA (US); Scott Michael Palconer, Seattle, WA (US); Edward B. Jordan, Belle Mead, NJ (US); Edmund Michael DelGUERCIO, Chula Vista, CA (US); Joshua Tyler Inman, Chula Vista, CA (US); Andrew Thomas Bolton, Princeton, NJ (US)

(73) Assignee: Augme Technologies, Inc., New York, NY (US)

(21) Appl. No.: 13/396,799

(22) Filed: Feb. 15, 2012

Related U.S. Application Data
(60) Provisional application No. 61/443,716, filed on Feb. 16, 2011.
(60) Provisional application No. 61/454,408, filed on Mar. 18, 2011.

(51) Int. Cl. G06F 17/40

(52) U.S. Cl. 235/375

(57) ABSTRACT

A system for enhanced barcode decoding and image recognition and method therefor. Target image data and ancillary image data are received at a server from a client device. Using the target image data and the ancillary image data, enhancement parameters are chosen to augmenting and/or enhanced the target image data. A code database is queried using the augmented/enhanced image data to identify codes that that match the target image. When multiple possible matching codes are returned in response to the query, a trending pattern associated with at least one of the target image data and the ancillary image is identified and is used to select the most probable match from the multiple possible matches.

### CROSS REFERENCE TO RELATED APPLICATIONS

This application claims priority under 35 U.S.C. §119(e) from provisional application No. 61/443,716 filed Feb. 16, 2011 and from provisional application 61/454,408 filed Mar. 18, 2011. The 61/443,716 and 61/454,408 applications are incorporated by reference herein, in their entireties, for all purposes.

### BACKGROUND

In recent years, the proliferation of mobile consumer electronic and wireless networking technology has allowed the development of a host of business methods that incorporate location awareness for mobile devices. In addition, various advertising systems allow advertisers to place advertisements in contexts with which consumers are interested. Information encoding symbologies, such as barcodes, data matrices and Radio Frequency Identification (RFID) tags, as well as the technology to decode them, has also been developed.

In scanning a code, the code image may not always be recorded faithfully and/or in an ideal and/or suitable condition for decoding and/or matching to associated content. Consequently, without appropriate processing, the code may not be recognized or it may be incorrectly interpreted.

### SUMMARY

Embodiments are directed to providing methods, including both automated and manually provisioned methods, to improve the decoding of a code or an image, to change the image using all available data points to improve decoding in other decode attempts or else to provide a “best guess” as to what the code or image might be.

### DESCRIPTION OF THE DRAWINGS

The accompanying appendices and/or drawings illustrate various non-limiting, examples, inventive aspects in accordance with the present disclosure:

FIGS. 1A-1B are combined logic and data flow block diagrams illustrating a general overview of embodiments of a Code Triggered Information Server (CTIS);

FIG. 2 illustrates a particular, exemplary embodiment of the CTIS, wherein contextual information and advertising is served to the user related to a news article in the business section of a media publication;

FIG. 3 illustrates user trajectories through a network of Ad provider zones;

FIG. 4 illustrates an embodiment of the web interface for user registration;

FIGS. 5A-E illustrate three types of 2D barcodes that may be employed within the CTIS and logic flow for code enhancement according to embodiments;

FIG. 6 illustrates a Scan Message data structure;

FIG. 7A-B are illustrations of a user profile data structure and a user profile user interface a graphical code serving interface (GCSI) used in conjunction with a CTIS according to an embodiment;

FIG. 8 illustrates an Information Base (Ad) data structure;

FIG. 9 illustrates a logic flow diagram of one embodiment of the user profile query heuristic;

FIG. 10 illustrates an exemplary histogram of Ad provider zone breaches;

FIGS. 11A-D illustrate systems for selecting non-triggered information to serve to users according to embodiments;

FIGS. 12A-B illustrate examples of coupons provided by the CTIS;

FIG. 13 illustrates a combined logic and data flow block diagram for an embodiment of the CTIS wherein contextual Ads are replaced by Ads based on ambient conditions;

FIG. 14 illustrates a combined logic and data flow block diagram for a particular exemplary embodiment of the CTIS in which allergy medication Ads are served in response to a high pollen count;

FIG. 15 illustrates a combined logic and data flow block diagram for a particular exemplary embodiment of the CTIS in which sunscreen Ads are served in response to heat and high UV levels;

FIG. 16 illustrates a combined logic and data flow block diagram for an embodiment of the CTIS wherein the selection of contextual Ads is influenced by ambient conditions;

FIG. 17 illustrates a combined logic and data flow block diagram for a particular exemplary embodiment of the CTIS in which an Ad for a luxury convertible is served based on warm weather conditions, a scanned code, and the user profile;

FIG. 18 illustrates a combined logic and data flow block diagram for a particular exemplary embodiment of the CTIS in which an Ad for Florida travel is served based on cold/rainy weather conditions, a scanned code, and the user profile;

FIG. 19 illustrates a combined logic and data flow block diagram for a particular exemplary embodiment of the CTIS in which an Ad for an ice cream shop is served based on warm weather conditions, a scanned code, and the user profile;

FIG. 20 illustrates a combined logic and data flow block diagram for a particular exemplary embodiment of the CTIS in which an Ad for ponchos and umbrellas is served based on rainy weather conditions, a scanned code, and the user profile;

FIG. 21 illustrates a combined logic and data flow block diagram for an embodiment of the CTIS wherein Ads are served to a User Agent device;

FIG. 22 illustrates a combined logic and data flow block diagram for a particular exemplary embodiment of the CTIS in which an Ad for a sports team's season tickets is served along with a pay-per-view event supplied directly to a user's cable box;

FIG. 23 illustrates a combined logic and data flow block diagram for a particular exemplary embodiment of the CTIS in which an Ad for virus scan subscription software is served;

FIG. 24 illustrates a user interface manifesting GCSI/CTIS functionality on a portable electronic device in one embodiment of GCSI/CTIS operation according to an embodiment;

FIG. 25 illustrates a user interface manifesting GCSI/CTIS functionality on digital paper in one embodiment of GCSI/CTIS operation according to an embodiment;

FIG. 26 illustrates a user interface manifesting GCSI functionality on a digital billboard in one embodiment of GCSI/CTIS operation according to an embodiment;

FIG. 27 illustrates a user interface manifesting GCSI/CTIS functionality for serving a short messaging service text message prompt in one embodiment of GCSI/CTIS operation according to an embodiment;

FIG. 28 illustrates a user interface manifesting GCSI/CTIS functionality on a mobile phone in one embodiment of GCSI/CTIS operation according to an embodiment;

FIG. 29 illustrates a user interface manifesting GCSI/CTIS functionality on a portable communication device in one embodiment of GCSI/CTIS operation according to an embodiment;

FIG. 30 illustrates a logic flow for media acquisition in one embodiment of GCSI/CTIS operation according to an embodiment;

FIG. 31 illustrates an illustration of media sampling and full media acquisition in one embodiment of GCSI/CTIS operation;

FIGS. 32A-B illustrate a logic flow for code scan monetization in one embodiment of GCSI/CTIS operation according to an embodiment;

FIGS. 33A-E illustrate aspects of JagTag encoding and codes in some embodiments of GCSI/CTIS operation according to an embodiments; and

FIG. 34 illustrates a computer systemization of the GCSI/CTIS according to an embodiment.

### DETAILED DESCRIPTION

In one embodiment, a code triggered information server (CTIS) interacts with a user (100a) capable of registering interest in an activity, transmitting and receiving data, and displaying information and a server (101) capable of communicating with the user, storing/updating user profiles, and selecting information to serve to the user. In addition, the CTIS enables the creation of at least two types of transactional articles: i) Scan Messages (115) and ii) Reply Messages (145). The CTIS provides context-specific Reply Messages in response to Scan Messages, which are prepared in response to the registration of activity interest by the user, in order to supply information and/or advertising to the user. The CTIS generates Reply Messages by processing Scan Message content with user profile information, containing basic profiling data as well as a history of Scan Messages supplied by a given user. As such, Reply Messages are transactional articles that increase a provider's opportunity to supply relevant and targeted information and/or advertising to the user that is both context and user specific. Without loss of generality, we will heretofore refer to the information and/or advertising content of Reply Messages as “Ads.” Additionally, the CTIS may also elect to send context and user-specific Reply Messages based solely on the user profile, without the user having recently registered activity interest, if it is determined from the user's profile, particularly the history of Scan Messages, that a particular Ad is appropriate.

In one embodiment, users of the CTIS scan codes to register interest and the CTIS acts as a portal for consumers to access information supplemental to the context in which the codes are found. Users may scan codes found in media publications, on billboards or signs, on consumer products or packages, on websites or television screens, other locations. In doing so, the users may identify themselves via an identification code specific to the mobile device and service account with which the scan is made. At the same time, the scanned code can be recorded, as well as the time of day and user location, such information of which may form the basis of consumer profiles that may be saved by the CTIS. As these scans are indicative of interest in various subjects, goods, and/or services, they may serve as a basis for an individual customer tracking system. As such, advertisers can finely tune and efficiently tailor their efforts towards achieving maximum return on the advertising expenditure.

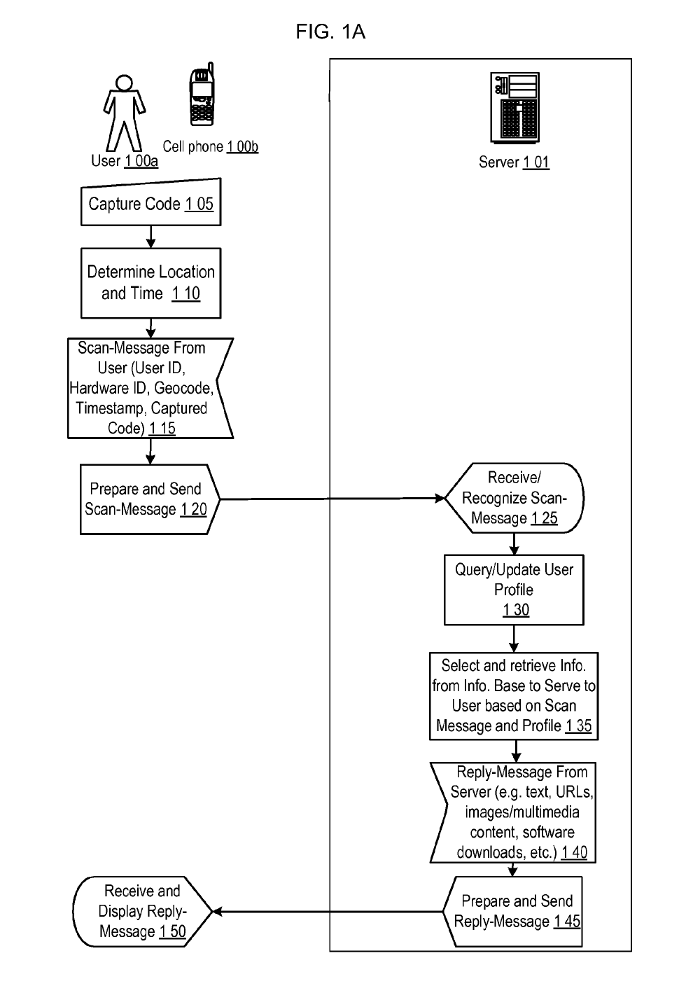

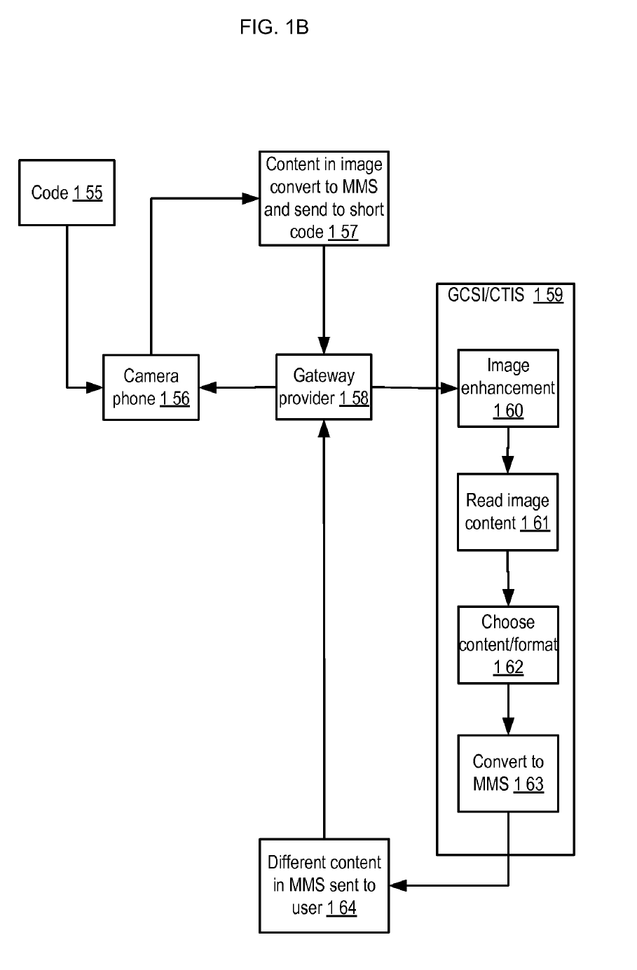

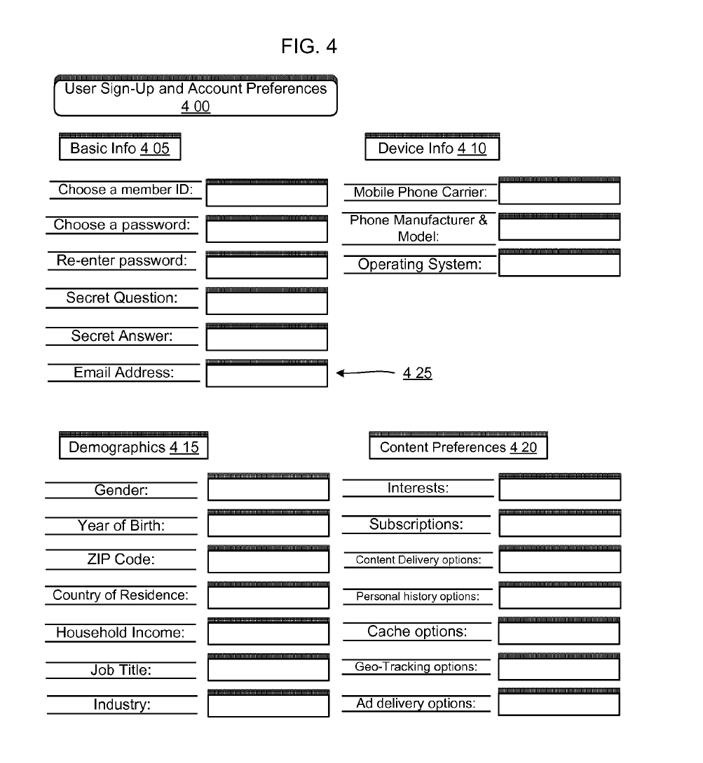

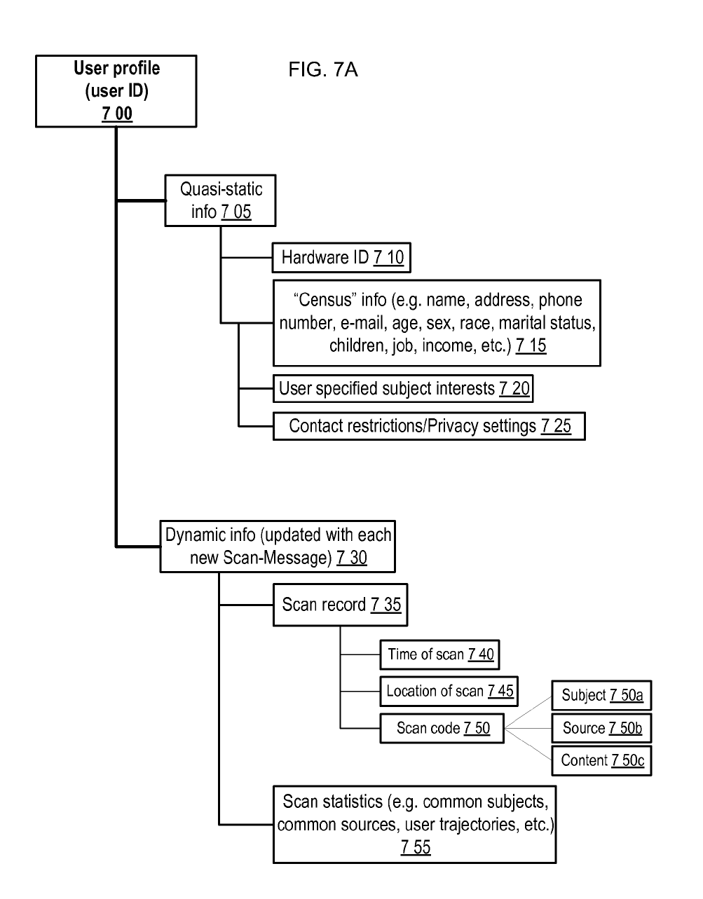

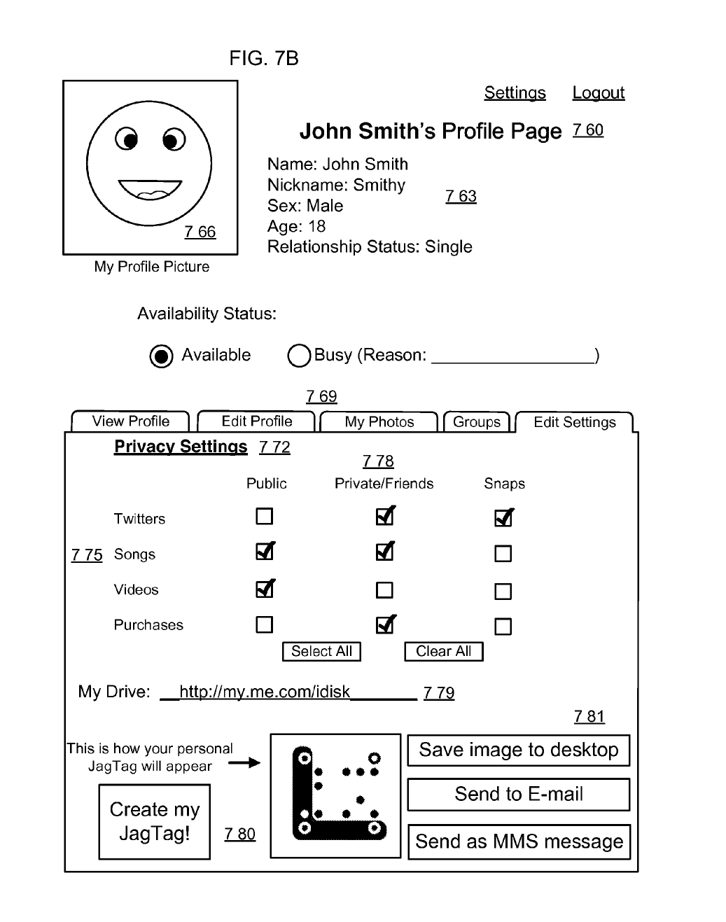

FIG. 1A is a combined logic and data flow block diagram illustrating a general overview of the CTIS in one embodiment. The CTIS may be configured so that a user (100a) may scan a digital code (105) with a scanning device (100b), as for example by using a cell phone camera to scan and/or take a picture of a barcode, 2d code, matrix code, data matrix, QR code, or other such symbology. An example of a mobile device and software capable of such code capture is the Nokia 6600 cellular telephone equipped with ConnexTo software. Alternatively, the CTIS may be triggered by the user selecting an Internet link (such as on an Internet enabled mobile device), by making decisions within a virtual world (such as a massively multiplayer online game), and/or the like. Without loss of generality, all such forms of interest-registering CTIS triggering will be referred to as “code scanning” The time and location (as determined by GPS, GPRS, or other such geo-positioning technologies) of the mobile device are determined (110), and a Scan Message (115) is generated containing a user identification (ID), a hardware ID that identifies the type of mobile device being used, a geocode (location of the device), a timestamp, and the scanned code (see. FIG. 4 and discussion of Scan Message below). Additional user-input information may also be supplied at this point. The Scan Message is packaged and sent (120) to a server (101) that receives and recognizes it (125). The user's profile, specific to the supplied user ID, is updated with the new Scan Message (i.e., it is added as a transaction to their profile transaction history) and queried (130) for information to use in the preparation of a Reply Message (140) that is also based on the content of the current Scan Message. The server selects (135) the Ad content (see FIG. 7) of the Reply Message (145) from an Information Base and sends it to the user's mobile display device, which displays the pertinent content to the user (150).

In one embodiment, the Scan Message and/or scanned code may be sent to the server (101) by a Multimedia Messaging Service (MMS) protocol. In other embodiments, a wide variety of other communication protocols may be employed, including, but not limited to, Short Messaging Service (SMS), instant messaging, web browser based messaging, e-mail, Enhanced Messaging System (EMS), TCP/IP, WAP, and/or the like.

In one embodiment, the server (101) may be addressed by a short code, short numbers, Common Short Code (CSC), and/or the like for sending the Scan Message and/or scanned code. For example, a short code may appear alongside a code in a print publication, and a user may be informed that the scanned code should be sent to the indicated short code number in order to retrieve a Reply Message, advertisement, coupon, and/or the like. In other embodiments, other addressing means may be employed, such as an ordinary telephone number, an e-mail address, a universal resource locater (URL), and/or the like. In another embodiment, the short code and/or other server address may be encoded within part of the code itself. When the user scans the code with his or her mobile device, the code may be partially decoded by the client device to extract the address and automatically send the rest of the code thereto.

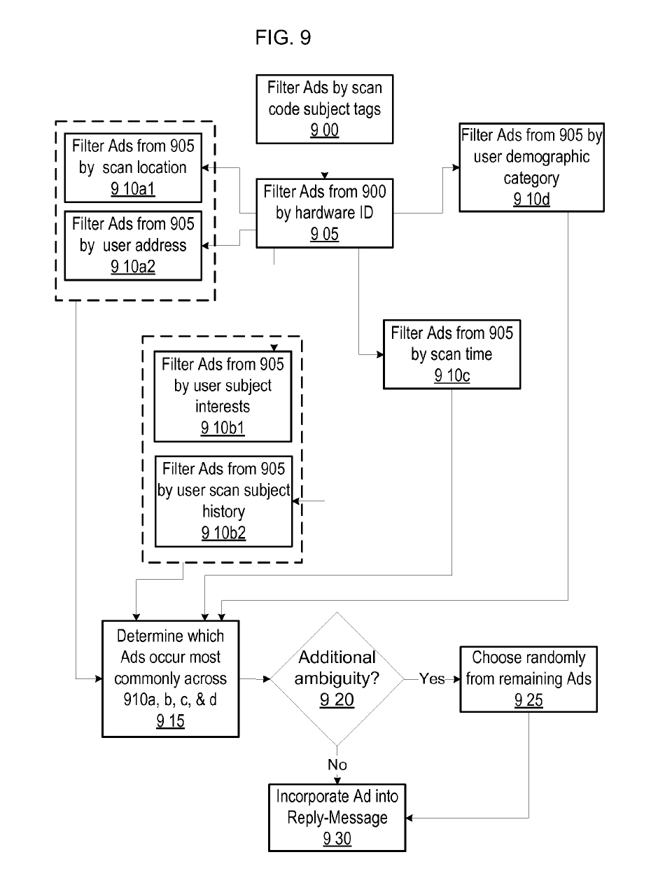

FIG. 1B illustrates a combined logic and data flow of CTIS operation. A code (155) is scanned by a camera phone (156), and the resulting image content is converted to an MMS format to be sent via short code (157) through a gateway provider (158) to the CTIS (159) server. At the server, the image information may be enhanced, manipulated, and/or otherwise processed (160) so as to aid in determining the appropriate content to serve in response. After enhancement, the image content is read (161) and the content and format for the appropriate response is determined (162) (see e.g., FIGS. 9-11). A response message is formed in MMS format (163) and is sent (164) back to a gateway provider (158) to be served to the user's camera phone (156).

In an alternative embodiment, the scanned code may be directly decoded on the client mobile device instead of on the server. The decoded content may then be converted to MMS format and sent via short code to the server in order to retrieve the appropriate content associated with the code. That content may be returned from the server to the client mobile device by means of an MMS protocol as well.

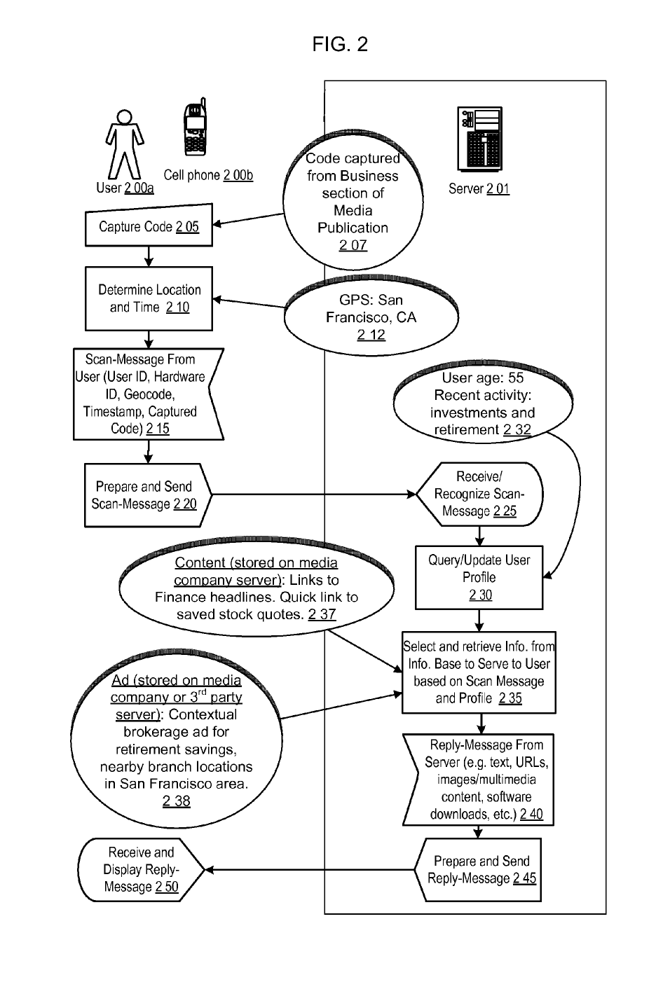

For illustration, the CTIS is shown in FIG. 2 for a particular, exemplary embodiment providing targeted and contextual information and advertising to the user related to a news article. Here, a user employs a cell phone to scan a code associated with an article in the Business section of a media publication (207), such as by using the phone's built in camera to photograph a 2D matrix code (e.g., QR code). The location of the scan (e.g., San Francisco, Calif.) is determined by the phone's built in GPS receiver (212), and this location is incorporated as a geocode, along with the user ID, the hardware ID of the particular type of device (e.g., cell phone) used, the time, and the code content, into a Scan Message. This is sent to a server via the cell phone's data connection (e.g., wireless Internet systems such as 1xEV-DO), and the server queries a database of user profiles based on the supplied user ID in order to update the appropriate user profile with the content of the current Scan Message and to determine what, if any, information in the user profile may be relevant to the preparation of the current Reply Message. Here, the server recognizes that the user is 55 years of age and has recently been scanning articles and/or ads related to investments and retirement planning (232). In one embodiment, the user can supply a list of interests to be considered in addition to those culled from their scan history. The server selects the appropriate Ad content to include in the Reply Message, comprised in this case of links to Finance headlines, quick links to saved stock quotes (237), and a contextual brokerage advertisement (238), including information on branch locations in, e.g., San Francisco (212) near the user. This reply is sent by the server to the user's mobile device which displays the appropriate message content.

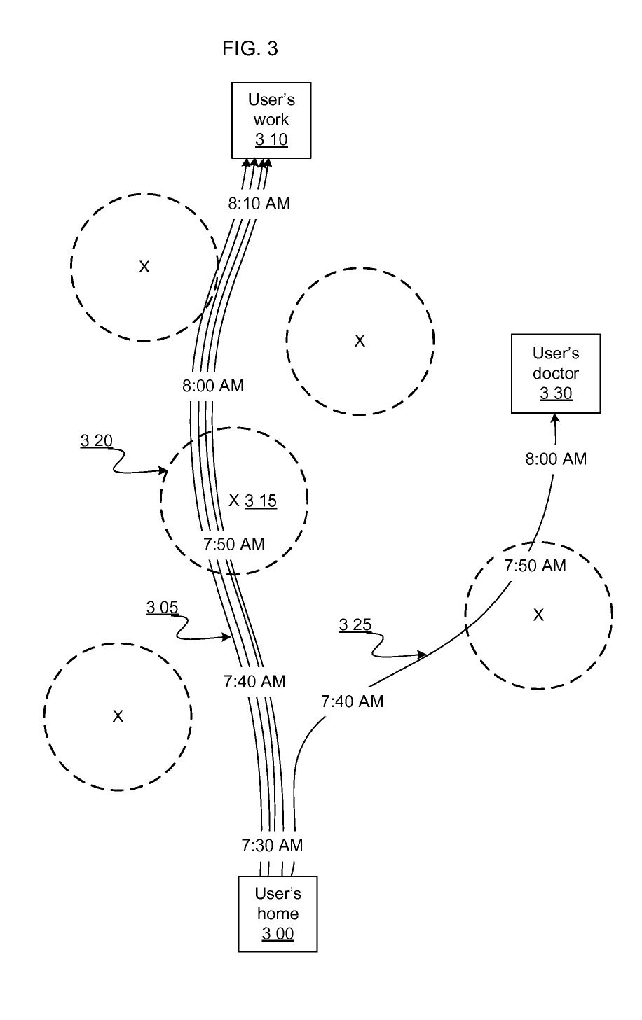

In one embodiment, the CTIS can serve information to the user based on the collected knowledge of user space-time trajectories contained in the user profile, without the need for any initiating code scan. This embodiment is best illustrated by example, as drawn in FIG. 3. Here, a user rides a bus from home (300) to work (310) on four of the last five days, and takes a different bus to his doctor's office (330) on the remaining day. The space-time trajectories for the four work trips (305) and the one doctor trip (325) are determined by codes that the user scans with his cell phone from a newspaper during the bus rides. In this example, the user is assumed to scan a code every ten minutes starting at 7:30 AM until the destination is reached, and the geographic location of each scan is indicated by the position of the timestamp along each trajectory. In one embodiment, tracking occurs without scanning, simply by having the device send geocodes and timestamps by itself. Along the way to his destinations, the user passes a number of Ad providers (marked with X's) with Ad content in the CTIS Information Base, with dotted circles indicating the locus of points that are a distance of two miles from each provider. One Ad provider in particular (315), a gourmet coffee shop, is within two miles (320) of the user's space-time trajectory at 7:50 AM in four of the last five days. The user's profile also lists “coffee” as an interest, both based on user specifications during registration and on the user's advertisement and article scan record. Consequently, on the sixth day, the server supplies the user with an advertisement for the coffee shop (315) at 7:45 AM.

The CTIS may be enabled by the participation of Ad providers and users. In one embodiment, Ad providers supply Ads for storage on the CTIS. In an alternative embodiment, the Ads are stored on third party servers that are referenced by the CTIS. The user experience may be enhanced by the incorporation of personal preferences and demographic information to optimize the targeting of Ad content. Consequently, one embodiment would incorporate a user registration procedure. Users may register for the CTIS via the Internet, telephone, postal mail, and/or the like. If a particular embodiment of the CTIS requires client software for the user to install, this could be supplied upon successful user registration. FIG. 4 illustrates an exemplary embodiment of a user registration interface (400), wherein a user can input Basic Info (405) (e.g., member ID, password, secret question/answer, e-mail address, etc.), Device Info (410) (e.g., mobile phone carrier, phone manufacturer & model, operating system, etc.), Demographics (415) (e.g., gender, year of birth, zip code, country of residence, household income, job title, industry, etc.), and Content Preferences (420) (e.g., interests, subscriptions, content delivery options, personal history options, cache options, geo-tracking options, ad delivery options, etc.) in a plurality of fields (425). In an alternative embodiment, a basic user identification packet (e.g., a “cookie”) is sent with a user's first code scan, thus establishing a basic user profile that can be filled in with greater detail at a later time.

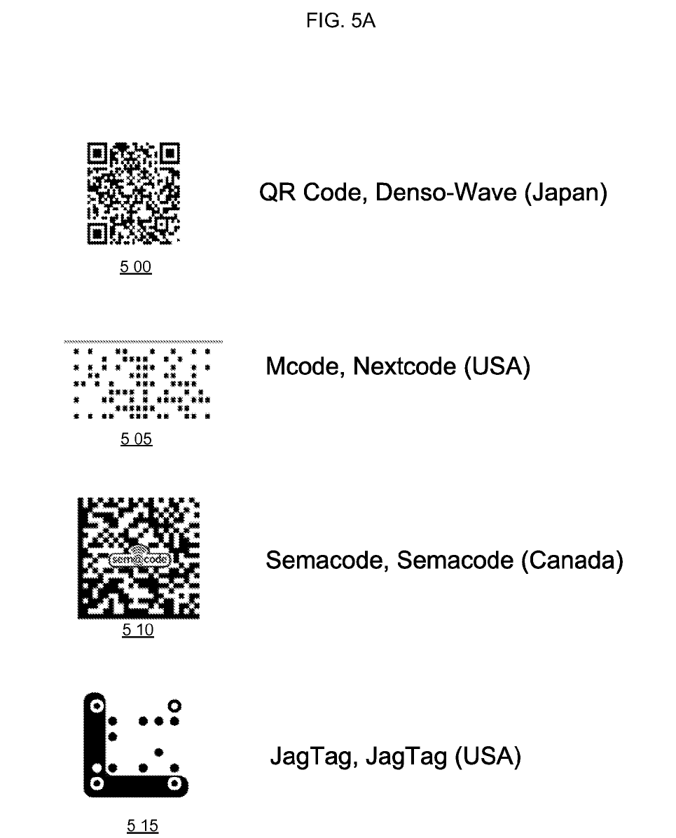

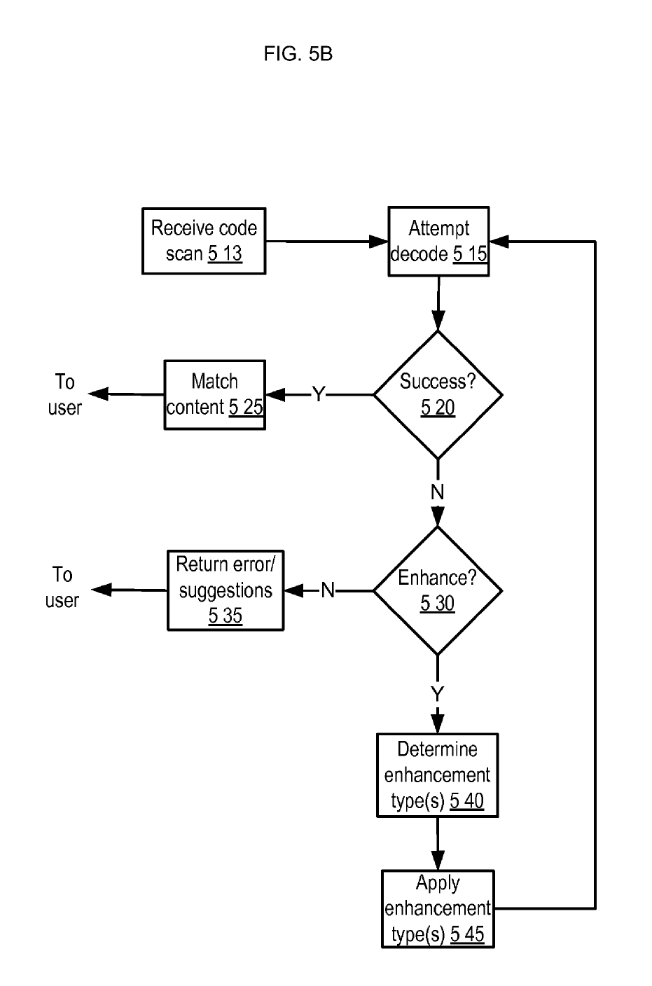

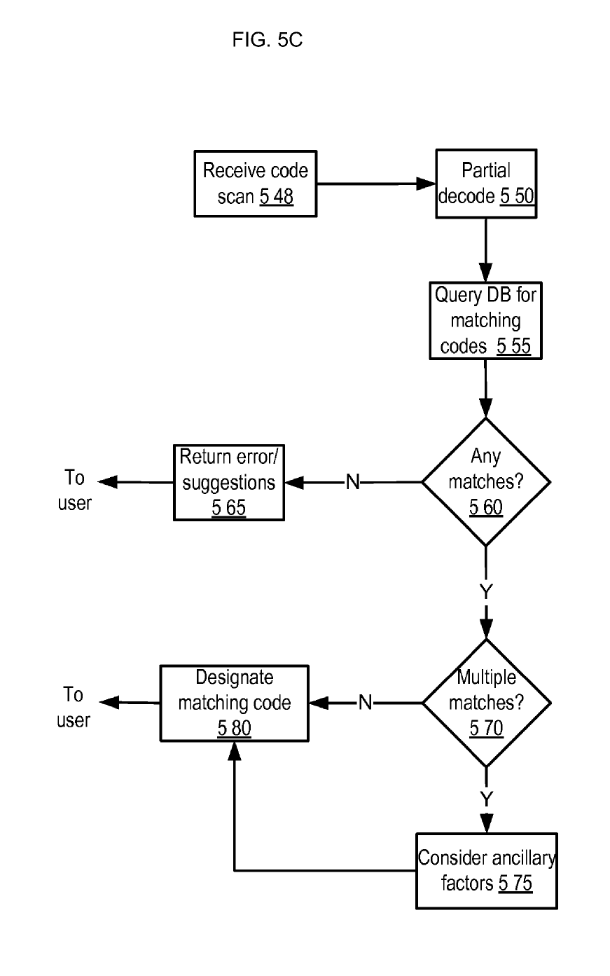

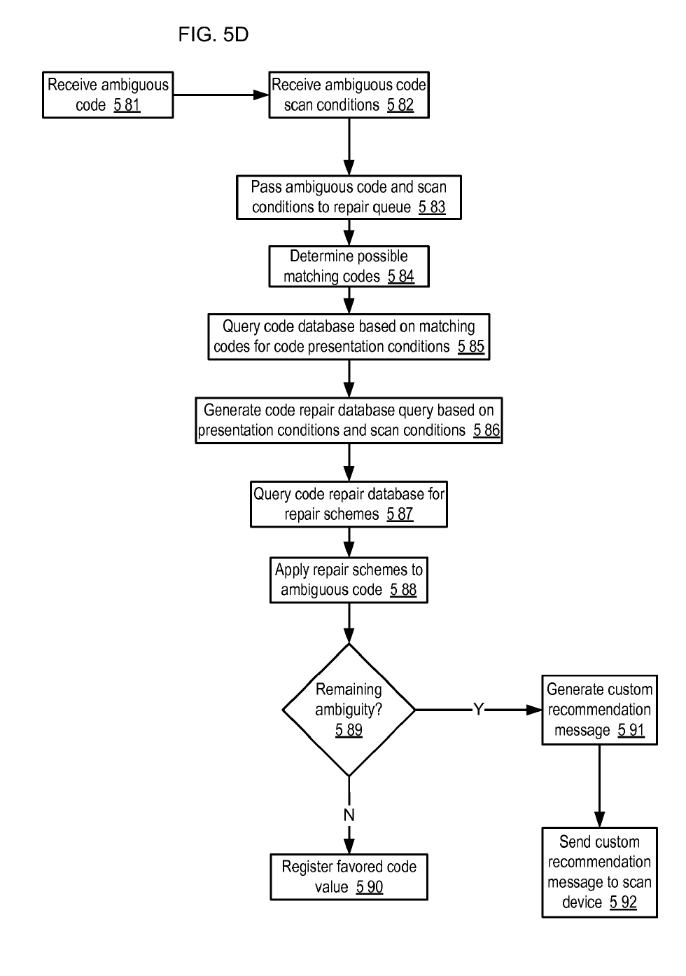

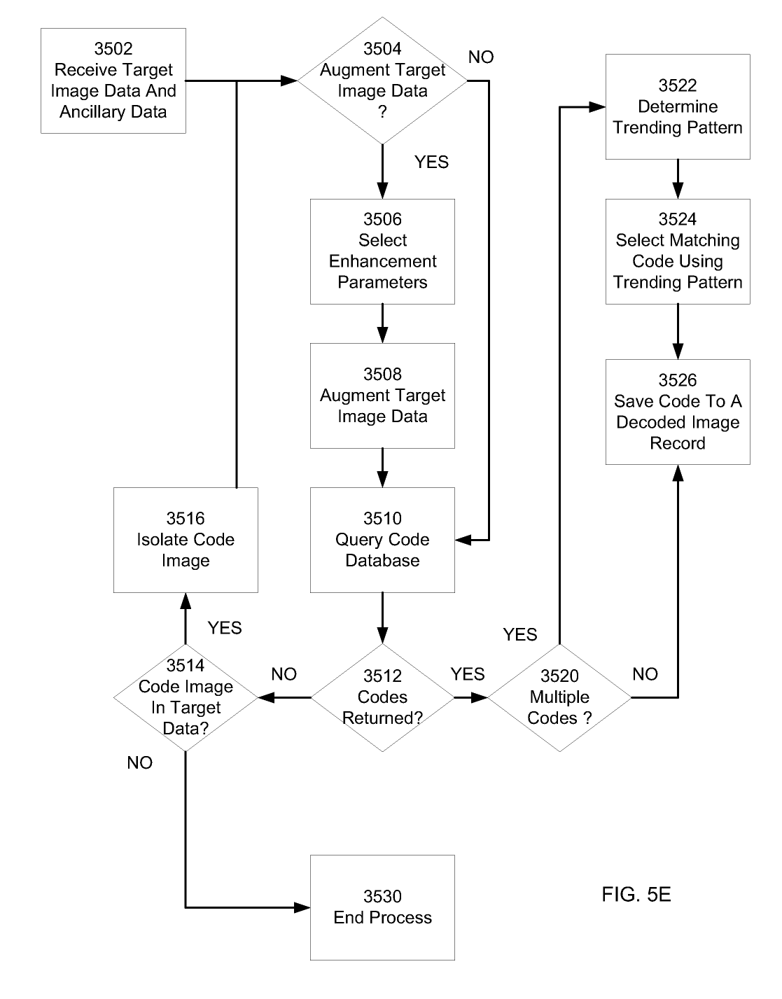

Scannable codes may be found in a variety of locations, including, but not limited to, newspaper and magazine articles, signs and billboards, flyers, store locations and kiosks, consumer products, packages, clothing, stickers, websites, software displays, television broadcasts, virtual worlds, and/or the like. The nature of the code and associated method with which the code can be scanned depends, to some extent, on where the code is found, but among the possible types of codes are standard barcodes (e.g., UPC, EAN, Code 128, etc.), 2D matrix codes (e.g., QR code, Semacode, Data Glyphs, mCodes, etc.), user-input codes (e.g., text messages), RFID tags, pure images (e.g., an image of a sign to be analyzed by optical character recognition), website links, software inputs, and/or the like. These codes may be located on any medium, e.g., on newspapers, magazines, books, video content, computer screens, embedded in objects (e.g., RFID tags on clothes, etc.), and/or the like. One embodiment employs 2D matrix codes, examples of which are provided in FIG. 5A, due to their large data capacity, ease of scanning, and resilience to damage or error. These examples include QR codes (500), Mcodes (505), Semacodes (510), JagTag code (515) and/or the like.

When scanning a code, the code image may not always be recorded accurately. For example, the code may not be in and ideal condition to be scanned. Further, it may not be in a suitable condition for decoding and/or matching to associated content. Consequently, in an embodiment, the CTIS may be configured to enhance and/or otherwise process a code image in order to better recognize the code. FIGS. 5B-C illustrate logic flows for processing and/or managing code scans in embodiments of CTIS operation. Referring now to FIG. 5B, a scanned code is received at the CTIS (513) and a first attempt is made to decode a received code scan (515). In one embodiment, a received code scan may take the form of a bitmap image and/or a compressed bitmap image. If the decoding is successful (520), then the code is matched to associated content (525) that is ultimately destined to be served to a user. Otherwise, a determination is made as to whether enhancement should be applied to the scanned code (530). If not, then an error message and/or suggestions on how to improve the quality of the scanned code may be returned to the user (535). The CTIS may decide not to apply enhancement, for example, if enhancement has already been applied unsuccessfully to the same image before or if the quality of the image is so poor as to be clearly beyond improvement. If enhancement is to be applied, then the CTIS determines the appropriate enhancement type (540) based, for example, on the quality and character of the scanned code image and subsequently applies the enhancement (545), after which a new attempt is made to decode (515) the scanned code.

The repair schemes may be adjusted based on feedback received from users about which codes they were actually trying to scan. In one embodiment, the GCSI/CTIS may provide a query message to a user presenting a summary of content associated with alternative matching codes in order to determine which content the user was actually trying to access.

In some embodiments, multiple enhancement processes may be applied against a scanned code and the results compared in order to determine the encoded content. Prior to enhancement, the image may be downsized if necessary for speed of processing in applying multiple enhancements against the image. Image quality may also be increased, if necessary, in order to more successfully complete initial decoding or for applying enhancements. For code images having extraneous information and/or noise, an enhancement process may be applied to remove all extraneous information, despeckle, and/or the like. For code images having shades of gray and/or shadows obscuring the encoded content, an enhancement process may be applied to manipulate the contrast and/or brightness of the image in order to create a pure black and white image for cleaner decoding. For code images that are tilted and/or not taken flat in a plane, an enhancement process may be applied to tilt the plane of the code to create a flat plane, eliminate “keystoning” and to aid in successful decoding. For code images that are rotated or skewed, an enhancement process may be applied to de-rotate, de-skew, and/or otherwise recreate proper rectangular pixel groupings that can be decoded. For code images that are taken out of focus, an enhancement process may be applied to sharpen the image into recognizable pixel groupings. Additionally, the CTIS may apply edge recognition processes to the code image to create a set of potential code images that can be processed and compared to records in a code database. These image enhancement techniques are not meant to be limiting. Other types of image enhancement known in the art will also find use in clarifying scanned code images.

In some cases in which full decoding of a scanned code image is not accomplished, a partial decoding may be accomplished and content may be served based on that partial decoding. A partial decoding may, for example, result in a probabilistic code match without ever successfully decoding the complete code. FIG. 5C illustrates a logic flow for partial decoding in one embodiment of CTIS operation. A scanned code image is received (548), partially decoded (550), and the partially decoded content used to query a code database to find matching codes comprising at least the partially decoded information (555). A determination is made if any matches exist (560) to the partially decoded information and, if not, then the CTIS may return an error message to the user and/or make suggestions about how to improve the image of the scanned code (565). If a match is found for the partially decoded information, however, then a determination is made as to whether there are multiple matches (570) for that partially decoded information. If so, then the CTIS may consider ancillary factors (575) in attempting to isolate a single code as the most likely match to the received code. Such ancillary factors may include, but are not limited to: the incoming phone number, the carrier, the time of day, current code traffic, the source of the code, the context of the code, the user ID, the hardware ID, the user behavioral history, the user location, and/or the like. In considering ancillary factors, the CTIS is thus capable of predicting the true code based on knowledge of the user who is scanning the code, the context of the code, ambient factors, and/or the like. Once a code has been identified via this probabilistic determination, this is designated as the matching code (580) and the CTIS proceeds with determining the appropriate associated content to serve to the user.

In an illustrative example of partial decoding, a given matrix code may encode the string ABC123. In multiple processes, it may be determined that the code contains A.sub.--1.sub.--3 (where the blanks represent unknown values), _C1_, and AB_. Through these multiple processes, the CTIS system now knows that the code contains ABC1.sub.--3 and may check this against codes in a code database to determine how many matches exist. If it finds two matching codes (e.g., ABC123 and ABC143), it may consider ancillary factors. For example, ABC123 may correspond to an advertisement for a new action movie while ABC143 corresponds to a coupon for women's cosmetics. If the user supplying the code is determined, based on a supplied user ID, to be a man with a history of scanning movie-related codes, then the CTIS system may infer that ABC123 is the matching code and serve the corresponding content. In one embodiment, the CTIS may further supply a confirmation request for partially matched codes, requesting the user to affirm or deny that the supplied content is, in fact, the content that he or she was seeking.

FIG. 5D illustrates a logic flow for customized repair and/or decoding of obscure or ambiguous scanned codes. An ambiguous code may be received at a graphical code serving interface (GCSI) that is in communication with a CTIS system (581), such as may be sent via a communications network from a user's mobile scanning device. In one embodiment, a scanned code may be qualified as an ambiguous code if an attempt to decode the code does not yield a single result. In one embodiment, the system may also receive code scanning conditions (582) describing any of a variety of circumstances of the code scan which may affect the quality and/or fidelity of the scanned code. For example, some relevant circumstances may include the time of day, light levels, use of flash, mobile scanning device type and/or characteristics, code size, contrast, brightness, sharpness, skew, rotation, and/or the like. The ambiguous code and scan conditions may then be passed to a repair queue (583), whereby the system may analyze the ambiguous code and attempt to discern the correct decoded content. A plurality of possible matching codes is determined (584), and a code database is queried (585) to extract code presentation conditions corresponding to each of the plurality of matching codes. Code presentation conditions may describe how and where the code was displayed and may comprise a wide variety of factors, such as but not limited to medium (e.g., newspaper, glossy paper, product packaging, television display, website, billboard, and/or the like), likely obscuring factors (e.g., glass covering, tears, distance, and/or the like), and/or the like. The GCSI/CTIS system may then generate a code repair database query based on the presentation conditions and/or scan conditions (586) and query the repair database to extract repair schemes (587) corresponding to the particular presentation and/or scan conditions. For example, a particular code repair scheme may be tailored for and/or correspond to codes displayed on billboards that are scanned after dark by Nokia mobile phones. Extracted repair schemes corresponding to each of the possible matching codes are applied to the ambiguous code (588), and a determination is made (589) as to whether any one of the possible matches is now more likely to be correct than the others. This determination may be made, for example, by measuring the fidelity of codes with various repair schemes applied and selecting as the correct code that which has the highest resulting fidelity. If no remaining ambiguity exists as to the correct code, then the favored code is registered with the GCSI/CTIS system (590). Otherwise, the GCSI/CTIS may generate a custom recommendation message (591) and send the message to a user and/or a user's mobile device (592).

The custom message may, for example, provide tailored recommendations on how the user may improve the fidelity of the code scan based on the possible matching codes and the associated presentation conditions and/or scan conditions. Tailored recommendations, as well as the repair schemes themselves, may be adjusted based on feedback received from users about which codes they were actually trying to scan. In one embodiment, the GCSI/CTIS may provide a query message to a user presenting a summary of content associated with alternative matching codes in order to determine which content the user was actually trying to access. It should be noted that code analysis and/or repair may be undertaken on a code image level, alphanumeric string level, binary string level, and/or the like basis. Combinations of such bases may also be undertaken, such as by first analyzing the ambiguous code in its alphanumeric string form and then, if ambiguity remains, analyzing the code in its binary form. Further discussion on such an analysis is provided below.

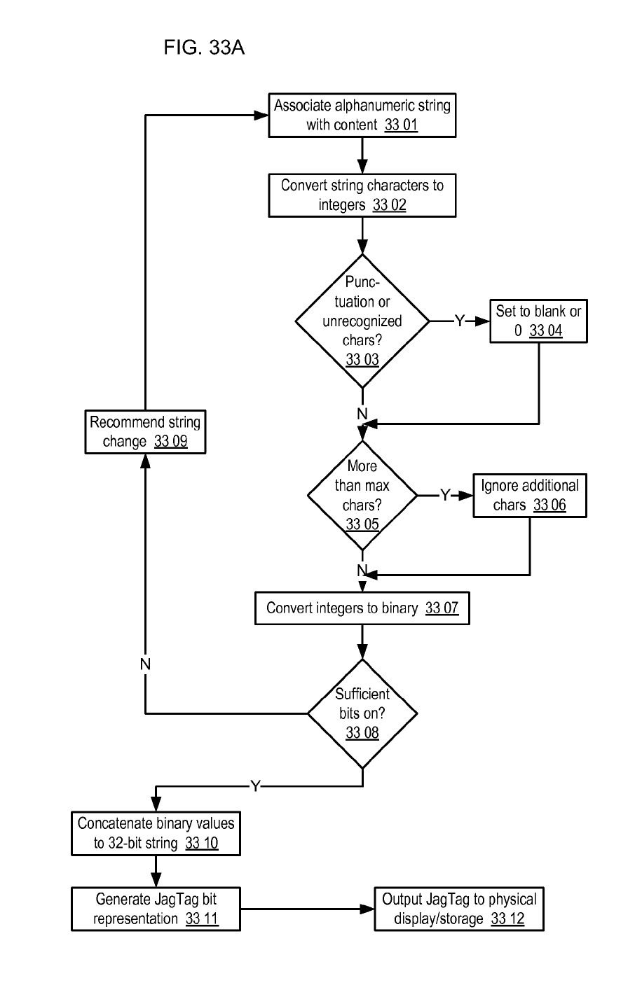

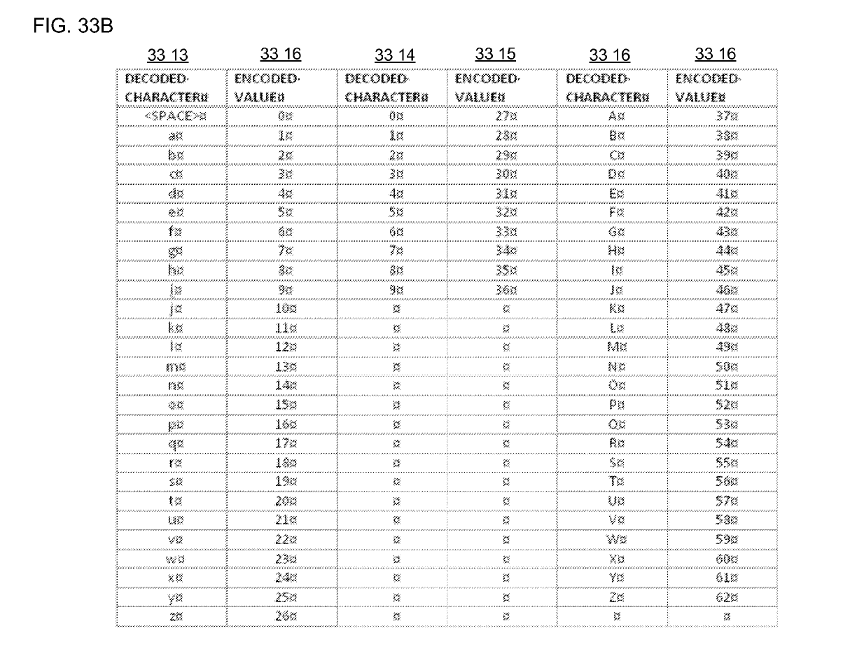

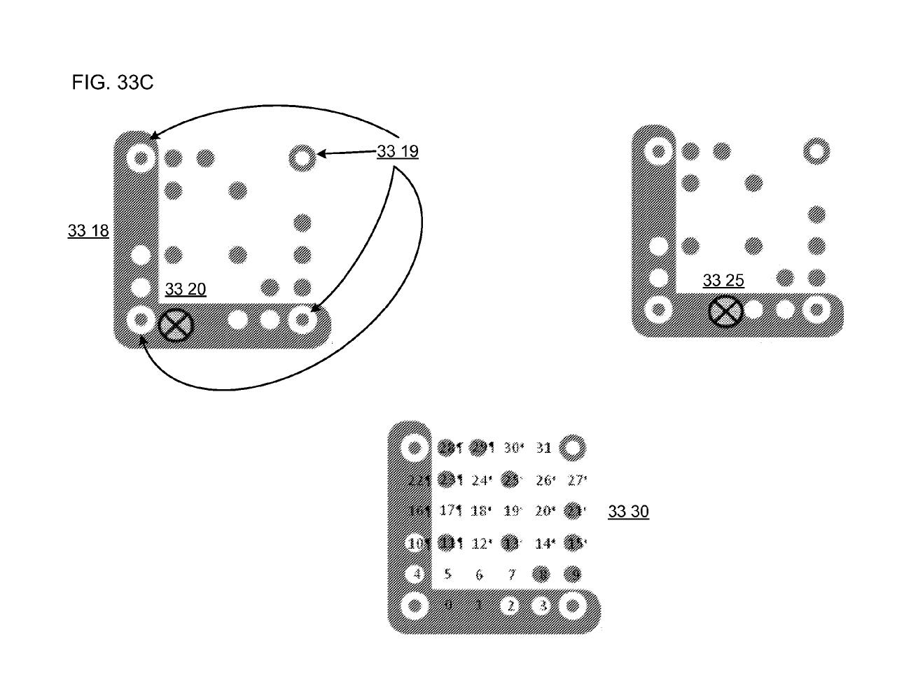

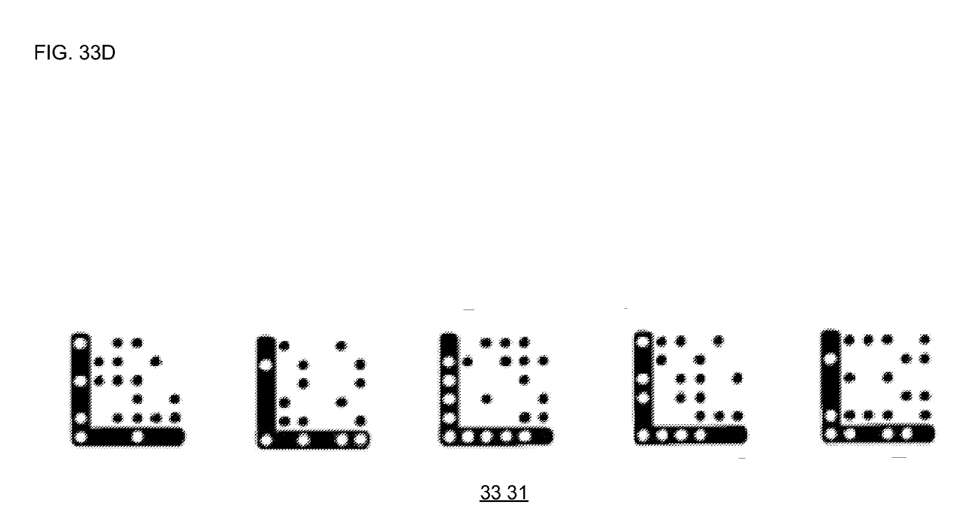

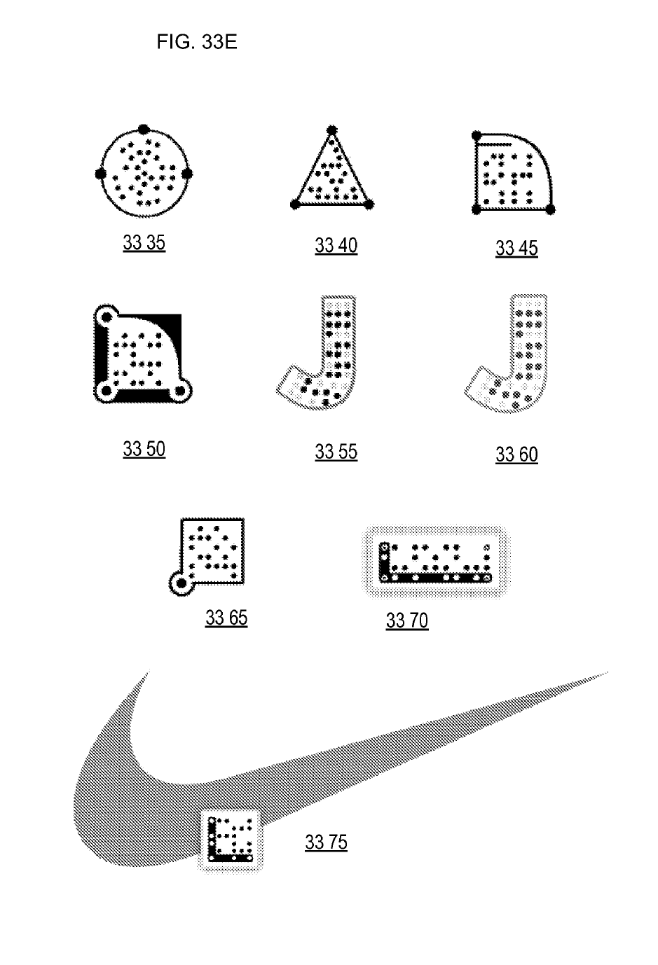

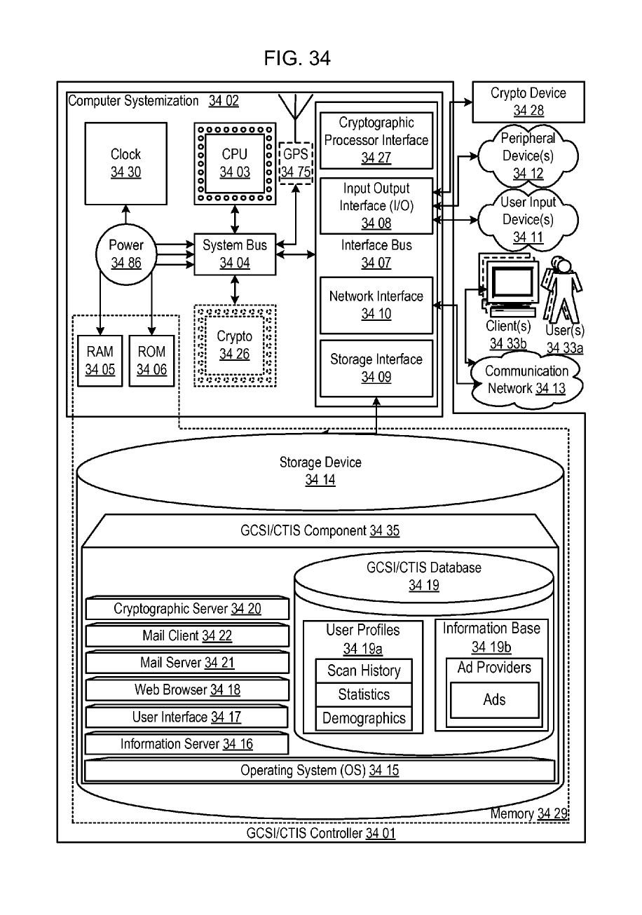

In one embodiment, analysis of ambiguous codes may comprise a two-stage process. In a first stage, an encoded string comprising a number of alphanumeric characters, one or more of which may be unclear, may be compared to a database of alphanumeric strings to determine which, if any, match. In one embodiment, a Levenshtein distance metric may be employed to determine the similarity of an input string to strings existing in the database. In one embodiment, the input string may only be compared against “live” strings in the database (i.e., strings that are currently engaged in active use and/or tied to actual content). If ambiguity remains about which code has been scanned after this character-based analysis, a GCSI/CTIS system may apply a second stage of analysis, whereby the input alphanumeric string is converted into a corresponding binary bitset array (see, e.g., FIGS. 33A-B and associated discussion below) and a comparison is performed between binary values of the input string and the strings stored in the code database. The most significant bits come first in the bitset array while the least significant bits come last, so priority weighting may be applied against potential value matches based on which bits match between the input and stored strings.

FIG. 5E is block diagram illustrating a process flow for enhancing and resolving ambiguous codes according to embodiments.

Target image data and ancillary data are received (Block 3502). A determination is made whether to augment or enhance the target image data (Block 3504). If the determination is not to augment or to enhance the target image data, that is, the result of Block 3504 is “NO,” the image data are used to query a code database (Block 3510). If the determination is to augment or to enhance the target image data, that is, the result of Block 3504 is “YES,” the enhancement parameters are selected (Block 3506) and the target data is enhanced or augmented (Block 3508). The code database can then be queried using the augmented image data (3510).

As discussed above, the CTIS may use image pre-processing to enhance images in order to generate an enhanced image that can be decoded or used to gather more information from the image to improve decoding. Image pre-processing includes, but are not limited to, image enhancements such as manipulating desaturation, rotation, skew, color levels, contrast, brightness, sharpen, blur, resizing, etc. In an embodiment, these image enhancements may be targeted in various configurations based on a variety of variables including but not limited to device type, time of day, type of image type, surrounding layout, etc.

In another embodiment, the CTIS may use ancillary data, both from the image as well as the incoming reception method, such as surrounding layout, geographic information, kind of blur, time of day, information wrapped around the code, IP address information, etc., in order to take image enhancing actions for resubmission to the decoder. This information may also be used to make comparisons with historically successful, unsuccessful, and/or corrected decode attempts. The ancillary data may comprise data purposefully added in and/or around a tag (borders, text, etc) and the detection and classification of naturally occurring ambient data such as color, brightness, angle, skew, setting, noise, artifacts etc.

As noted above, a code database (Block 3510) is queried using the target image data from Block 3504 or the augmented/enhanced image data from Block 3508.

A determination is made as to whether the target image data or the augmented/enhanced image data match codes held in the code database (Block 3512). If the determination is that no codes match the target image data or the augmented/enhanced image data, that is, the result of Block 3512 is “NO,” a decision is made as to whether a code image is contained in the submitted data (Block 3514). If the determination is that no code image is contained in the submitted data, that is, if the result of Block 3514 is “NO,” the process ends (Block 3530). If the determination is that a code image is contained in the submitted data, that is, if the result of Block 3514 is “YES,” processes are applied to isolate the image and to resubmit the isolated image to Block 3504.

In embodiment, the CTIS may use error data provided by decoders to take various actions on images to improve the ability to decode a code or image and/or to provide a “best guess” as to what the code or image is. A non-limiting example of this may be when a decoder provides error information that a code is in the image but it cannot be decoded. In this case, the system may manipulate the image by finding the code, cropping out the rest of the image and then resubmitting to the decoder. In one embodiment of the CTIS may improve decoding in images where a code takes up a small portion of an overall image or else the surrounding layout creates interference with the decoder.

Returning again to Block 3512, if the determination is that codes match the target image data or the augmented/enhanced image data, that is, the result of Block 3512 is “YES,” a decision is made whether multiple possible code matches have been returned by the code database (Block 3520). If the determination is that only a single code matched the submitted data, that is, if the result of Block 3520 is “NO,” the single matched code is stored in decoded image record (Block 3526).

If the determination is that multiple codes possibly matched the submitted data, that is, if the result of Block 3520 is “YES,” a trending pattern is determined Block 3522. For example, trends may be discerned from statistics of successfully, unsuccessfully, or corrected decoded incoming codes. Trends may also be identified in a scan location, such as an event venue, and a currently popular code scan, such as code relating to a new album or video. A code that is consistent with the trending pattern is selected (Block 3524) is saved to the decoded image record (Block 3526).

By use of the techniques noted above, codes that are ambiguous may benefit not only from pre-processing but from the use of trend data to improve the likelihood that the image data is associated with the correct code. Such trend data may also comprise real-time recognition of trending patterns to provide a probability distribution of potentially matching codes.

Trends may also be identified to relate ancillary data to a particular code. For example, a scan that originates at a particular time of day from a particular location may be associated with a particular code scanned at that time and location by other devices. The trending data enhance the selection of the code that best matches the image data.

In another embodiment, the CTIS may enhance and/or reinterpret data stored within a two-dimensional barcode from internal and/or external data sources based on some aspect of the original encoded data. In some implementations of such embodiments the enhanced data may be generally meaningful in a raw decode process. The enhancement and/or reinterpretation of data and presentation of that data may be executed within various alternate embodiments of the CTIS. Some non-limiting examples of the immediately aforementioned embodiment may include:

Using part of a URL as a key, such as converting http://jagta.ag/12345 to lookup key “12345” in the CTIS, which may trigger the sending of a media form (e.g., video, image file, music file, social media output, etc.) instead of the raw URL. In another example, http://jagta.ag/12345 may be navigated to a variation of the content.

Using a URL http://www.facebook.com/user1 to trigger the return of the URL wrapped in a Facebook theme.

Using a URL http://www.twitter.com/user1 to grab user's picture instantaneously and/or automatically from Twitter and return it along with the decoded URL.

Using a general URL to grab a favicon to return with the URL.

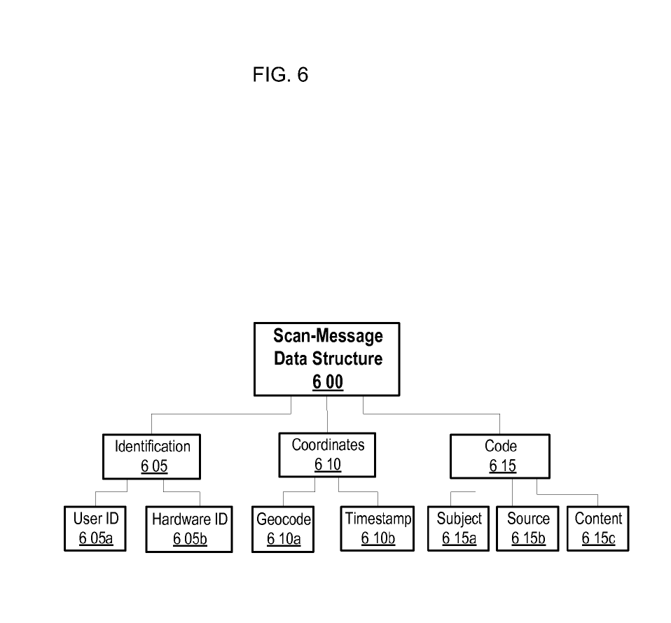

The Scan Message generated by the CTIS is, itself, a novel data structure. In one embodiment that is illustrated in FIG. 6, it contains an identification field (605) comprising a unique user ID (605a) and a hardware ID (605b), both automatically supplied by the device used to scan and transmit the scanned code; a coordinate field (610) comprising the location geocode (610a) (e.g., GPS coordinate, latitude and longitude, city and state, etc.) and timestamp (610b) of the scan; and a code field (615) supplying the specific content of the scanned code, which may include a subject code (615a) for the code context, a source code (615b) indicating where the code was located, and a content code (615c) indicating the specific information, if any, to be supplied in response to a scan of that code.

In one embodiment, the XML for the Scan Message takes the following form:

<Scan_Message>
<ID>

<User ID> 012345 </User ID>
<Hardware ID> Nokia 660 </Hardware ID>

</ID>
<Coordinates>

<Geocode> GPS 40 46.516 −73 57.98 </Geocode>
<Timestamp> 08/21/2006 13:45:28 </Timestamp>

</Coordinates>
<Code>

<Subject> entertainment; movies; comedy </Subject>
<Source> New York Times </Source>
<Content> Showtimes for latest popular comedy movie </Content>

</Code>
</Scan_Message>

In one embodiment, sending and receiving the Scan Message and Reply Message will employ standard data transmission techniques to ensure successful transmission and to preserve data integrity (e.g., TCP/IP, 1xEV-DO, etc.). This is relevant for the Scan Message, which will contain the coded information scanned by the user. Such techniques may include but are not limited to the use of standard transmission protocols, “handshaking”, data compression, data encryption, and error correction.

The content of the user profile generated by the CTIS is itself a novel data structure. In one embodiment illustrated in FIG. 7A, the profile (700), which is uniquely specified by the user ID, will contain a category of quasi-static user information (705) that is generally fixed over time and one of dynamic user information (730) that is updated with each successive Scan Message that the user submits. The quasi-static info (the “quasi” qualifier indicates that this information may be updated, for example if a user changes their mobile device, however it does not change with each successive code scan) may include a hardware ID (710); “census” info (715) such as name, address, phone number, e-mail address, age, sex, race, marital status, number and age of children, job title, annual income, etc.; subjects of interest specified by the user (720); and information regarding allowed methods to contact the user (725). In one embodiment, this information could be supplied by the user when registering for the CTIS service as, for example, on a website. The dynamic info in the profile may include a scan record (735), comprising the time (740), location (745), and scan code (750) (including subject (750a), source (750b) and content (750c)); and statistics related to the scan history (755). Such statistics may include, but are not limited to, the most popular scan subjects, most popular scan sources, user space-time trajectories, etc. In one embodiment, the profile contains a series of identifying codes distilled from the profile content (e.g., demographic category code based on census info, subject codes, source codes, etc.) that can be compared with similar codes in the Scan Message to determine the appropriate Ad content to include in the Reply Message. In an alternative embodiment, the profile contains identifying keywords or “tags” based on the profile content that can be compared with similar tags in the Scan Message to determine the appropriate content to include in the Reply Message. In both cases, the identifying labels for the user profiles may be input by CTIS administrators or automatically generated by an appropriate computer algorithm such as stripping header labels from ad descriptions (e.g., for example, stripping the header tags from an HTML ad).

In one embodiment, the XML for the User Profile may take the following form:

<User>

<Quasi-static info>

<User_ID>123-45-6789</User_ID>
<Hardware ID> Nokia 660 </Hardware ID>
<Census info> John Smith; 123 Maple Dr., Smalltown,
CA 92676; (123)456-7890; jsmith@email.com; 55
years; male; white; married; 2 children; etc.
</Census info>
<Interests> camping; fishing; classic cars; movies; etc.
</Interests>
<Contact restrictions> Weekdays 8 AM - 7 PM only
</Contact restrictions>

</Quasi-static info>
<Dynamic info>

<Scan record>
<Scan_#1>

<Time> 08/21/2006 13:45:28 </Time>
<Geocode> GPS 40 46.516 −73 57.98 </Geocode>

<Code>

<Subject> entertainment; movies; comedy </Subject>
<Source> New York Times </Source>
<Content> Showtimes for latest popular comedy
movie </Content>

</Code>
</Scan_#1>
<Scan_#2>
etc...
</Scan_#2>

etc...

</Scan record>
<Scan statistics>

<Popular subjects> entertainment; cars; travel; etc. </Popular
subjects>
<Popular sources> New York Times; Car and Driver; CNN.com;
etc. <Popular sources>
<Trajectories> Data files listing time and geocode coordinates,
computed average trajectories, likely locatons, etc.
</Trajectories>
etc...

</Scan statistics>
</Dynamic info>
<Code>

<Subject> entertainment; movies; comedy </Subject>
<Source> New York Times </Source>
<Content> Showtimes for latest popular comedy movie
</Content>

</Code>

</User>

In one embodiment, data accumulated in a plurality of user profiles may be analyzed to extract information about codes that are scanned. For example, the frequency with which a particular code is scanned may be extracted from user profiles and parsed by geographic, temporal, and/or demographic criteria to yield code profiling information. This information may be stored in a code and/or Ad profile. In an alternative embodiment, the code/Ad profile may be constructed and/or updated by the CTIS immediately upon the receipt of a Scan Message rather than being extracted from user profiles.

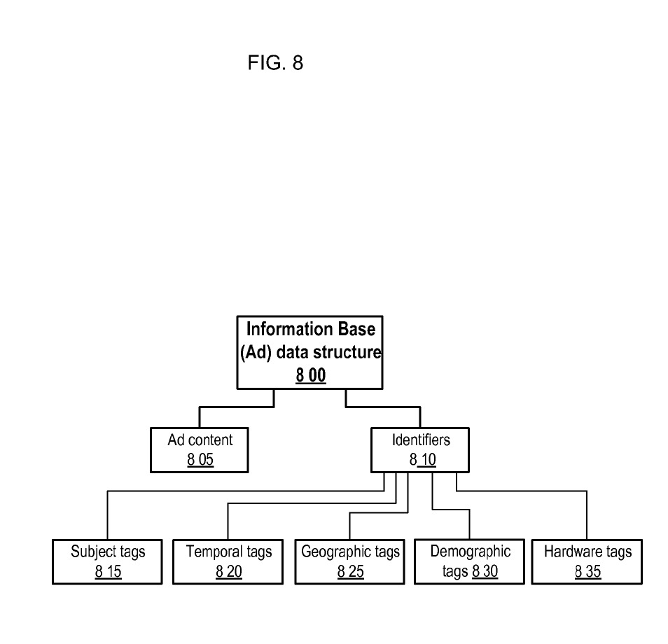

The Information Base contains the content that may be included in the Reply Message sent to the user and may be stored on the CTIS central server or on third party servers accessed by the CTIS. In one embodiment, each Ad is associated with searchable labels. The Ad content together with its labels, collectively referred to here as an Ad, forms a novel data structure. In one embodiment illustrated in FIG. 8, the Ad (800) is comprised of the specific ad content (805) (e.g., text, images, video, etc.) and a set of identifiers (810) including subject tags (815), information characterizing the temporal character of the Ad based on which the Ad may be triggered (820) (e.g., 6 to 10 AM for a breakfast Ad), information characterizing the geographic specificity of the Ad based on which the Ad may be triggered (825), demographic specificity of the Ad (830) (e.g., an Ad for family vacations), and the hardware requirements of the Ad (835) (e.g., hardware IDs of devices capable of displaying the content of a particular Ad). In one embodiment, the Ad would also contain information identifying the source in which the Ad code is to appear. In another embodiment, the Ad would also contain code/Ad profile data, describing the history and/or statistics of scans related to the Ad.

In one embodiment, the XML for an Ad may be in the following form:

<Ad>
<Ad_ID>123</Ad_ID>
<Ad content>

textual movie showtime listings ( or images, audio, video, URLs,
etc.)

</Ad content>
<Identifiers>

<Subject> entertainment; movies; comedy </Subject>
<Temporal> 08/21/2006; 12:00:00 to 14:00:00 </Temporal>
<Geographic> Smalltown, CA 92676 </Geographic>
<Demographic> 17 years and older </Demographic>
<Hardware> any (text only) </Hardware>

</Identifiers>
</Ad>

The CTIS queries the user profile to determine which Ads to include from the Information Base in the Reply Message in order to tailor those Ads to the user's profile characteristics, interests, and trajectories. In one embodiment, a scanned code will yield two components in the Reply Message content: i) static content that is the same for every user who scans the code, and ii) dynamic content that depends on the context of the user and the user profile. The static content (i) is determined from the scan code, while the dynamic content (ii) is determined by a combination of the scan code and the user profile, requiring a dynamic content generation heuristic to combine their respective influences. While a variety of such heuristic are possible and contemplated as being within the scope of this disclosure, and the specific heuristic employed in a given realization will likely depend on the precise application and intention, we discuss one embodiment of this heuristic here for illustrative purposes with reference to FIG. 9. In one embodiment, the scan code and user profile is labeled with keywords or “tags” that identify the subject content of each. In an alternative embodiment, the scan code, user profile, and Ads are labeled with identifying codes. In either case, the heuristic exhibited in FIG. 9 first filters all Ads in the Information Base by the subject code or tag of the scanned code (900). The Ads from (900) are filtered by the hardware ID (905) to ensure that the Ad content can be successfully acquired and displayed by the user. The Ads from (905) are filtered into separate categories by scan location (910a1), user address (910a2), user specified subject interests (910b1), user scan subject history (910b2), scan time (910c), or user demographic category (910d). Ads in each of these filtered categories are compared to determine which occur most commonly across (910a, b, c, & d) (915). The server determines if (915) has yielded a single Ad (920), and if so, it incorporates the Ad's content into the Reply Message (930). Otherwise, it chooses one Ad at random from the remaining Ads (925) for incorporation. It must be emphasized again that this is but a single, specific embodiment of the user profile query heuristic intended for illustrative purposes. The heuristic is highly flexible and can be finely tuned for the specific application at hand. Some other possible methods may include alternative ordering of filters, addition or removal of filters, weighted filtering, complex conditional trees, and/or the like.

Referring to FIG. 2, in an embodiment the user scans a code from an article on finance and investment in the business section of a media publication. In this embodiment, the user scans a code from an article on finance and investment in the business section of a media publication. Keywords associated with this code may include “Business,” “Finance,” “Investment,” etc. Consequently, only those Ads possessing these identifying keywords are passed at (800). In an alternative embodiment, the keywords may be ranked in order or relevance and the Ads filtered accordingly. The Ads from (900) are filtered by Hardware ID; we presently assume that the user's mobile device is equipped with advanced capabilities (text, image, audio, video, Internet, etc.), so that all Ads are passed at (905). In an alternative embodiment, the Ad filter may preferentially choose those Ads that take fullest advantage of the user device's display capabilities. Of the remaining Ads, there is one for a brokerage firm that is tagged with a location code corresponding to the user's address (San Francisco, Calif.), the user's specified subject interests (investing, retirement), and a portion of the user's demographic profile (age 55 or older). The three tag matches (location, subject, and demographic) distinguish this Ad from the others in the Information Base, which, in this example, all have two or fewer tag matches; so this unique Ad, a brokerage firm located in San Francisco, Calif. with retirement services, is chosen to be served to the user's mobile device.

In one embodiment, the user may respond to the Reply Message with a relevance rating. This rating may then be stored in the user profile and/or employed to refine the criteria for tailoring future Reply Messages to that user.

In one embodiment, the Ads would not be filtered by hardware ID at (905). Rather, when a final Ad has been selected for inclusion in the Reply Message following filtration under the other relevant criteria, the server will determine whether that Ad is properly formatted for the device specified by the hardware ID. If so, then the Ad will be included in the Reply Message as is. Otherwise, it will be converted into the required format appropriate to the user's mobile device. For example, if the selected Ad contains color images, but the server determines that the user's hardware device is an early model BlackBerry that only accommodates monochromatic text, the server will implement a peripheral application to strip the text content from the Ad and incorporate only that in the Reply Message.

Though Ads served by the CTIS are determined by codes scanned at some time in the past, it is possible for the CTIS to serve Ads without any immediately contiguous, causal code scan. A general illustration of this capability was given above in FIG. 3, where each Ad provider has specific geographic locations of operation. These are assumed to be stores/restaurants for the present purposes of illustration in this disclosure, but they may have different character for different embodiments and applications, including but not limited to, kiosks, signs and billboards, offices, hospitals, real estate, shelters, emergency service providers, traffic monitors, individuals, websites, virtual world locations, and/or the like. A chosen distance surrounding each Ad provider location defines a “provider zone,” where the metric by which “distance” is gauged may be generalized in the case of cyberspace/virtual world locations. A provider zone breach occurs when a user scans a code within a provider zone. This may be regardless of the content of the scanned code, for, in this example, the goal is to record the user's space-time position. In an alternative embodiment, a provider zone breach can be registered even if a user does not scan a code within the provider zone, if the CTIS can infer a breach from two or more code scans outside the provider zone through interpolation. When such a provider zone breach occurs, a special note may be incorporated into the user profile, such as in the Scan statistics module (755), indicating the time and the particular Ad provider.

In an alternative embodiment, the CTIS may be configured to automatically query a user position without scanned codes. For example, a user's mobile device may be configured to periodically register its GPS location with the CTIS system. In another embodiment, the CTIS may be able to continuously monitor the position of a client mobile device based on the cell site or tower to which the device is communicatively coupled. Cell site based user location may also be registered when a user scans a code.

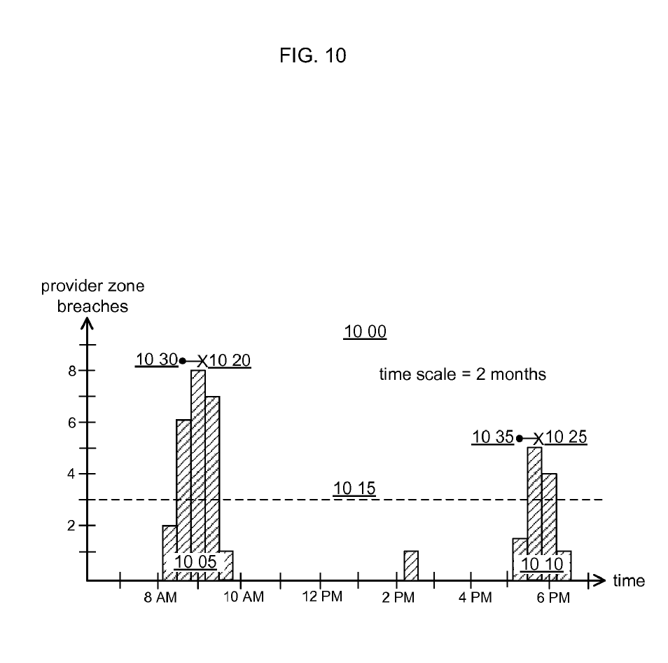

From an accumulated record of these breaches, data of the form of FIG. 10 can be determined. FIG. 10 illustrates a histogram (1000) of provider zone breaches in 20 minute intervals for a particular user over a chosen time scale, which, for purposes of this example, will be two months. In one embodiment, such histograms will correspond to breaches of specific Ad provider locations; while in an alternative embodiment, they will correspond to breaches of any of a plurality of locations corresponding to a specific Ad provider; while in still another embodiment, they will correspond to breaches of different locations of related but different Ad providers, chosen to target a specific collective user demographic. In this exemplary histogram, the significant provider zone breaches (those exceeding the threshold) are clustered around two times: one approximately centered at 9 AM (1005), and the other at 6 PM (1010). This may represent, for example, a user scanning codes as he passes the same Ad provider location while riding a bus to and from work. In one embodiment, a threshold breach level (1015), indicated in FIG. 10 by a horizontal dotted line, is specified, such that all breaches below this threshold number are ignored. This threshold level should be specified with respect to the time scale of the histogram; in the present example, the threshold is 3 breaches per two month period. The average peak times (1020, 1025) of the breach clusters that exceed this threshold are computed (marked by X's in FIG. 9), and a time is chosen prior to those averages (1030, 1035) to serve an appropriate Ad to the user. In one embodiment, provider zone breaches could be sorted by scan subject, so that a histogram of the form of FIG. 10 could be constructed for a specific category of scans in order to further tailor the supplied Ad content.

In another embodiment, the system may be generalized to analyze trajectories in “cyberspace-time.” In this embodiment, a record of trajectories is kept of the user's activity on the worldwide web as browsed, for example, on the user's Internet enabled mobile device. A generalized concept of “distance” may be incorporated, for example reflecting an average number of links needed to get from one website to another. Provider locations become websites in this embodiment, and a zone breach may be registered when the user is a specified number of links away from the provider's website. Then, just as before, the CTIS can anticipate user cyberspace-time trajectories and supply Ads, coupons, pop-ups, etc. related to websites that the user is approaching. For example, the CTIS may track that a user visits web site A at 9:00 AM and web site B at 9:20 AM every day. The CTIS may then provide Ads to website A at 8:50 AM and to website B at 9:10 that are targeted to that user. In an alternative embodiment, the CTIS may provide this targeting information to existing ad serving systems, which in turn may use the targeting information for timely placement of ads. The aggregation of such targeting information, in particular, may be useful to advertisers and website owners. For example, reports may be run on user profiles sorted by location (e.g., web sites) and time of visit. This information may be supplied, along with user profile IDs, which may then be used by the advertising servers and/or websites to pre-cache ads that are relevant to the users'interest just prior to their anticipated visits to the website. As such, the CTIS works in conjunction with certain websites to supply user-specific Ads on those sites. As a result, the content of the user profile within the CTIS may be used to select Ads that the user browses using their mobile device. In an alternative embodiment, web-based Ads may be specific to the trajectories of users in geographic space-time, since that information is included in the user profile. For example, if a user is known to be passing by a coffee shop at a specific location and time every day (e.g., a coffee shop on 123 Main Street, New York, N.Y. at 9:00 AM), and is also know to visit a specific website at that time (e.g., at 9:00 AM the user visits website C reading the daily news on their walk to work), then the system may provide the user with Ads directly to their PDA or embedded in website C (because it was pre-loaded as already discussed) for the coffee shop. As such, the CTIS provides a mechanism to provide geographically relevant ads to traditional websites. In yet another embodiment, the total content of the websites browsed by a user on their mobile device may be modified by the content of the user profile within the CTIS. For example, a news website may select articles for a user that are specific to the user profile, including their interests, demographics, current time and location, etc.

In another embodiment, the CTIS may analyze the user trajectories in “virtual worlds” or “synthetic realities” and serve ads accordingly. An example of a virtual world is a massively multiplayer online game, such as The Sims Online, EverQuest, World of Warcraft, Second Life, and/or the like. In such a virtual environment, a code scan may be comprised of a particular user action or decision such as initiating or completing a game mission, clicking on an icon, saving a game, etc. In such virtual worlds, geographies and virtual locations may be used in employing trajectories. The history of user activity within the virtual world may then be incorporated into the user profile and used by the CTIS to serve ads within the context of the virtual world or elsewhere. For example, in games like Second Life, virtual televisions, billboards, etc. may be used as advertising delivery mechanisms.

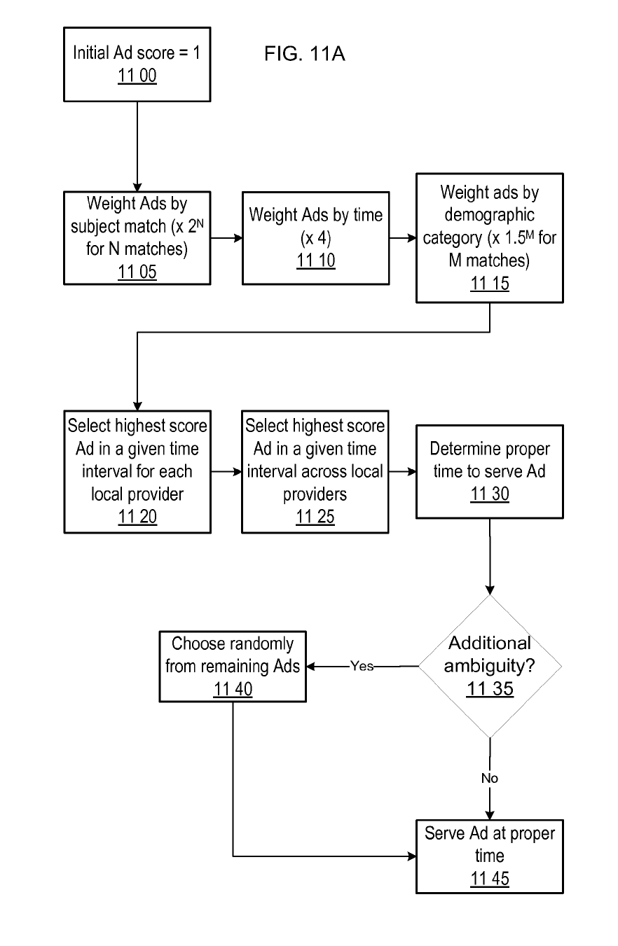

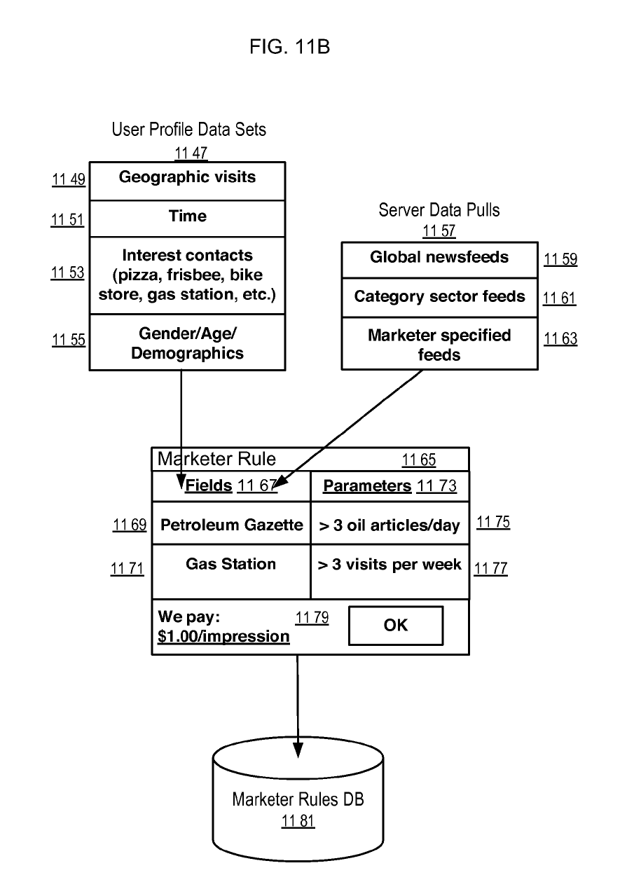

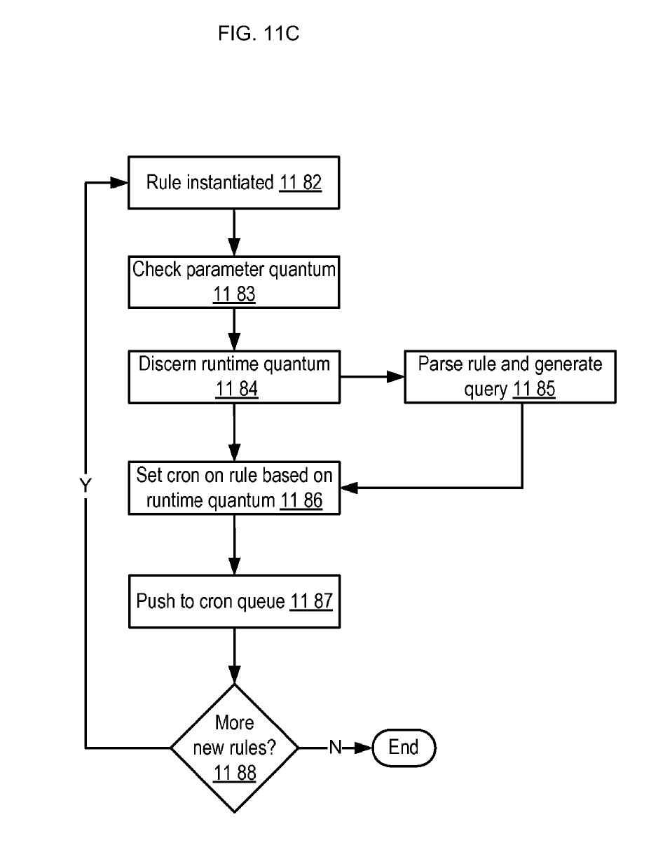

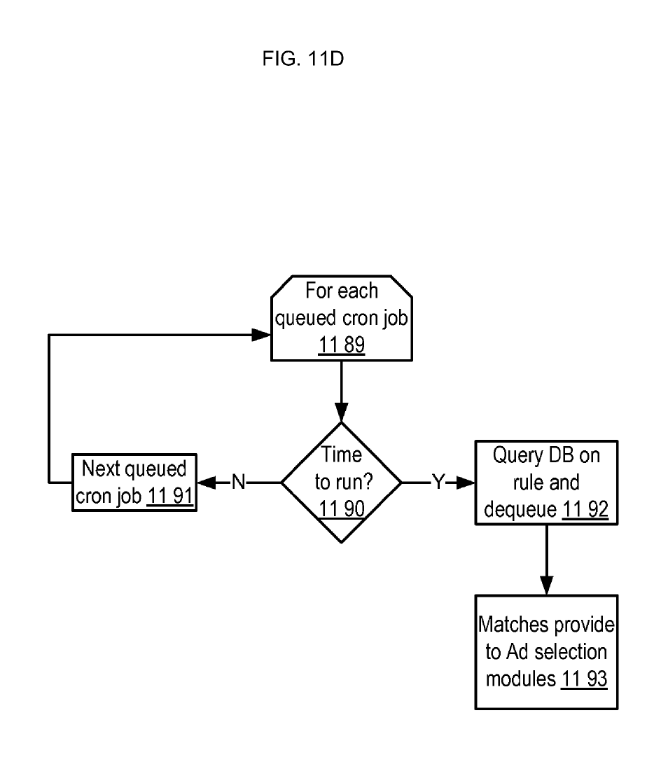

Selecting the proper Ad to serve to the user in the non-triggered Ad serving embodiment of the CTIS may be accomplished using a variety of heuristics that are best tailored to suit the specific use or application. An illustrative example of an ad selection process is provided in FIG. 11A. In this example, a weighting system may be employed to select among the Ads of a specific Ad provider once it is established that an Ad from this provider is to be served to the user based on the analysis of FIG. 10. This weighting system begins by assigning a score of 1 (1100) to all Ads in the Information Base corresponding to the provider. This score is multiplied by a subject coefficient (1105) for every match between the Ad subject and the user specified subject interest or scan subject history. That coefficient is 2 in the present example, so N matches would yield a weighting factor of 2.sup.N. The Ad score may also be multiplied by a time coefficient (1110) if the serving time (1030 or 1035) falls within a time range specified for a particular Ad. In the present example, the time coefficient is 4, expressing the greater importance of this factor compared to a single subject match. Finally, the Ad score may be multiplied by a demographic coefficient (1115) for every match between the Ad demographic category and that of the user. That coefficient is 1.5 in the present example, reflecting the diminished importance of this factor compared to the time and subject considerations. M demographic category matches will yield a weighting factor of 1.5.sup.M. Once all of the Ad provider's Ads are scored in this fashion, those Ads with the highest scores for that provider may be selected over the rest (1120). Similarly, the highest scoring Ads from other providers are selected and the highest scoring Ads over all providers can be selected to serve for a particular time interval (1125). Finally, the proper time to serve the Ad (e.g., 30 minutes prior to the expected average provider zone breach time) is established (1130) and, if there is no further ambiguity (1135), the proper Ad is served at that time (1145). Any residual ambiguity may be resolved by selecting randomly from the remaining Ads.

As a specific example of how this might work, we assume that the histogram (1000) of FIG. 10 represents provider zone breaches for a fast-food restaurant that a user passes on his way to and from work. An Ad in the restaurant's base of provided Ads matches the user's stated interest in gourmet coffee, and this Ad is further labeled by a time identifier indicating that it is best served between 8:00 AM and 10:00 AM. Consequently, at 30 minutes before the user's average breach time of the provider's zone, the server supplies the Ad to the user's mobile device, touting this restaurant's new line of gourmet coffee drinks Alternatively, the user's profile may specify that he is married with two children. This matches the demographic category of an Ad in the provider's base which is also labeled by a time identifier indicating that it is best served between 5:00 PM and 8:00 PM. As a result, 30 minutes before the user breaches the provider's zone on his way home from work, the server supplies the Ad to the user's mobile device, touting their family-pack of hamburgers.

In an alternative embodiment, the CTIS may be configured to receive and implement marketer rules for serving Ads. FIG. 11B illustrates a schematic illustration of data structures related to establishment of a marketer rule for Ad serving in one embodiment of CTIS operation. A user profile data sets (1147) may include a variety of data fields related to user activities, interests, characteristics, and/or the like, such as but not limited to: geographic visits (1149), as may be recorded by code scans, time (1151) associated with code scans, interest contacts (1153), such as may be reflect the user's interests and may be based on the context and/or associated content of scanned codes, gender, age, demographic, and/or other personal information (1155), and/or the like. Server data pulls (1157) may reference one or more data feeds to which the CTIS has access in order to draw information that may be pertinent to marketer rules and/or Ad serving procedures. A wide variety of different types of feeds may be accessible, including but not limited to: global newsfeeds (1159), such as associated press wire services, weather information, sports scores, political and social events, financial market data, and/or the like; category sector feeds (1161), such as more specific and/or special interest news feeds, marketer specified feeds (1163); and/or the like. A marketer rule (1165) may be established by selecting one or more fields (1167) from the user profile data sets (1147) and/or the server data pulls (1157) and supplying associated parameters (1165) and/or parameter values associated with those fields. As illustrated, the rule associates a Petroleum Gazette field (1169) with a parameter specifying more than three oil articles read per day (1175). In addition, the rule associates a gas station visitation field (1171) with a parameter specifying more than three visits per week (1177). If both of these conditions are deemed true for a given CTIS user, then the CTIS may serve one or more Ads selected for and/or associated with the marketer rule. A price-per-impression (1179) may be charged for each time that the Ad is served to a user under the circumstances specified by the rule. In one embodiment, a marketer may propose a price-per-impression when he or she creates the rule, which is then submitted to the CTIS and/or a CTIS administrator for approval. In another embodiment, the CTIS may automatically generate a price-per-impression based on the rule and/or the marketer. For example, a fixed charge may be applied for each additional field and associated parameter added to the rule, as this refines the specificity with which the associated Ads will be served and increases the likelihood of transactional consummation. Once a rule is complete, it may be entered for storage and subsequent use in a marketer rules database (1181). It should be understood that the functionality described for this embodiment of the CTIS may be integrated or employed within any of the other CTIS embodiments described herein.

In one embodiment, the XML for the above marketer rule may take a form similar to the following:

<Rule>

<Rule_ID>123</Rule_ID>
<Rule_name> Oil Rule </Rule_name>
<Rule_owner> Ads R Us </Rule_owner>

<Condition1>
<Field1> Petroleum Gazette </Field1>

<Parameter1> 4 or more oil articles/day </Parameter1>

</Condition1>
<Condition2>

<Field2> Gas Station </Field2>
<Parameter2> 4 or more visits per week </Parameter2>

</Condition2>
<Ad_database> Hybrid car Ads </Ad_database>
<Price>

<Amount> $1.00 </Amount>
<Contingency> Impression </Contingency>

</Price>

</Rule>

In one embodiment, the elements of FIG. 11B may form the basis of a user interface for marketer rule generation. A marketer and/or other CTIS user may be presented with lists of user profile data sets (1147) and server data pulls (1157) that may be dragged and dropped to the marketer rule box (1165) to generate a marketer rule. When the parameter values have been specified and the rule is complete, the user may click OK to submit the rule and/or drag and drop the rule to a marketer rules database icon (1181).

FIG. 11C illustrates a logic flow for generating a rule queue in one embodiment of CTIS operation. A rule is instantiated (1182), and the CTIS checks parameter quanta associated with the rule (1183). A runtime quantum is discerned for the rule (1184) to determine the timing for applying the rule. The rule is subsequently parsed to generate the appropriate query structure (1185), and the cron schedule for the rule is established based on the runtime quantum (1186). The rule may then be pushed to the cron schedule queue (1187), and a determination made as to whether there are any additional new rules to process (1188).

FIG. 11D illustrates a logic flow for cron job queue management in one embodiment of CTIS operation. The CTIS may monitor the cron job queue and, for each queued cron job associated with a rule that is next in the queue (1189), the CTIS may determine whether or not it is time for that particular cron job to run (1190). If not, then the CTIS passes to the next cron job in the queue (1191). On the other hand, if it is time to run, then the appropriate databases specified in the rule are queried, and the particular cron job is dequeued (1192). If the results of the database query match the rule criteria so as to require serving an Ad impression to a user, then that match indication may be passed to Ad selection modules in order to choose an Ad to supply to the user. In one embodiment, the marketer rule itself may uniquely determine an Ad to serve. In another embodiment, the marketer rule may determine a set or class of Ads to serve, from which a unique Ad may then be randomly selected. In yet another embodiment, as Ad may be selected from the marketer rule determined set or class of Ads based on a user profile.

It must be emphasized again that this is but a single, specific embodiment of the non-triggered Ad serving procedure intended for illustrative purposes. The procedure is highly flexible and can be finely tuned for the specific application at hand. Some other possible methods may include different relative weighting factors, alternative weighting considerations, categorical filtering, consideration of the number of provider zone breaches above the threshold level, graduated consideration of the distance from the provider location, modified provider zone shapes, pattern recognition algorithms, artificial intelligence facilitation, and/or the like.

In an embodiment, personnel directives may be served that are targeted based on characteristic profiles, behavioral patterns, and/or contextual surroundings and situations. A project manager may deliver personnel directives based on user activities, such as may be registered by codes scanned by mobile devices, as well as user characteristics and an accumulated history of user activities (e.g., code scans). The scans, together with geographic, temporal, and user-specific information, are obtained by the server that receives, processes, and records the message. Based on these messages and a user profile—which may include continuously updated user-specific behavior information, situational and ambient information, an accumulated history of scanned code messages, and integration with outside database information—the server selects information to serve to the users' mobile devices from an information base. For example, a user who scans a barcode for a house-building project with his/her cell phone and whose profile lists his/her role as “mason” may be directed to begin mixing mortar. When he/she is finished, he/she may scan a completion barcode to receive the next directive (e.g., to begin laying bricks). In one embodiment, the code triggered information server allows managers to supply product information and/or personnel directives to users by selecting content based on a combination of the context of the code that the user scanned, the user's status and/or employment position as recorded in his or her user profile, the user's demographic profile, situational information, and a record of scanned codes. These factors can be analyzed and employed by the CTIS for both user tracking and behavioral profiling/targeting. In another embodiment, the code triggered information server may supply personnel directives solely based on user profiles with no immediately contiguous code scans. For example, the system may predict user trajectories based on the collected history of code scans, including the locations where the scans occurred. Then, based on these predicted trajectories, it may direct all users with “emergency service personnel” in their profiles who are projected to be in the vicinity of an emergency situation to report for duty. It may even provide more detailed directives to each specific type of emergency service personnel based on the title and experience level listed in each user's profile, and on the specific location of the user with respect to the emergency situation.

In an embodiment, the CTIS allows managers to obtain better operational success rates by supplying personnel directives to users that are specific to the users' current geographic locations at specific times of the day. In another embodiment, the CTIS provides rapid and evolving geographic and historical statistical profiling of user progress and behavior. In another embodiment, the CTIS provides an expanded platform to supply large quantities of information and/or personnel directives with a minimal amount of publication space.

From the user point of view, the CTIS provides a mechanism by which, in exchange for scanning a code and providing basic information, he/she can receive the most targeted information and/or personnel directives relevant to his/her role in the collective operation. At the same time, the system grants a manager a powerful tracking tool, to monitor roles, accomplishments, failures, and behavioral patterns of users on individual, demographic, temporal, and geographic scales. This allows, among other things, the deployment of anticipatory information/personnel directives that are served to users in anticipation of their locations and/or operational progress based on an accumulated history of user tracking data.

Managers participate by contributing content to an Information Base that categorizes and labels that content under a number of considerations, such as subject matter, geographic and temporal identity, status/role specificity, demographic specificity, and/or the like. Elements of the Information Base can then be compared via these labels with comparable labels found in a database of user profiles in order to match content with users via subject, location, time, demographic category, and/or the like. As such, the CTIS efficiently facilitates project management by providing personnel directives to users with highly tailored specificity.

In another embodiment, the CTIS provides a mechanism of instituting plans for large-scale coordination of personnel using a single coded broadcast. High-level officials could determine which of a number of coordination plans to institute, each being associated with a unique 2D matrix code. When a plan is decided upon, the code is broadcast (such as over television or the Internet) and lower-level employees scan the code to obtain instructions, diagrams, maps, etc. that are tailored to the employees' specific profile contents (i.e., job, skills, location, etc.). There may also be authorization information included in the employee profiles that determines whether they are allowed to decode the broadcast. As each employee progresses in their role within the plan, additional codes could be provided to the employee to scan, both to update their tasks and to track their progress, space-time trajectories, etc.

In another embodiment, the CTIS provides a means of employee tracking. For example, tasks are supplied to employees in the form of 2D matrix codes. When a code is scanned by a given employee, the scan is recorded in the employee's profile and the employee is provided with instructions specific to that task and their position within the organization. When the task is completed, the employee is provided with a completion code that, when scanned, records the employee's successful completion of that task and provides instructions for the next task and/or reward information. In this manner, a record of employee accomplishments is kept as well as information regarding the time taken by the employee to accomplish various tasks. A statistical record of an employee's experience by subject matter may also be generated and included in his/her profile using the CTIS.

In embodiments, a user profile is used to provide information querying and serving in a virtual world. Such virtual worlds may include, for example, massive multiplayer online games, like The Sims Online, Everquest, World of Warcraft, Second Life, and/or the like. Information and/or advertisement providers may use a code triggered information server to serve context, demographic, and behavior targeted information to users in a virtual world. Users, in turn, trigger the provision of information by scanning or observing codes or information, or by making decisions within a virtual world such as attempting a mission within a game. The triggers, together with virtual world geographic, temporal, and user-specific information, are obtained by the server that receives, processes, and records the message. Based on these messages and a user profile—which may include continuously updated user-specific behavior information, situational and ambient information, an accumulated history of triggers, and integration with outside database information—the server selects information to serve to the user in a virtual world from an information base. For example, a user in Second Life who likes modern clothing for his/her avatar may be presented with ads on virtual billboards from advertisers of virtual in-game clothing stores that are near his/her virtual position. In another example, an advertisement tailored to a user's particular interests or behavioral patterns may be placed at a location within a virtual world that the user is known to routinely pass.

In one embodiment, the CTIS allows advertisers to supply product information in a virtual world to the consumers who would be most interested in such ads; this may be achieved by the CTIS selecting advertising content based on a combination of the context of the code that the consumer scanned, the consumer's stated interests as recorded in his or her user profile, the consumer's demographic profile, a decision made within a virtual world, situational information, and a record of scanned codes and/or virtual world decisions; these factors can be analyzed and employed by the CTIS for both user tracking and behavioral profiling/targeting. For example, a player of The Sims Online who frequently acquires new furniture for his/her virtual apartment and has a stated interest in modern art may be served advertisements for an actual furniture store that sells modern furniture and is near the user's geographic location following one such virtual furniture acquisition. In another example, a user of Second Life that likes modern clothing for his/her character may be presented with ads on virtual billboards from advertisers of virtual in-game clothing stores that are nearby the user's virtual position (or offer a virtual transportation link that will instantly move the user's avatar to the virtual in-game store).

The CTIS delivers targeted Ads to users in a virtual world while simultaneously providing detailed customer tracking information to Ad providers. The CTIS supplies Ad providers with greater precision and focus to provide consumers with the information that is most relevant to their interests, behavioral patterns, and space-time and/or virtual world trajectories to maximize the possibility of consummating a transaction. In one embodiment, the CTIS is designed to allow advertisers to place ads at virtual world locations at specific times of the day such as to increase the likelihood of garnering the attention of prospective customers. In another embodiment, the CTIS yields time and virtual world location resolved records of scans for the determination of coded advertisement visibility. In another embodiment, the CTIS provides rapid and evolving virtual world geographic and historical statistical profiling of user interest and coded advertisement quality. In another embodiment, the CTIS provides an expanded platform to supply large quantities of information and content with a minimal amount of publication space.

From the user point of view, the CTIS provides a mechanism by which, in exchange for officially registering interest and providing basic information, he/she can receive the most targeted solicitations, enhanced content, sales offers/coupons, and/or the like within a virtual world. User benefits include: relevant and targeted advertising, mobile context specific information, contiguous location and/or immediate event information, coupons and/or offers for many types of goods and services, and/or the like.

At the same time, the system grants the advertiser a powerful tracking tool, to monitor behavioral patterns of consumers on individual, demographic, temporal, and virtual world geographic scales. This allows, among other things, the deployment of anticipatory advertising: serving advertisements to users in anticipation of their locations and/or potential interests based on an accumulated history of user tracking data. Other Ad provider benefits include: compilation of highly specific customer tracking information, including customer virtual world trajectories, virtual world location and/or time specific advertising, highly flexible coded advertising placement, quick and updated determination of coded advertisement visibility, and/or the like.

Of benefit to both users and Ad providers is the fact that users improve the specificity of their Reply Messages with each successive scan, since each scan further refines the contents of the user profile. Users thus have a motivation to scan as many codes as possible related to subjects of interest and will thereby be exposed to more advertisements than in more traditional, passive advertising and marketing schemes.

Ad providers participate by contributing content to an Information Base that categorizes and labels that content under a number of considerations, such as subject matter, virtual world geographic and temporal identity, demographic specificity, and/or the like. Elements of the Information Base can then be compared via these labels with comparable labels found in a database of user profiles in order to match content with users via subject, virtual world location, time, demographic category, and/or the like. As such, the CTIS efficiently facilitates commerce by providing advertising to consumers with highly tailored specificity.

In an embodiment, the CITS delivers information on the Internet based on user activities, such as may be registered by codes scanned by mobile devices or website links selected on a computer, as well as user characteristics and an accumulated history of user activities. For example, information and/or advertisement providers may use CTIS to serve context, demographic, and behavior targeted information to users on the Internet. In particular, information and/or advertisements are served on the Internet that is targeted to the individual based on the individual's characteristic profile, behavioral patterns, and present contextual surroundings, either in real space of cyberspace. For example, a web-based advertisement may be provided on an Internet enabled mobile device for goods and services located near a mobile user, which advertisement is selected based on the user's behavioral patterns and stated interests.

In one embodiment, the CTIS allows advertisers to supply product information on websites to the consumers who would be most interested in such ads; this may be achieved by the CTIS selecting advertising content based on a combination of the context of the code that the consumer scanned or the web link that the user selected, the consumer's stated interests as recorded in his or her user profile, the consumer's demographic profile, situational information, and a record of scanned codes or web links; these factors can be analyzed and employed by the CTIS for both user tracking and behavioral profiling/targeting. For example, a user with a stated interest in running and a recent pattern of scanning codes related to shoes may be served a web-based advertisement on his/her Internet-enabled mobile device for a new running shoe being sold at a nearby shoe store. In another example, a user profiled to be a teenager and having a pattern of browsing websites related to comic books may be served a web-based ad for the newest comic book themed movie when he/she visits a movie-listings website.

Users, in turn, trigger the provision of information by scanning or observing codes or information, or by selecting web links. The triggers, together with geographic, temporal, and user-specific information, are obtained by the server that receives, processes, and records the message. Based on these messages and a user profile, which may include continuously updated user-specific behavior information, situational and ambient information, an accumulated history of trigger messages, and integration with outside database information, the server selects information to serve to a user on the Internet from an information base.

For example, a user with a recorded history of interest in coffee products may be served an advertisement for a nearby coffee shop while browsing the web on his/her PDA. In one embodiment, information may also be served to users on the Internet based solely on the user profiles, and without any initiating trigger. This is based on user trajectories or web-surfing habits deduced from the accumulated history of triggers. For example, a user known to routinely visit a music vendor website near the same time each day may be served an advertisement for the latest top-selling CD shortly before that time.

In embodiments, ambient and/or other situational conditions that may be considered in selecting and targeting information include temperature, weather, light levels, UV levels, pollen count, humidity, air quality, prices of commodities and/or consumer goods, stock and/or financial index prices, global and/or local news events, Internet activities, sports scores, entertainment news, security warnings, and/or the like. As such, this disclosure details a code triggered information server (CTIS) that delivers information based on user activities, such as may be registered by codes scanned by mobile devices, as well as user characteristics, an accumulated history of user activities (e.g., code scans), and ambient conditions. For example, a user in the midst of high ambient temperatures who is profiled as a teenager who enjoys sweets and has a recorded history of scanning codes pertaining to fast food restaurants may be served an advertisement for the newest ice cream sundae product at a fast food restaurant near the user.

The user's code scans, together with geographic, temporal, and user-specific information, are obtained by the server that receives, processes, and records the message. Based on these messages and a user profile, which may include continuously updated user-specific behavior information, situational and ambient information, an accumulated history of scanned code messages, and integration with outside database information, the server selects information to serve to the users' mobile devices from an information base. In one embodiment, the code triggered information server allows advertisers to supply product information to the consumers who would be most interested in such ads; this may be achieved by the CTIS selecting advertising content based on a combination of the context of the code that the consumer scanned, the consumer's stated interests as recorded in his or her user profile, the consumer's demographic profile, situational information, and a record of scanned codes; these factors can be analyzed and employed by the CTIS for both user tracking and behavioral profiling/targeting.

In another embodiment, the CTIS may serve Ads based on prevailing ambient conditions or climate at users' space-time positions. For example, this may occur when the relevance score for contextual Ads is low.

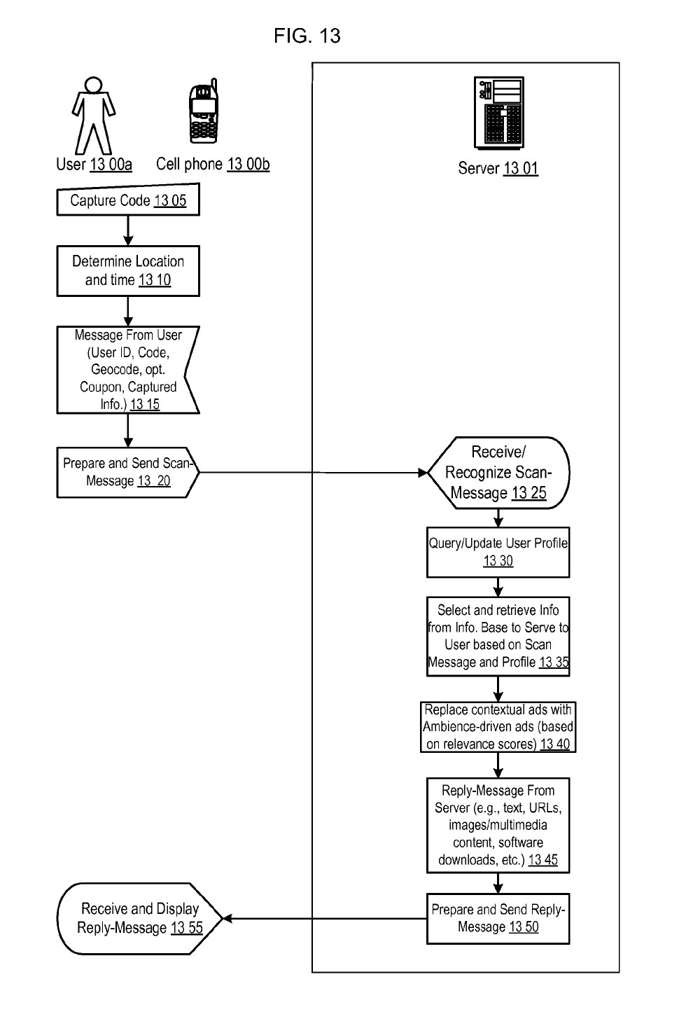

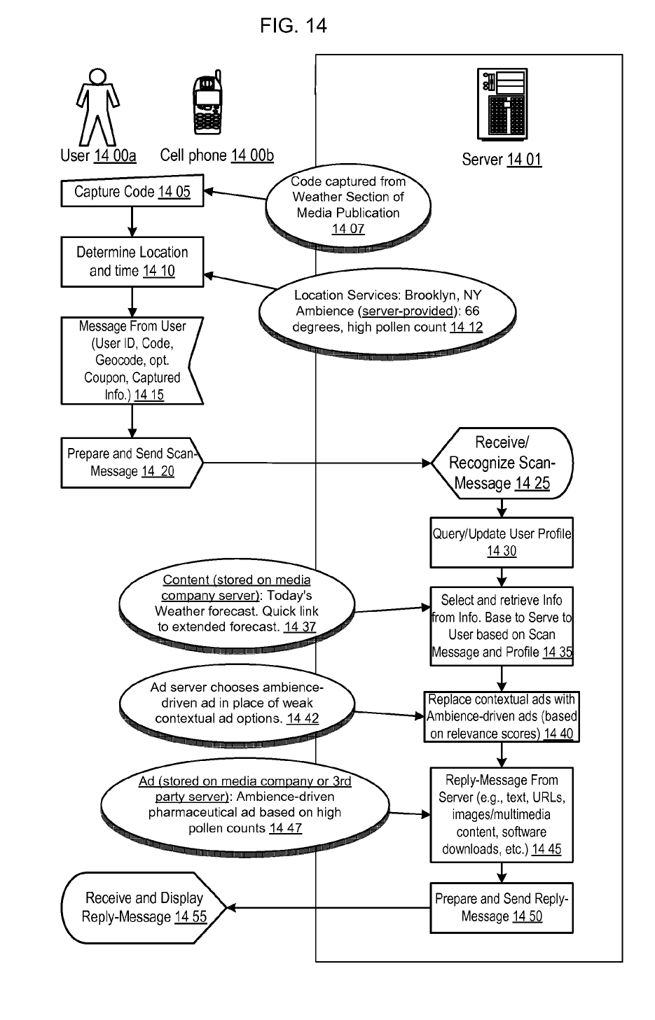

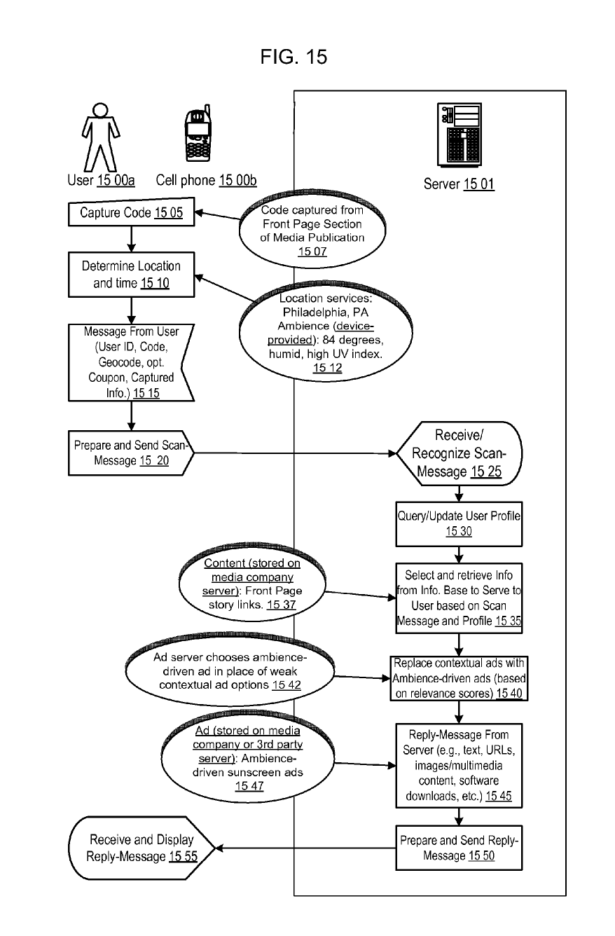

An illustration of the logic and data flow in this embodiment is provided in FIG. 13, wherein the contextual Ads selected from the Information Base on the basis of code scan and user profile are supplanted in favor of Ads chosen on the basis of prevailing ambient conditions (1340). Exemplary embodiments are provided in FIGS. 14 and 15. In FIG. 14, an Ad for allergy medication is provided (1447) in lieu of weak contextual ad options (1442) in response to a code scan from the weather section of a media publication (1407) in conjunction with ambient weather information, including pollen count, queried at the server (1412). In FIG. 15, an Ad for sunscreen is provided (1547) in lieu of weak contextual Ad options (1542) in response to a code scan from the front page section of a media publication (1507) in conjunction with ambient weather information, including humidity and UV index, queried directly by the user's mobile device (1512). In various embodiments, certain ambient conditions such as UV levels, humidity, download/upload speeds, and/or the like may be detected by the user's mobile device itself, while in other embodiments, ambient conditions are separately supplied to a database used in conjunction with the CTIS.

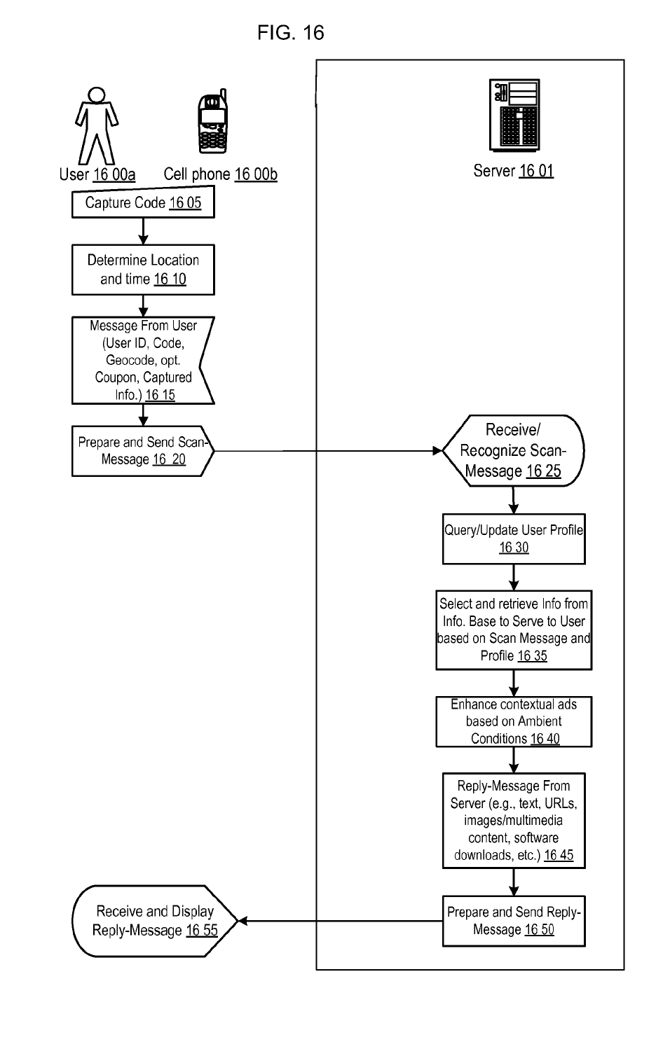

In another embodiment, the CTIS may serve contextual Ads with content enhanced by reference to prevailing ambient conditions. An illustration of the logic and data flow in this embodiment is provided in FIG. 16 wherein the contextual Ads selected from the information base at 1635 are further refined by the ambient condition information at 1640.

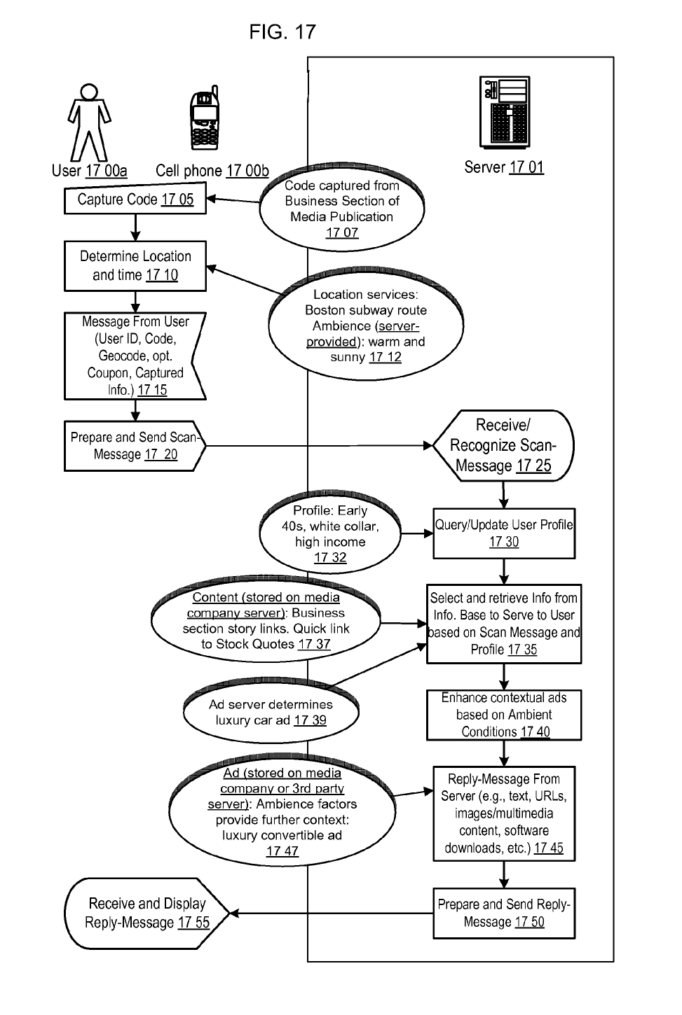

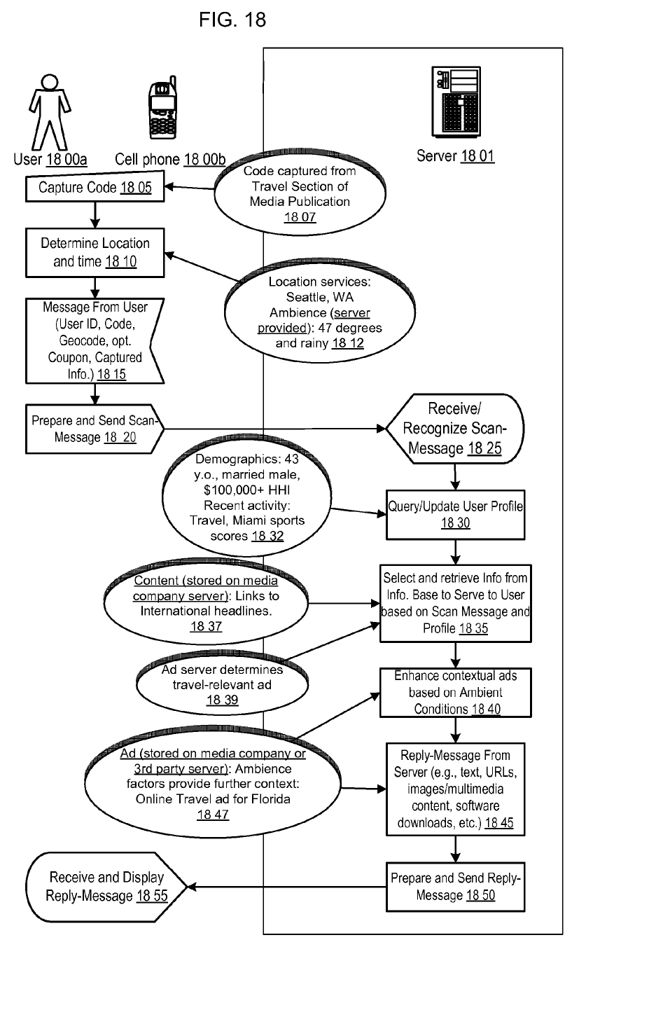

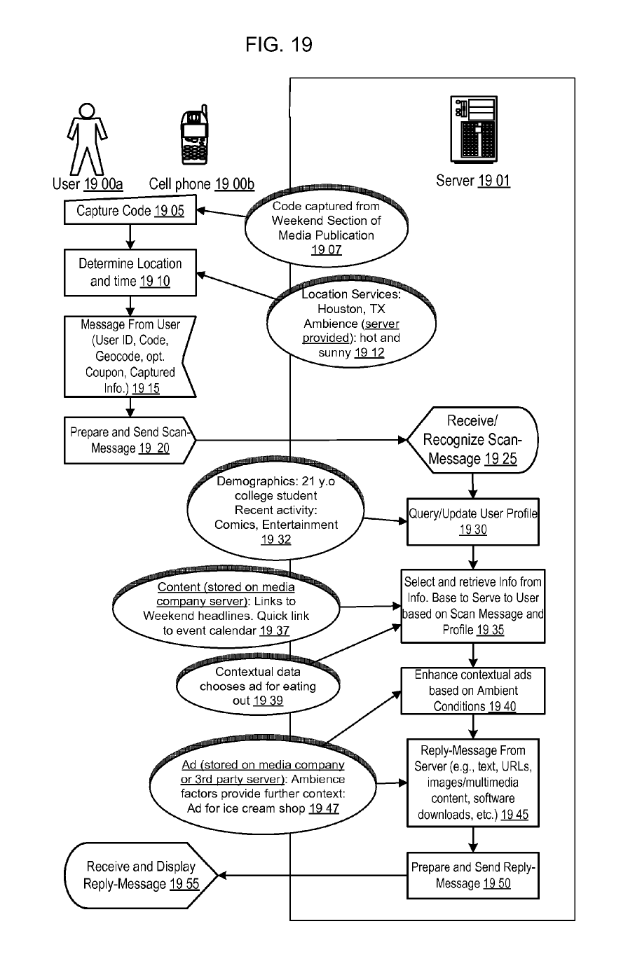

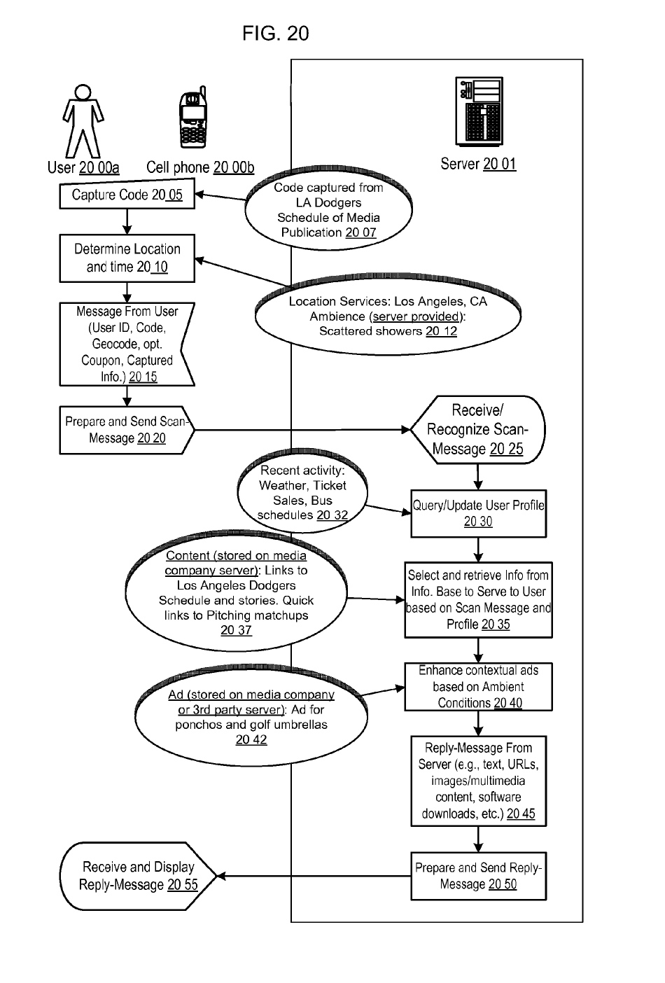

Exemplary embodiments are provided in FIGS. 17-20. In FIG. 17, a code is scanned from the Business section of a media publication 1707 and the CTIS selects luxury car Ads for display 1739 based on the scanned code, user location, and user profile 1732, and these Ads are further refined based on the ambient weather conditions provided to the server at 1712. In this case, warm and sunny weather provides further context to cause the CTIS to serve an Ad for a luxury convertible 1747. In FIG. 18, a code is scanned from the Travel section of a media publication 1807 and the CTIS selects travel Ads for display 1839 based on the scanned code and user profile 1832, which includes recent scan code transactions pertaining to travel and Miami sports scores. The CTIS consequently queries the prevailing ambient weather conditions, comprised of cold and rainy weather, and supplies an Ad for Miami travel opportunities. In FIG. 19, a code is scanned from the Weekend section of a media publication 1907 and the CTIS selects a contextual Ad for eating out 1939 from the Information base 1935 to serve based on the scanned code and the prevailing ambient weather conditions, which are hot and sunny 1912. This Ad is further refined by the user profile contents 1932 indicating a college student interested in comics and entertainment, and an Ad for an ice cream shop is finally supplied 1947. In FIG. 20, a code is scanned from a baseball team schedule within a media publication 2007. Based on the prevailing ambient weather conditions, including scattered showers 2012, the scanned code, and the recent activity in the user profile 2032, an Ad is supplied for ponchos and golf umbrellas 2042.

In various embodiments, the CTIS may serve Ads based on a wide variety of different ambient and/or situational conditions that may be detected by the client mobile device, provided by internal or third party databases or information feeds, and/or the like. Some non-limiting examples of potential ambient and/or situational conditions that may be considered and/or employed in selecting information to serve are temperature, weather, light levels, UV levels, pollen count, humidity, air quality, prices of commodities and/or consumer goods, stock and/or financial index prices, global and/or local news events, Internet activities, sports scores, entertainment news, security warnings, and/or the like. Consideration of such factors, by themselves or in conjunction with knowledge of a user such as may be gleaned from a user profile, may form the basis of information serving rules that have great specificity of targeting. For example, a marketer rule within the CTIS may specify that an Ad for participating bars that includes a coupon for a particular brand of beer be served to all male users between the ages of 21 and 40 with a history of scanning baseball-related codes within three hours of any time that the local baseball team wins a game. In another example, a marketer rule within the CTIS may specify that an Ad for hybrid vehicles be served to all mothers with young children who have a history of scanning codes in Time magazine whenever the local price of gasoline is greater than $2.50/gallon and they scan a code in an issue of Time that contains articles on both global warming and the Iraq War. Such hyper-targeted information serving, enabled by the CTIS, may prove very valuable to marketers and, in fact, to a wide variety of information dissemination applications. Advertisers may be able to purchase Ad time and/or impressions that are conditional on events, people, time, place, ambient conditions, and/or combinations thereof, and/or the like. Consequently, a premium may be charged to advertisers for each Ad served, and that premium may increase with the number of factors considered in serving the Ad (i.e., the degree to which the Ad serving is targeted). In another embodiment, a different price may be charged per impression depending on the characteristics of the individual to which the Ad is served. For example, the hybrid car Ad described above may cost an advertiser $0.75 for an impression to a mom with adult children but $1.00 for an impression to a mom with young children. Such graded pricing schemes may be specified within a marketing rule data structure.

In another embodiment, Ads may be served based on Internet “climate,” such as serving Ads for virus detection software during a computer virus outbreak or serving Ads for high-speed broadband Internet service on days of high Internet traffic. Conditions for specific websites (i.e., cyberspace-time positions) could even be taken into account. For example, an Ad for high-speed broadband Internet service could be supplied to visitors of a website experiencing particularly high traffic.

In another embodiment, the CTIS may interface with various customer information databases, customer relationship management databases, and/or any other third party data sources in order to extract information that may be used to further target and/or refine Ad selection for a given user. In one embodiment, a marketer may supply the CTIS with access to a given marketer-specific database and/or data feed, in order to allow the CTIS to access the information therein during Ad selection processes. It should be understood that the functionality described for this embodiment of the CTIS may be integrated or employed within any of the other CTIS embodiments described herein.

In an embodiment, information querying and serving are triggered by codes that are scanned by a user. The information is selected based on the profile of the user. In an illustrative example, a user who is profiled as a teenager with a stated interest in comic books and a record of scanning codes related to movies may be served an advertisement for the latest comic book themed movie playing in the next hour near his/her present geographic position the next time he/she scans a code from the entertainment section of the newspaper.

In one embodiment, information may also be served to users based solely on the user profiles, and without any initiating code scan. This may be based on predicted space-time trajectories derived from the accumulated history of scanned codes.

The CTIS delivers information based on user activities, such as may be registered by codes scanned by mobile devices, as well as user characteristics and an accumulated history of user activities (e.g., code scans). The scans, together with geographic, temporal, and user-specific information, are obtained by the server that receives, processes, and records the message. Based on these messages and a user profile, which may include continuously updated user-specific behavior information, situational and ambient information, an accumulated history of scanned code messages, and integration with outside database information, the server selects information to serve to the users' mobile devices from an information base. In one embodiment, the code triggered information server allows advertisers to supply product information to the consumers who would be most interested in such ads; this may be achieved by the CTIS selecting advertising content based on a combination of the context of the code that the consumer scanned, the consumer's stated interests as recorded in his or her user profile, the consumer's demographic profile, situational information, and a record of scanned codes. These factors may be analyzed and employed by the CTIS for both user tracking and behavioral profiling/targeting. This information can then be supplied to a user based on anticipated user trajectories and/or interests, as may be determined from the record of scanned codes.

For example, the space-time trajectories of a user who has scanned barcodes in magazines using his/her cell phone over a period of time may be determined, and future likely trajectories determined. Then, advertisements could be served to the user based on where the user is expected to be at a given time, his/her demographic profile, his/her stated interests, and the types of advertisements or articles from which he/she has scanned codes in the past. As an illustrative example, a user may have a history of scanning codes related to fast food, a stated interest in sweets, and a project path passing near a particular fast food restaurant at a particular time. This user may be served an advertisement for the latest dessert product at that restaurant on his/her cell phone shortly before he/she is expected to pass the restaurant.

The present disclosure is directed to apparatuses, methods and systems for determining and announcing proximity between trajectories. Existing schemes fail to take full advantage of the tracking and context targeting possibilities enabled by the present disclosure. In particular, they do not allow tracking and proximity notification that is targeted to the individual consumer's characteristic profile, behavioral patterns, and present contextual surroundings. As such, this disclosure details a code triggered information server (CTIS) that tracks users and notifies them of proximity with other users based on user activities, such as may be registered by codes scanned by mobile devices, web links selected on a computer, or decisions made in a virtual world. For example, a recorded history of scanned barcodes, as well as the time and location of each scan, may be analyzed to determine where a user has been and what they were interested in scanning at the time. Based on such a record, a prediction of a user's likely location may be made. Then, intersections or near-misses for such predicted trajectories between different users may be determined and reported. The CTIS may also incorporate user characteristics and interests.

As the first proximity notification system with geographic, context, and behavioral specificity based on user profiles, the CTIS is designed to analyze user behavioral patterns in order to statistically derive user trajectories and tracking information. In one embodiment, the CTIS is designed to compare expected user space-time trajectories to determine when two or more users are likely to be within a specified distance of each other at a given time. In another embodiment, the CTIS is designed to compare expected user web-surfing habits to determine when two or more users are likely to be on the same website, or within a specified number of links from each other, at a given time. In another embodiment, the CTIS is designed to compare expected user trajectories within a virtual world to determine when two or more users are likely to be within a specified virtual distance from each other within the virtual world. In another embodiment, the CTIS provides rapid and evolving geographic and historical statistical profiling of user activity.

In an embodiment, information is displayed in an electronic system by displaying a first visual token and animating the first visual token to reveal a second visual token comprising a coded symbol. The animation of the first visual token may be in response to a user action. In an embodiment, the user action is a selection response that uses a user pointer. The animation may include, for example rotating the first visual token to reveal a coding symbol on a proximate side of the first visual token.

The encoding symbologies for example, matrix codes, may be placed proximate to graphical elements in a wide variety of digital display contexts and media, including portable display devices, mp3 players, cell phones, digital paper, animated billboards, websites, Internet or television broadcasts, software interfaces, and/or the like. Users may capture images of information encoding symbologies from such displays, for example using a cell phone camera, and decode them with software applets to receive additional information, multimedia content, offers, coupons, notifications, and/or the like.

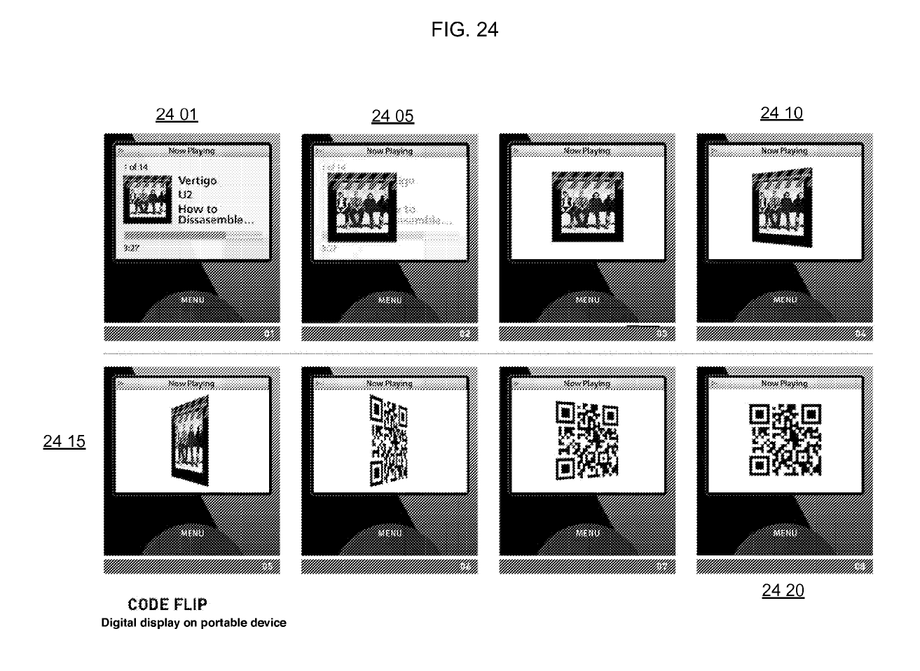

Serving codes to users may be accomplished by a variety of different means and in a variety of different contexts. FIGS. 24-26 illustrate graphical code serving interfaces (GCSIs) of the GCSI/CTIS system. In these embodiments, a graphical display and/or interface initially presents a first visual token for display. This first visual token may comprise virtually any image, picture, drawing, emblem, icon, logo, animation, and/or the like. This first visual token may then be animated to reveal a second visual token comprising encoded information, such as a QR code, matrix code, bar code, and/or the like. Animation of the first visual token may, for example, comprise rotation of the first visual token to reveal the second visual token on a proximate side of the first visual token. For example, a two-dimensional picture in the graphical display may rotate in the third dimension to reveal a matrix code on the back of the picture. Other forms of animation may also be employed within different embodiments. For example, the first visual token may dissolve, morph, disassemble and reassemble, and/or the like to reveal the second visual token. In some embodiments, the animation of the first visual token to reveal the second visual token may occur only in response to some user interaction with the first visual token. For example, a computer screen may display a first visual token persistently until a user clicks on the first visual token with a mouse pointer, at which time the first visual token may rotate to reveal the second visual token on its back. In another example, an electronic billboard may persistently show an advertisement until a motion sensor detects someone walking by, at which time the advertisement dissolves to reveal a matrix code underneath. In still another example, an electronic sign may display a particular image until a detector coupled to the sign detects a signal and/or an authorization code from a compatible, portable electronic device near the detector, at which time the image may morph into a barcode.

In still another example, the first visual token displayed on a touch-sensitive display may flip over to reveal a code when a user touches it with a finger or runs a finger over it to simulate a flipping motion.

FIG. 24 illustrates a user interface manifesting GCSI/CTIS functionality on a portable electronic device in one embodiment of GCSI/CTIS operation. A wide variety of different portable devices may execute and/or coordinate with GCSI/CTIS functionality, such as but not limited to portable media players, cellular telephones, blackberries, PDAs, and/or the like. As illustrated, a portable media player displays album information, including an image of the album cover, on a graphical display, where the displayed information corresponds to music being played on the player (2401). A user may click on or otherwise select the album cover image, causing it to increase in size (2405) and rotate (2410-2415) to reveal a matrix code on the image (2420).

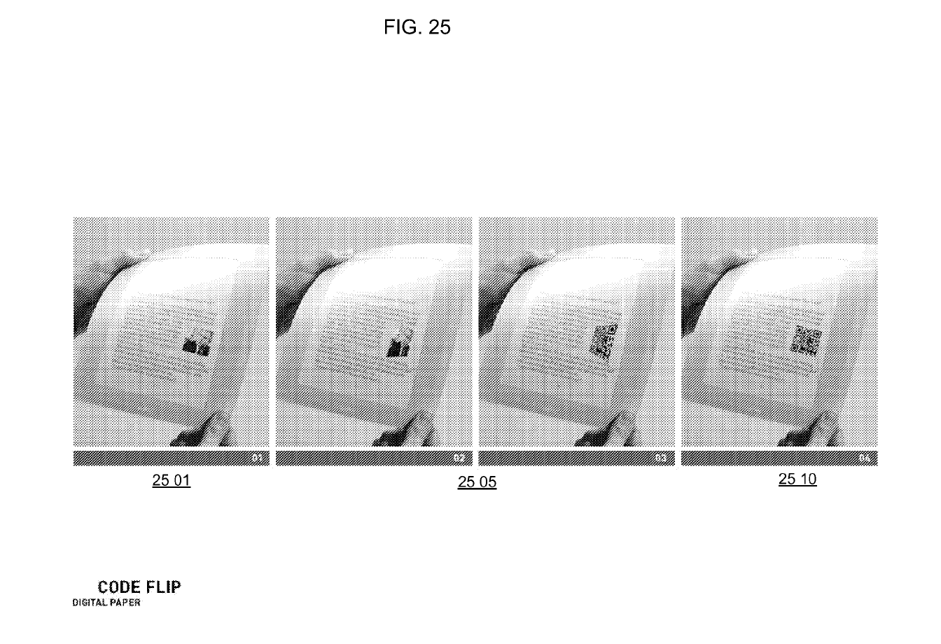

FIG. 25 illustrates a user interface manifesting GCSI/CTIS functionality on digital paper in one embodiment of GCSI/CTIS operation. Here, an image is included in one area of an article displayed on the paper (2501). Either by itself or in response to some user action, the image flips (2505) to reveal the code on its other side (2510).

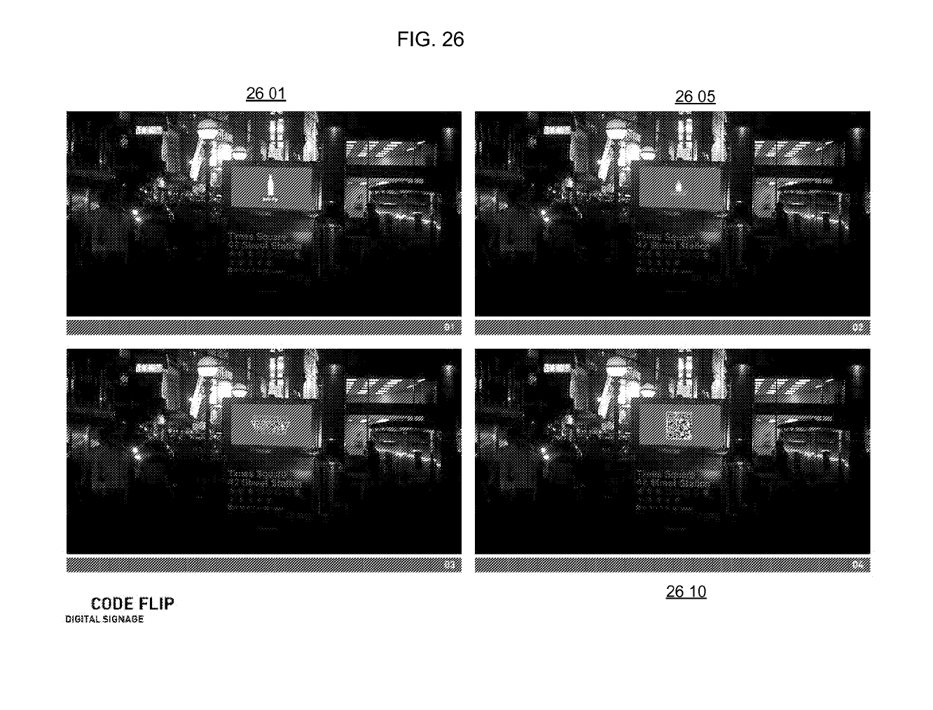

FIG. 26 illustrates a user interface manifesting GCSI functionality on a digital billboard in one embodiment of GCSI/CTIS operation. A public, electronic billboard display shows an advertisement comprising a product logo (2601). The product logo rotates (2605) to reveal a matrix code on its opposite side (2610). Flipping of the logo may occur periodically or aperiodically, upon detection of a nearby viewer, upon detection of a portable device capable of decoding the matrix code, and/or the like.

Embodiments are directed to apparatuses, methods, and systems for a code-mediated content delivery platform comprising a Graphical Code-Serving Interface and a Code Triggered Information Server (“GCSI/CTIS”). The GCSI/CTIS connects information encoding symbologies, and by proxy the underlying information content, to graphical display elements, to graphical interface elements and facilitates generation of encoding symbologies, error-correction, media sampling and purchasing, social networking, and sales promotion programs.

In an embodiment, active display elements provide access to information, particularly information that is targeted to an individual's profile, interests, and/or contextual surroundings and that is portable and/or made available in unexpected physical locations. The active display elements facilitate the serving of such information via placement of information encoding symbologies, such as matrix codes, proximate to graphical elements in a wide variety of digital display contexts and media, including portable display devices, mp3 players, cell phones, digital paper, animated billboards, websites, Internet or television broadcasts, software interfaces, and/or the like. Users may capture images of information encoding symbologies from such displays, for example using a cell phone camera, and decode them with software applets to receive additional information, multimedia content, offers, coupons, notifications, and/or the like.

In one embodiment, a code sent via a communications network from a mobile communications device from a user is received. The code is based on a scan of an optically-readable coding symbol. A code database is queried to discern a multimedia content data identifier corresponding to the received code. Multimedia content data is retrieved from a multimedia database based on the multimedia content data identifier. A sample of the multimedia content data is sent to the mobile communications device via a communications network. A sample acceptability message is received from the user. The multimedia content data is sent to a data repository associated with the user provided that the sample acceptability message indicates that the user wishes to receive the multimedia content data.

In another embodiment, an alphanumeric string comprising a plurality of characters and representing a location of multimedia content data is received from a first data source. Each of the plurality of characters of the alphanumeric string is converted into a corresponding binary number to yield a plurality of binary numbers based on a character correspondence table. The plurality of binary numbers is concatenated to yield a bitwise array. An optically-readable encoding symbol comprising a plurality of disconnected solid shapes is drawn in which the presence of a solid shape at a position in the symbol indicates presence of a 1 in a corresponding position of the bitwise array.

In another embodiment, an incomplete code associated with an optically readable encoding symbol is received. A code database is queried based on the incomplete code to determine a plurality of possible matching codes. The code records associated with the plurality of possible matching codes are queried to retrieve code presentation conditions associated with each of the plurality of possible matching codes. A plurality of code repair schemes are retrieved from a code repair database based on code presentation conditions. Each of the plurality of code repair schemes are applied to the incomplete code to yield a plurality of repaired codes. A repaired code is selected from the plurality of repaired codes based on at least one pre-designated code fidelity rule. The repaired code is designated as a correct code corresponding to the optically readable encoding symbol.

In another embodiment, a scan indicator comprising an indication that a user has scanned an optically-readable encoding symbol with a mobile scanning device is received. The optically readable encoding symbol is associated with a good or service. A retailer at which the user scanned the optically readable encoding symbol is identified. A retailer record is queried to determine whether the retailer is subscribed to a sales promotion program. The retailer is charged a first retailer fee based on the received scan indicator if the retailer is subscribed.

In another embodiment, an on-line social network is provided. A user identifier is received and stored. User profile information is received and stored in association with the user identifier. A plurality of user scan indicators indicating that a user has scanned a plurality of optically readable encoding symbols are received. The plurality of user scan indicators are stored in association with the user identifier. At least one friend designation indicating an association with at least one other user is received and stored in association with the user profile.

Users may scan codes found in media publications, on billboards or signs, on consumer products or packages, on websites or television screens, on movie screens, on clothing or accessories, on mobile device displays, and/or the like.

In an alternative embodiment, content associated with a captured code or other user interest registration may be sent to a data repository other than a user's mobile device. For example, a user may scan a code corresponding to media content. Rather than triggering the GCSI/CTIS to send the media content to the mobile device with which the code was scanned, the code scan may trigger the GCSI/CTIS to send the media content to a user's computer, an online data repository, and/or the like for storage and later retrieval by the user. For example, the GCSI/CTIS may discern a user identity from the Scan Message (115), query user access and/or authorization information, and use that access and/or authorization information to access an online data repository corresponding to the user to store requested media content thereon for later retrieval and/or use by the user.

FIG. 7B illustrates a user profile user interface in one embodiment of GCSI/CTIS operation. The profile page (760) may include a display of basic user information (763) and/or a user picture (766), and may provide a wide variety of other user information, including demographic information, interests, media libraries, friend lists, code scanning activities, and/or the like. The display further includes a plurality of tabs (769) allowing the user to view profile information, edit his or her profile, view photos, groups to which the user may belong, and/or edit settings, including sharing and/or privacy settings (772). Privacy settings may, for example, control access of other individuals to a user's personal information, code scanning activity, and/or the like. In some embodiments, certain information about a user, in particular regarding codes that a user has scanned and/or the content associated with those scans, may be shared with other users. For example, a user may be able to inquire, via a GCSI/CTIS affiliated system, as to what codes have been recently scanned by other users that are within a particular geographic radius of the user. In another example, a user scanning a code to receive a song may also be provided with information about the code scanning activities of other users whose codes also corresponded to songs.

In one embodiment, a user may be allowed to restrict which information of theirs is sent to other users and/or to restrict which information of other users is sent to them. For example, a user may have a “friends” list that has a different level of access than the general public.

In one embodiment, a user may have a personal code that is associated with the user and/or a user profile. In one embodiment, other users can scan the personal code to automatically join the first user's friend list. In another embodiment, a personal code may comprise a short-link to the user's profile (760), and/or to other profile pages or web pages associated with the user, such as a Facebook page, Myspace page, and/or the like. In one embodiment, the user can set a forwarding instruction on his or her GCSI/CTIS page to forward inquiries corresponding to scans of the user's personal code to another page. In another embodiment, the user may provide the personal code on other pages as a link back to the user's GCSI/CTIS profile page.

In one embodiment, a user may be provided recommendations in response to a code scan. For example, the user may scan a code corresponding to a particular song by a particular musical artist. The user may then be provided a listing of other songs, artists, and/or the like having codes recently scanned by the members of the user's friends list and/or that may be further related to the song and/or artist whose code the user scanned.

In one embodiment, a user's code scans may be integrated with an instant messaging, blogging, micro-blogging, and/or the like service, whereby the user's code scans are automatically rendered as descriptive summaries and displayed to other users, such as on a webpage, via SMS text messages, e-mails, and/or the like. For example, each code scan may have a pre-set text description associated therewith that, upon scanning of the code, is displayed on a user's Twitter.com page. In one embodiment, a user may receive an incentive payment for particular types of content that are provided to the user's friends, associates, blog subscribers, and/or the like as a result of the user's code scans. For example, a reward may be provided to the user every time the user scans a code corresponding to a particular brand of products and a message associated with those products is supplied to subscribers to the user's profile and/or blog. A further reward may be provided to the user if it can be determined that one of the user's associates made a purchase based on the provided message.

The privacy settings include permissions for displaying “twitters”, songs, videos, and purchases (775) associated with the user's code scans to various security levels for other people (778), including the general public, private/friends, and “snaps” (i.e., those who may have scanned a user's personal code and/or a code corresponding to the user's profile). Selection of a particular privacy setting may generate a sharing rule that is stored in association with the user and consulted each time a user scans a code corresponding to one of the categories shown at (775) to determine whether or not code-associated information should be provided and/or sent to any of the categories of people shown at (778).

The profile page (760) further includes a field (779) wherein a user may specify the location of a data storage facility to which some or all media and/or other content that the user acquires via code scans are to be sent and/or stored. For example, the user may specify an online storage facility (e.g., Apple's iDisk service) in which the user's code scan-acquired content is to be stored.

The profile page (760) further includes interface components configured to generate a personal code, in this case a JagTag (780). Selection of the button at (780) causes the GCSI/CTIS system to associate a code with the user and/or the user's profile and generate a corresponding code, which is displayed for the user. The user may then elect to save an image of the code to his or her computer desktop, send the code in an e-mail, send the code in an MMS message, and/or the like via the interface elements at (781).

In one embodiment, coupons may be supplied to a user's mobile device with digital rights management (DRM) software included to prevent or discourage coupon copying, sharing, and/or the like. In another embodiment, no DRM software is included with the coupon.

In one embodiment, a GCSI/CTIS may query, store, and/or consider data pertaining to media demographics associated with a particular medium in which a code is published; the subject content associated with a code; the type of information requested by scanning a code; and/or the like. For example, a user scanning a code associated with a product review for a hybrid sports utility vehicle (SUV) in a men's magazine may trigger a GCSI/CTIS system to draw and/or analyze data pertaining to media demographics associated with the men's magazine, subject content associated with hybrid vehicles (i.e., environmentally conscious consumers), subject content associated with SUVs (i.e., outdoor activity or families), and product reviews. Thus, the GCSI/CTIS may be configured to consider both the subject of a user's inquiry, the source of the inquiry, the type of inquiry, and/or the like.

In another embodiment, the GCSI/CTIS may allow users to instantly subscribe to and/or enroll in services, loyalty programs, discount programs, and/or the like by scanning codes associated therewith. For example, a user may subscribe to receive weather updates by scanning a weather-linked code. In another example, a user may enroll in a brand-affiliated coupon program by scanning a code associated with that program. Selection of a subscription and/or enrollment code may cause the GCSI/CTIS to submit a user's personal information to an integrated subsystem and/or third-party system for subscription registration. In some embodiments, the GCSI/CTIS may require verification from the user, separate from the code scan itself that the user wishes to enroll and/or subscribe to the associated service. In some embodiments, a user may submit trigger specifications and/or conditions for enrolled service notifications. For example, a user may specify that he or she only wishes to receive weather updates associated with heavy rain or thunderstorms. In another example, a user may specify that he or she only wishes to receive coupons for products from a particular grocery store and not from other grocery stores. Scanning of a code associated with a subscription program wherein specification of triggers and/or conditions is permitted may cause a GCSI/CTIS system to retrieve and display a user interface screen to the user that is tailored to the particular subscription and/or enrollment service and configured to receive trigger and/or condition specifications.

In another embodiment, the GCSI/CTIS may be configured to track and/or implement a rewards program. For example, in an embodiment, a user of a single-tiered rewards program may scan a code every time he or she purchases a particular item (e.g., a sandwich from the local sandwich shop) in order to register each purchase and store a record thereof in association with the user. The user may then receive a discount, free item, and/or the like after a pre-designated number of purchases and associated scans are registered, after which the record of scans is reset to start anew. In another example, in another embodiment, a user of a multi-tiered rewards program may continue to register additional purchases and associated code scans to receive larger and/or more significant benefits, discounts, and/or the like.

In another embodiment, the GCSI/CTIS may be configured to implement contests and/or prize awards. For example, a user may enroll in a contest by scanning a code associated with the contest, causing personal information, user identifiers, and/or the like to be submitted to a contest subsystem. Such contests may comprise instant-win and/or other types of lotteries, auctions, raffles, and/or the like and/or may enroll the user in a contest program through which they may receive further instructions, possibly including additional codes for scanning, in the future.

In another embodiment, the GCSI/CTIS may be configured as a voting facility. A user may register a vote for a particular candidate, ballot initiative, viewpoint, survey result, and/or anything else for which a vote may be registered by scanning a code associated with the user's choice. In one embodiment, a user identifier may be discerned and submitted with the vote in order to prevent repeat voting, to correlate with voter registration, and/or the like. In one embodiment, voter identifying information may be stripped from a scan message prior to the message being provided to particular agencies or individuals, in order to preserve a secret-ballot style of voting.

In another embodiment, the GCSI/CTIS may be configured as a facility to effectuate purchases of goods and/or services. By scanning a code associated with a particular good or service, a message may be sent to a GCSI/CTIS system identifying the good or service associated with the code as well as identifying the user, such as based on a mobile device identifier. The GCSI/CTIS system may then automatically generate a bill for the user, charge a specified credit account, deduct a payment from a debit account, and/or the like to effectuate payment for the good or service. In one embodiment, the GCSI/CTIS may return a payment confirmation, such as to the user's mobile device and/or a retailer's point-of-sale device to confirm that the user has provided adequate payment.

In another embodiment, the GCSI/CTIS may be configured to facilitate communications. For example, a code may correspond to a particular telephone number, IP address, and/or the like. Scanning of the code by a communications-enabled mobile device may cause the mobile device to automatically establish a connection with the address to which the code corresponds. In one embodiment, the connection may be established directly by an on-board applet loaded on the mobile device. In another embodiment, the connection may be established by an instruction sent to the mobile device by a GCSI/CTIS subsystem in response to a received code scan.

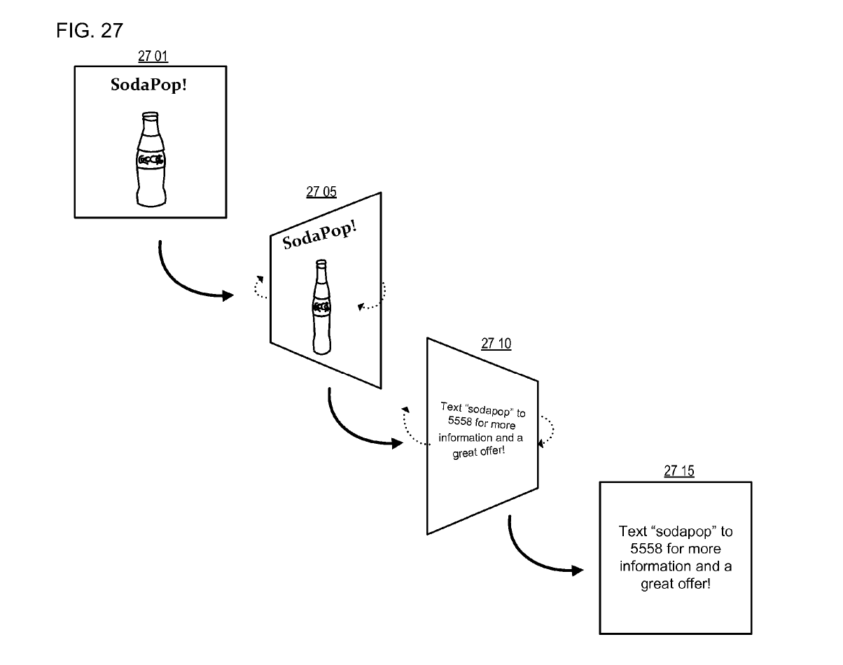

FIG. 27 illustrates a user interface manifesting GCSI/CTIS functionality for serving an

SMS text message prompt in one embodiment of GCSI/CTIS operation. A first visual token (2701) shows an image and text, such as may correspond to an advertisement, logo, and/or the like. The token may appear in a wide variety of contexts, such as on a website, in a virtual world, on a cell phone or other portable communications and/or media device (e.g., Blackberry, iPhone, iPod, and/or the like), on an electronic billboard, on broadcast television or recorded video content, and/or the like. The first visual token may be animated, such as by flipping, rotating, revolving, and/or the like (2705, 2710), to reveal encoded content on a proximate side thereof. As illustrated in FIG. 27, a message appears along with an SMS code that a user may key in to an SMS enabled communication device to receive associated content. In alternative embodiments, other types of codes and/or code communication protocols may be displayed and/or employed for communication with GCSI/CTIS systems, such as but not limited to: MMS, instant messaging, web browser based messaging, e-mail, Enhanced Messaging System (EMS), TCP/IP, WAP, and/or the like. For example, a first visual token may be animated to reveal an e-mail address, website address, instant message nickname, and/or the like on a proximate side to enable a user to connect to and/or communicate with a GCSI/CTIS system and/or affiliated entity for the receipt of information, coupons, offers, advertisements, media, and/or the like.

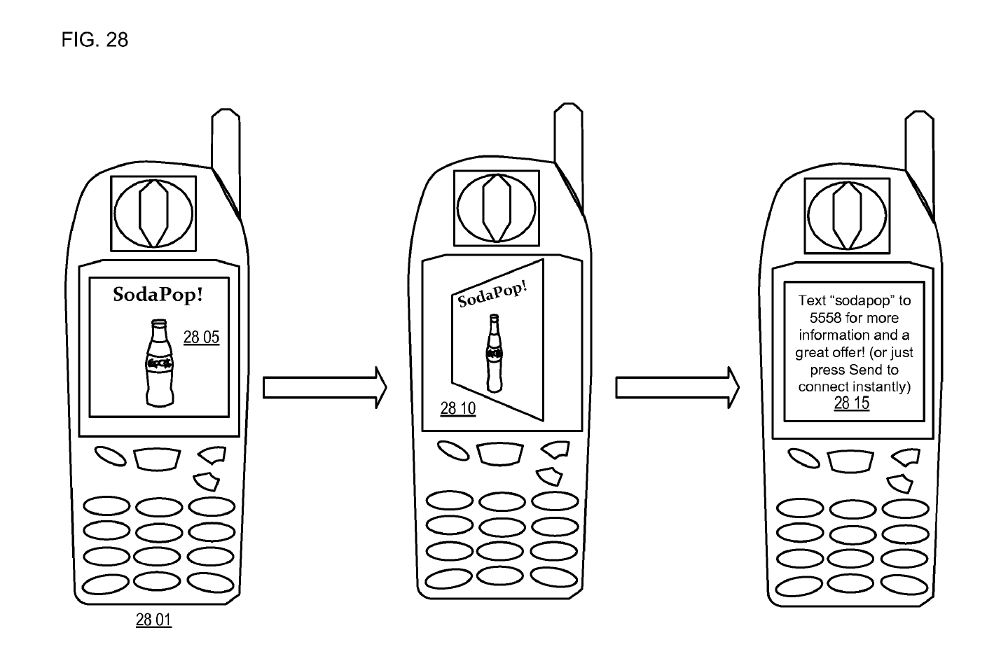

FIG. 28 illustrates a user interface manifesting GCSI/CTIS functionality on a mobile phone (2801) in one embodiment of GCSI/CTIS operation. A first visual token comprising an image, advertisement, logo, and/or the like (2805) is displayed on a mobile phone display screen. The first visual token may be animated (2810), such as in response to a user interaction (e.g., pressing a button on the mobile telephone, clicking on the first visual token with a pointer widget, and/or the like). In an alternative embodiment, the first visual token may be automatically animated and/or animate without the need for any user interaction. In the illustrated embodiment, the animated first visual token flips to reveal a second visual token comprising a message and an SMS text message prompt on a proximate side 2815. In one embodiment, the user may manually key in the text message and/or destination address to receive the associated content. In another embodiment, the GCSI/CTIS interface may supply a selectable link that, when selected, will automatically generate an SMS text message to retrieve the associated content. In still another embodiment, such as the example illustrated at (2815), the user may be allowed to automatically generate and/or send the SMS text message from the second visual token by pressing a “Send” button on the mobile phone, clicking and/or otherwise interacting with the second visual token, and/or the like.

In one embodiment, a user may receive a coupon and/or coupon code in response to an interaction with the second visual token, sending of an SMS text and/or other message in response to the second visual token, and/or the like. For example, in one embodiment, a user may receive a numerical coupon code in response to a sent SMS text message, wherein the numerical coupon code may be presented to a retailer, entered into a website, and/or the like to receive discounts, free items, special offers, and/or the like. In another embodiment, the user may receive a scannable code, such as a QR code, matrix code, and/or the like in response to a sent SMS text message, wherein the scannable code may be scanned by a retailer in order for the user to receive the associated benefits, discounts, and/or the like. For example, the scannable code may appear on a user's mobile phone display screen and may be scannable therefrom to provide the user with the benefits associated thereto. In another embodiment, the user may receive an e-mail message in response to interaction with a graphical code-serving interface, the message containing requested content and/or links thereto, scannable codes, coupon codes, and/or the like.

In another embodiment, a first visual token may comprise a “poster” image corresponding to a full-length movie, movie preview, video clip, television show, and/or the like. The second visual token revealed on a proximate side of the first visual token may then enable a user to retrieve the full video content associated with the poster image. For example, a user may scroll through a series of poster images corresponding to a series of full-length movies. When the user finds a movie he or she desires to retrieve, watch, download, and/or the like, he or she may select the corresponding poster image, which may then be animated to reveal a second visual token, such as an SMS instruction, message, delivery address, phone number, and/or the like, whereby the user may interact with a GCSI/CTIS system and/or affiliated entity to retrieve the desired movie content.

In one embodiment, a series of first visual tokens may be displayed as scrollable thumbnails, within a cinematic presentation, as an immersive slideshow, and/or the like.

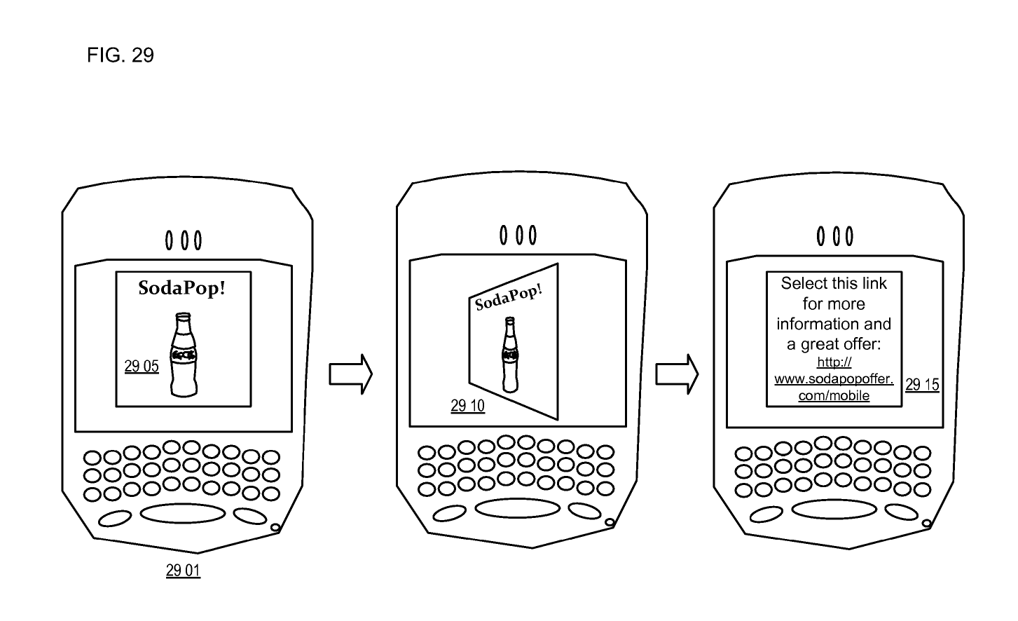

FIG. 29 illustrates a user interface manifesting GCSI/CTIS functionality on a portable communication device in one embodiment of GCSI/CTIS operation. The portable communication device (2901) may represent a blackberry, iPhone, PDA, and/or the like. A first visual token (2905) is animated (2910) to reveal a message and a selectable hyperlink on a proximate side (2915), in this case a URL connecting to content, information, offers, coupons, and/or the like. In one embodiment, a user may be permitted to directly select the hyperlink from the displayed image using interface elements of the device in order to retrieve content, view a webpage, interact with a GCSI/CTIS and/or affiliated system, and/or the like.

A variety of operational models may be employed to provide code-serving interface capabilities to users and content providers alike in accordance with the embodiments and/or embodiments described herein. In one embodiment, a central GCSI/CTIS may enable content providers to supply first and/or second visual tokens, associated SMS and/or MMS codes, and/or any other information necessary to connect users to supplied content. The central GCSI/CTIS may then outfit the supplied tokens and/or other information with HTML markup information allowing the code-serving interface to be embedded in any webpage or other display media. In one embodiment, the HTML markup information may further include a link to one or more downloadable applets that may be required to enable a user to view and/or interact with the code-serving interface. Having provided the data corresponding to a first and/or second visual token, SMS and/or MMS code, and/or other information, a content provider may be provided with an embeddable link, URL, and/or the like that may be cut and pasted into a web page HTML to embed the code-serving interface therein.

In another embodiment, a content provider may submit just a first visual token and response content and/or a means of addressing said content, and a GCSI/CTIS may generate a corresponding code-serving interface, a dial-in code and/or SMS and/or MMS address, hyperlink, and/or the like to allow users to interact with the first visual token to receive the response content. In one embodiment, the generated code-serving interface may include HTML markup information enabling it to be embeddable on any webpage. A fee may be charged to the content provider, such as on a pay-per-click basis, for user interactions with the generated code-serving interface.

In still another embodiment, a webpage or other display area may include a generic placeholder for code-serving interfaces that may be filled by code-serving interfaces and/or associated content supplied from one or more advertisement servers and/or GCSI/CTISs. The supplied code-serving interfaces may be selected based on webpage content, contextual cues, and/or the like and/or based on the goals of content providers and/or code-serving interface creators. For example, an advertiser may wish to place a particular code-serving interface associated with a new action movie on any webpage having a generic placeholder that mentions extreme sports. A fee may be charged to an advertiser for such targeted and/or contextual placement, such as on a bid-per-keyword basis. Fees may also be charged on a pay-per-click basis (i.e., levying a charge whenever a user clicks a code-serving interface to reveal the code, communication address, and/or the like on a proximate side).

GCSI/CTIS Media Acquisition Example

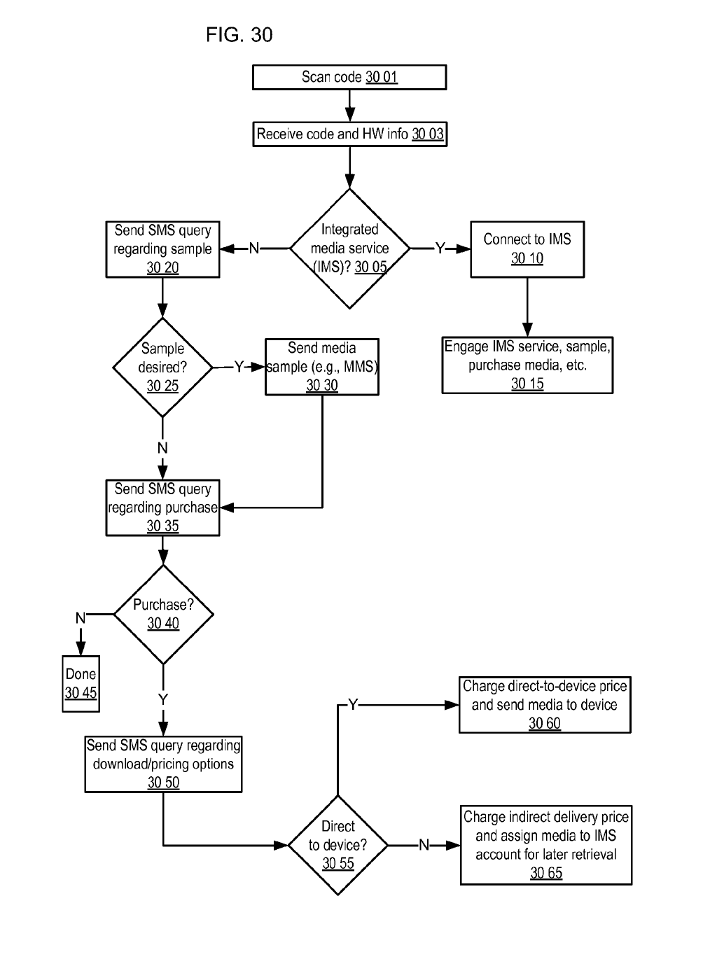

In some embodiments, the GCSI/CTIS may be configured to supply media content, music, images, video, and/or the like to users based on the scanning of codes, as described above. Acquisition of full media content may, in some embodiments, be preceded by acquisition of media samples that may be reviewed by an acquiring user to determine whether or not to proceed with acquisition of the full content. For example, a billboard may display the Billboard Top 20 songs with a separate code for each song on the list. Consumers, in this example, may scan codes corresponding to each song in the list for which they have interest using a mobile scanning device and receive a sample of each song. In one embodiment, a sampling user may further be provided with an opportunity to purchase and/or otherwise acquire the full media content once the sample has been received and/or reviewed. In one embodiment, media may be acquired by a user via MMS messaging, while in another embodiment, media may be acquired by means of an integrated media service (IMS). In one embodiment, the IMS comprises an on-demand media service wherein users may maintain accounts, sample and/or purchase media, download and/or upload media, and/or the like. An example of an IMS is Apple's iTunes Store. FIG. 30 illustrates a logic flow for media sampling and full media acquisition in one embodiment of GCSI/CTIS operation. A code may be scanned by a user (3001), such as via a mobile device. The scanned code information, as well as hardware information identifying the device, the user, and/or the like may then be received by GCSI/CTIS from the mobile device, such as via a communications network. The GCSI/CTIS may then make a determination, such as may be based on the hardware information, user information, a user profile, and/or the like, as to whether the mobile device is configured with an IMS (3005). If the mobile device is configured with an IMS, the GCSI/CTIS may issue an instruction to the mobile device to connect to the IMS (3010), allowing the user to engage IMS functionality such as the sampling, purchasing, downloading, viewing/playing, and/or the like of media files (3015).

If the user's mobile device is not configured with an IMS, the GCSI/CTIS may send a message to the device, such as an SMS text message (3020), to determine if the user desires to receive a sample of the requested media (3025). In one embodiment, the GCSI/CTIS may first interact with a media service to determine if a sample is available before offering the sample to the user. If a sample is desired, the GCSI/CTIS may send a media sample to the user's mobile device, such as in the form of an MMS message. The sample may, in various embodiments, comprise a clipped and/or low-quality version of an audio file, image file, video file, publication, and/or the like. In one embodiment, the GCSI/CTIS may first acquire the sample from a music service in order to provide it to the user's mobile device. In an alternative embodiment, the GCSI/CTIS may itself generate a sample from an original copy of a media file, such as may be acquired from a media service.

The GCSI/CTIS may then generate and send a query, such as via SMS text message (3035), to determine if the user would like to purchase the media associated with the scanned code (3040). If not, the GCSI/CTIS may exit the routine associated with the acquisition of the current media file, present alternative and/or related media files for user consideration, and/or the like (3045). If, on the other hand, the user indicates a desire to purchase the media file in question, the GCSI/CTIS may query the user, such as via an SMS text message, as to which of a selection of pricing and/or download options the user would like to pursue (3050). For example, in various embodiments, the user may be provided with options as to the quality and/or format of media files acquired, the method of acquisition, accessibility and/or rental options, and/or the like. As illustrated, the user may be presented with an option as to the method of media acquisition. Specifically, a determination may be made as to whether or not the media is to be acquired directly by the user's mobile device (3055). As illustrated, the determination is based on a user preference. However, in alternative embodiments, the determination may be made, in whole or in part, based on a variety of other factors, such as detected capabilities of the user's mobile device, available network bandwidth, pre-set profile settings, and/or the like. If the user selects for the media to be directly provided to his or her mobile device, then a corresponding fee may be charged and the media may be streamed, downloaded, and/or the like directly to the user's mobile device (3060). Alternatively, if the user does not desire to acquire the media directly to his or her mobile device, then the GCSI/CTIS may charge a price corresponding to an indirect delivery mode and conduct the media file to an intermediary storage facility for later retrieval (3065). For example, the GCSI/CTIS may instruct a media service to allocate the media file to a user account for later retrieval by the user. In another example, the GCSI/CTIS may acquire the media file and/or e-mail the file to a user e-mail account for later retrieval. When the user is ready, he or she may obtain the media file from the intermediary storage facility, transfer the file to a mobile device, and/or the like.

The charging of a fee for acquired media may proceed in a variety of different manners within various embodiments of the GCSI/CTIS. For example, in one embodiment, a user may be directly requested to enter payment information (e.g., credit card number, checking account number, etc.) at the time of purchase. The entered information may be verified before the media is made available to the user and/or the user's mobile device. In another embodiment, a user may enter payment information into a user profile and have a corresponding account automatically charged when the user directs the GCSI/CTIS to acquire media.

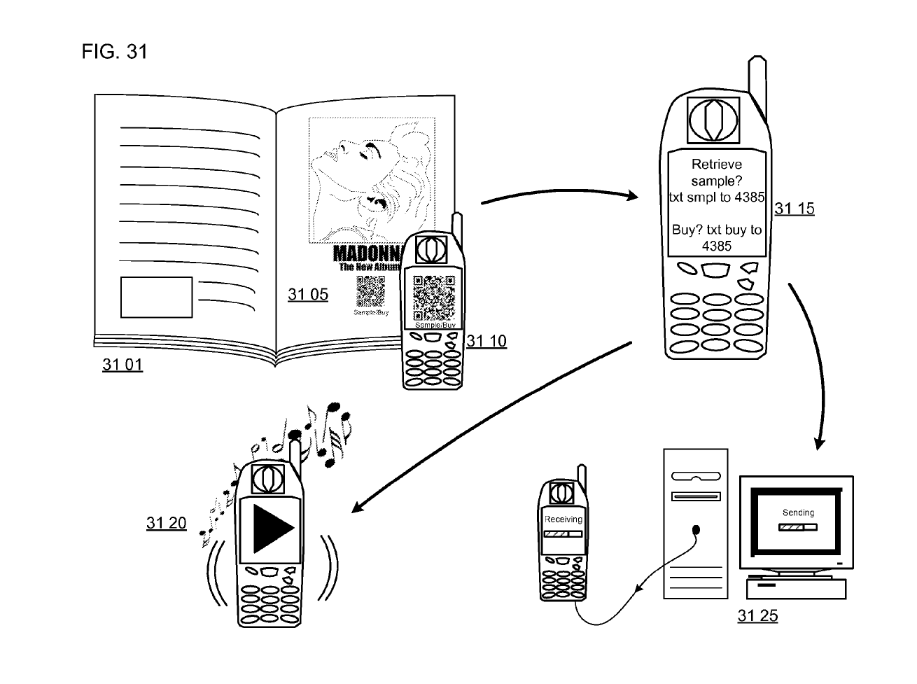

FIG. 31 illustrates media acquisition in one embodiment of GCSI/CTIS operation. As illustrated, a printed publication (3101) displays an advertisement for a new release by a recording artist (3105), the advertisement including a scannable matrix code that facilitates the acquisition of media associated with the new release by a user. In an alternative embodiment, an animated user interface may present a scannable code on a proximate side of a first image, such as on a video billboard, website, television program, and/or the like. The media may, for example, comprise an entire album, a single, a ringtone, a video, an image, and/or the like. In one embodiment, the media provided may depend on the scanned code in conjunction with a user profile containing user preferences, a history of user behavior and/or prior scanned codes, and/or the like. The user may engage the media content by scanning the code with his or her mobile device (3110), after which the GCSI/CTIS may query the user, such as via an SMS text message, as to whether or not he or she wishes to sample and/or purchase the requested media (3115). The user may respond, in one embodiment, by sending a reply text message to be relayed to the GCSI/CTIS. In one embodiment, the GCSI/CTIS may subsequently provide, stream, upload, and/or the like the requested media directly to the user's mobile device for storage and/or playback (3120). In another embodiment, the GCSI/CTIS may provide the requested media to an intermediary storage facility, such as a user's media service account, an e-mail server, an ftp server, and/or the like. The user may then subsequently procure the media from the intermediary storage facility, transfer the media to a mobile device, and/or the like (3125) at a later time.

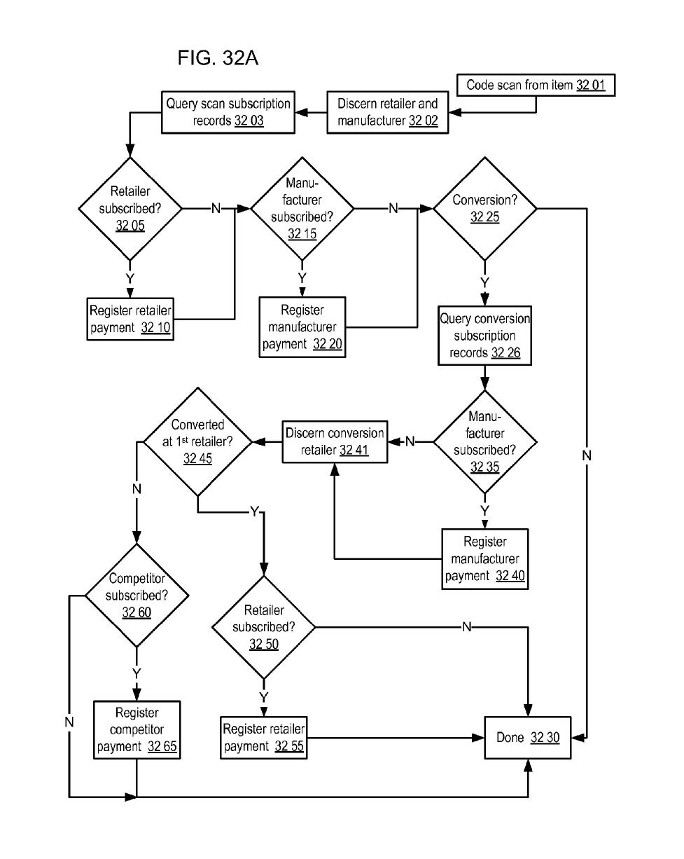

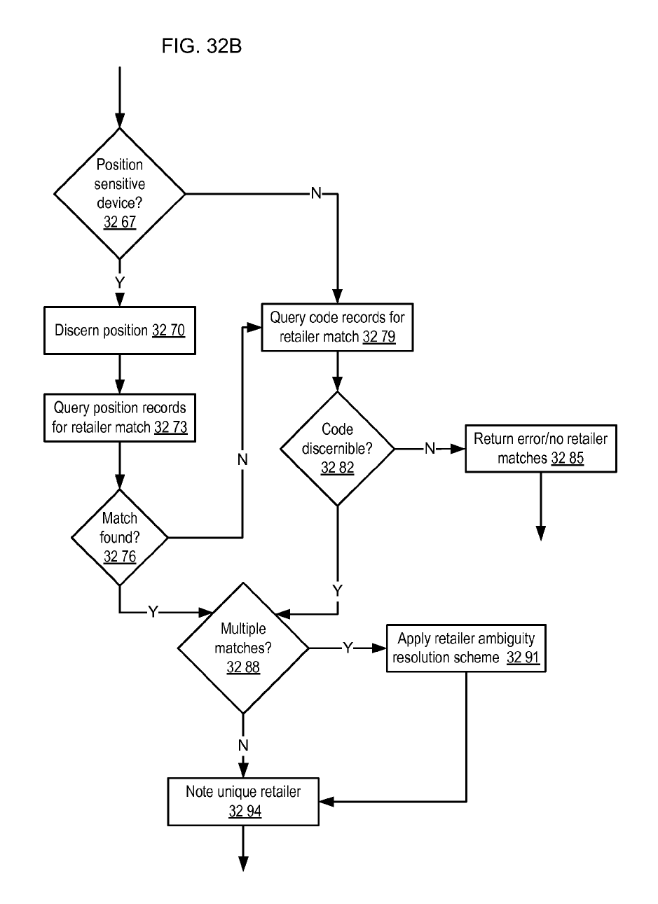

FIG. 32A-B illustrate logic flows for code scan monetization in one embodiment of GCSI/CTIS operation. In FIG. 32A, a code is scanned at (3201). As illustrated, the code may be found on a physical item that is subject to purchase and may be found in a retail establishment. For example, a compact disc (CD) in a music store may be embellished with a scannable code that, when scanned, may provide a sample of the music stored on the CD, deliver a ringtone to the user's mobile scanning device, provide artist information, images, concert dates, a coupon, and/or the like. In another embodiment, the item for purchase may not be physical but rather may be provided online, such as on a website, and an associated code may be provided on the page on which the item is offered for purchase. Once the code is scanned (3201), a determination may be made as to whether the retailer providing the item is subscribed to a GCSI/CTIS service (3205). In one embodiment, the retailer may be discerned based on a geographic position provided to the GCSI/CTIS by a code message sent from the user's mobile device that may, for example, be compared to records of retailer locations. The geographic position may be determined, for example, by an on-board GPS unit on the user's mobile device or based on geographic information contained in the scanned code. Subscription to the service may, for example, entail licensing to embellish items with GCSI/CTIS affiliated codes in exchange for a fee, such as a one-time or periodic fee and/or a per-scan fee, such as illustrated in FIG. 32. If the retailer is determined at 3205 to be a subscriber, then the GCSI/CTIS may register a retailer payment (3210). For example, in one embodiment, registering payment may comprise noting the fee in a fee record. In an alternative embodiment, the GCSI/CTIS may automatically deduct the fee from a pre-designated account. A determination may also be made as to whether the manufacturer, publisher, distributor, and/or the like of the item in question is a subscriber (3215). For example, for the case of the CD discussed above, the “manufacturer” may comprise a record label. If the manufacturer is determined to be a subscriber, then a manufacturer payment is registered at (3220).

Discernment of retailer, competitor, and/or manufacturer identities may be accomplished by a variety of different schemes in various embodiments and/or embodiments of GCSI/CTIS operation. For example, a unique subset of codes may be reserved for a particular manufacturer, retailer, and/or the like, such that a scan message corresponding to any code of the unique subset may be associated by a GCSI/CTIS system with the particular manufacturer, retailer, and/or the like. In another embodiment, retailers associated with a given scanned code may be discerned based on a geoposition of the mobile scanning device at the time of code scanning FIG. 32B illustrates a logic flow for discerning retailers in one embodiment of GCSI/CTIS operation. A determination is made at (3267) as to whether the mobile scanning device used to scan a code is position sensitive. Position sensitivity of a mobile device may be facilitated, for example, by an on-board GPS unit, mobile device and/or cellular tower triangulation, trilateration, multilateration, and/or the like. If the device includes one or more position sensitive facilities, the GCSI/CTIS may discern the position of the mobile device (3270). Position discernment by the mobile device and/or the GCSI/CTIS may include drawing raw geographic position data from one of the facilities described above using, for example, mobile device software development kit (SDK) tools, an example of which are those associated with the iPhone SDK toolkit. The GCSI/CTIS system may then query position records based on the position discerned at (3270) to seek retailers matching that position (3273). A determination is made at (3276) as to whether any matching retailers are found. If no retailers match the discerned mobile device position, or if the mobile device lacks position sensitivity at (3267), the GCSI/CTIS system may query code records based on the scanned code received from the mobile device to seek retailers matching the scanned code (3279). A determination is made at (3282) if any retailers are code discernible and, if not, then the GCSI/CTIS may return an error message and/or record that no matching retailer was found (3285). If any matches are find either by position or code discernment, then a determination may be made as to whether there exist multiple retailer matches (3288). If not, then the unique matching retailer may be recorded, provided to facilitate subsequent code scan monetization, and/or the like (3294). If multiple retailer matches exist, the GCSI/CTIS system may apply one or more retailer ambiguity resolution schemes (3291) in order to narrow down the results to a unique retailer match. A wide variety of ambiguity resolution schemes may be employed within different embodiments and/or embodiments of GCSI/CTIS operation. For example, in one embodiment, a GCSI/CTIS system may consult a user profile associated with the user who's mobile device issued the code scan to determine whether the user's code scan history indicates a preference for a particular retailer, retailer type, and/or the like which may assist in further discerning the unique retailer associated with the current code scan. In another embodiment, the GCSI/CTIS system may provide a plurality of possible retailer matches in a message (e.g., an SMS message) to a user's mobile device and request feedback as to which retailer is the correct one in whose establishment the code was scanned.

A determination may then be made as to whether a conversion has taken place whereby the user has actually purchased the item associated with the scanned code. In one embodiment, the GCSI/CTIS may monitor activity on a credit card associated with a user account once that user has registered a code scan. A subsequent purchase using the associated credit card may then register a conversion with the GCSI/CTIS. If no conversion is detected, such as within a pre-designated period of time, then the code scan monetization is complete for the particular code scan (3230). If, on the other hand, a conversion is registered, then a determination may be made as to whether the manufacturer is subscribed to pay further fees upon item conversion (3235). If so, then the additional manufacturer payment for conversion is registered at (3240).

A determination may be made as to whether the conversion, i.e., the purchase of the code-associated item, was made at the retailer at which the code was scanned (3245). If so, then a determination may be made as to whether the retailer is subscribed to pay an additional fee associated with item conversion (3250). If so, that payment is registered at (3255). If the conversion occurs at a competitor retailer different than the original retailer at which the item-associated code was scanned (e.g., another brick-and-mortar retailer, another website, etc.), a determination may be made as to whether the competitor retailer is subscribed to pay a fee for item conversion (3260). If so, then the competitor payment may be registered at (3265). In one embodiment, a competitor may be permitted to supply a message (e.g., an SMS text message, and/or the like) to a user's mobile device when the user scans codes associated with particular items at particular retail locations in order to entice the user to purchase the item from the competitor instead of at the particular retail location in which the code was scanned. The competitor message may, for example, include a coupon and/or other discount on the sale price of the code-associated item. In one embodiment, the competitor may be charged a separate fee for being allowed to supply such messages, such as a per-message fee, a one-time or periodic fee, and/or the like.

In some embodiments, fees charged to manufacturers, retailers, and/or competitors may be substantially the same. In alternative embodiments, different fees may be charged to manufacturers, retailers, and/or competitors.

FIG. 33A-E illustrate aspects of JagTag encoding and codes in some embodiments of GCSI/CTIS operation. FIG. 33A illustrates a logic flow for JagTag encoding in one embodiment of GCSI/CTIS operation. An alphanumeric string may be associated with content to which a JagTag code is ultimately to be associated 3301. In one embodiment, a five character string is employed. Each character of the alphanumeric string may then be converted into a corresponding integer, such as may be based on a correspondence table (3302). FIG. 33B illustrates such a corresponding table relating decoded characters, including lowercase letters (3313), numbers (3314), and uppercase letters (3315), to encoded values (3316) comprising integers between 0 and 62. To convert the alphanumeric string into a JagTag code, each character in the string is converted into a corresponding integer between 0 and 62 using the table in FIG. 33B. A determination may then be made as to whether any of the characters comprise punctuation marks or other unrecognizable or uncovertable characters (3303). If so, those characters are set to blanks or zeros in the resulting string of integers (3304). A determination may also be made as to whether the number of characters in the alphanumeric string exceeds a pre-designated maximum number (3305) (e.g., 5 characters). If so, additional characters are ignored (3306).

Each resulting integer may then be converted to a corresponding binary value (3307), and a determination may be made as to whether there are a sufficient number of “on” bits (i.e., bits equal to 1) (3308). For example, the GCSI/CTIS may require the existence of at least some minimum number (e.g., 9) of on bits. If not, then the system may return an error message and/or recommend that the user try a different initial alphanumeric string (3309). Otherwise, the GCSI/CTIS system may concatenate the string of binary numbers to yield a single 32 bit long bitset array (3310). The system may then generate a JagTag bit representation (3311), as described below, and output the resulting JagTag to a physical display and/or storage (e.g., storing an image formatted JagTag in a database, printing the JagTag, displaying the JagTag on a display screen, and/or the like) (3312).

The first bit of the bitset array may be considered a most-significant bit and the last bit of the bitset array may be considered a least-significant bit. Once complete, the 32 bit binary bitset array may be converted into a JagTag code representation. FIG. 33C further illustrates JagTag encoding according to an embodiment. The JagTag may include an L-shaped component (3318) that may promote orientational and/or size discrimination of the JagTag, such as by a scanning or analyzing device. The JagTag may further include four circular elements (3319) that may also serve to promote orientational and/or size discrimination. The most significant bit of the bitset array may be encoded as a circle at the position indicated by the crossed circle at (3320), with a white circle (owing to the dark background of the L-shaped component (3318)) indicating a 1 and no circle indicating a 0. The next most significant bit of the bitset array, then, may be encoded as a circle at the position indicated by the crossed circle at (3325). The numbering scheme indicated at (3330) shows how the circles (or lack of circles) at positions numbered from 0 to 31 correspond to the bits in the 32-bit bitset array, with 0 the most significant bit and 31 the least significant bit. If the bit falls on the L-shaped component (3318), a white circle is drawn for a bit value of 1, and otherwise a dark circle is drawn for a bit value of 1.

In one embodiment, a shell script may be configured to accept an alphanumeric string comprising characters to be encoded and to return a JagTag in an image format, such as a PNG, JPG, GIF, BMP, and/or the like file format. In one embodiment, the shell script may be further configured to receive a color specification (e.g., an HTML-style RGB triplet).

Configuring a JagTag for optimal recognition may be accomplished in a variety of different ways within different embodiments. For example, a color for the JagTag code may be selected to as to have high contrast with the background color. A high number of “on” bits (i.e., bits equal to 1) may also improve code recognition, as discussed above. Accordingly, in one embodiment, resulting JagTag codes having fewer than a minimum number of on bits may be rejected. Other measures that may be taken in various embodiments to improve JagTag recognition may include maximizing code dimensions, ensuring that the code is surrounded by a substantial margin (e.g., at least 25% of the code's width and height), and ensuring fidelity of the code by eliminating any obscuring interferences. JagTag codes may be configured for a wide variety of physical manifestations, including printing on magazine pages, billboards, newspapers, and/or the like, displaying on video display screens, television broadcasts, websites, and/or the like. JagTags may also be configured into different shapes or display configurations in various embodiments.

FIG. 33D illustrates one non-limiting embodiment of data loss resilient codes (3331), with characteristics that include: reducing errors based on “bleeding” of encoded data points by using circles/dots rather than squares that touch each other (this combats fuzziness of image as well as reduced light conditions); using a stronger identifier to discover processing directionality (rotation, skew, slant)—this is the black line with white dots shown in the figure; including data points within the identifier in order to maximize encoded data as well as allow for reduction in size of code; using equidistant lengths on identifier to process for skew and slant; using constant data points within the directional identifier to process for skew and slant—this may be top left, bottom right and bottom left white dots (not indicated in FIG. 33D); reducing the amount of data encoded in the code—most likely 5-8 characters—in order to allow for size reduction of the code; developing code characteristics so partial decoding allows for matching code to correct data on the server—for example, if only 70% of the characters from a code are discernible, the GCSI/CTIS can use server logic to extrapolate what the code is as well as the campaign/client it's associated with, i.e., information about the exact publication the code is in may be lost, but the GCSI/CTIS system can figure out the campaign and return an appropriate message; with regard to partial decode matching, server side and database logic focuses both on creating codes for clients and campaigns that are unique sets in order to enable partial decode matching as well as providing a set of rules around time, mobile number, and likelihood in order to determine the best potential match for partial decodes.

In the embodiment of the basic codes (3331) shown in FIG. 33D, design wrapped around the code does not impact the effectiveness of the decoding. High tone color differentials are allowed, so rather than black, dark blue, or red could be used. The white dots in the identifiers are less likely to allow for color changes although a very light yellow or gray may be allowed.

In a further embodiment, the dots most likely to be lost in an image may be assessed and the least useful information encoded appropriately based on that assessment. An interesting opportunity for this code is that it allows for some logos to potentially replace the dots. For example, an Alltel logo can be used nearly as well as the dots, or a Nike logo is decodable with some server side code modifications.

The codes have an additional benefit in that they are in and of themselves, aesthetically pleasing, and as such offer significant advantages over previous codes. The ability in one embodiment, to vary the colors of the code, allows it to better integrate and look better in marketing contexts.

FIG. 33E illustrates alternative JagTag display configurations, including circular (3335), triangular (3340), modified squares (3345, 3350, 3365), rectangular (3370), letter shaped (J shapes shown at (3355 and (3360)), and/or the like. JagTags may also be displayed in proximity to and/or integrated with other codes, logos, insignias, and/or the like, such as shown at (3375).

In an embodiment, a processor-implemented method is disclosed for processing and responding to ambiguous content requests. A scanned code image and a user ID are received and analyzed to determine if the information encoded therein is fully decodable. A scanned code disambiguation process is selected and applied to the ambiguous scanned code images to determine a most likely code. Accumulated user information in a user profile associated with the user ID is queried. A content database is queried to extract requested content based on the most likely code and the accumulated user information. The requested content is sent to the user.

As previously described in reference to FIG. 9, a Scan Message may include a hardware ID (905) that allows content (also referred to as an “Ad”) to be served that is compatible with the capabilities of the device. In an embodiment, content for delivery to a device may be filtered based on the hardware ID (905) such that only compatible content is selected. In another embodiment, the content is not be filtered by hardware ID (905). Rather, when a final Ad has been selected for inclusion in the Reply Message (930) following filtration under the other relevant criteria, the server will determine whether that Ad is properly formatted for the device specified by the hardware ID. If so, then the Ad will be included in the Reply Message (930) as is. Otherwise, it will be converted into the required format appropriate to the user's mobile device. For example, if the selected Ad contains color images but the server determines that the user's hardware device is an early model BlackBerry that only accommodates monochromatic text, the server will implement a peripheral application to strip the text content from the Ad and incorporate only that in the Reply Message (930).

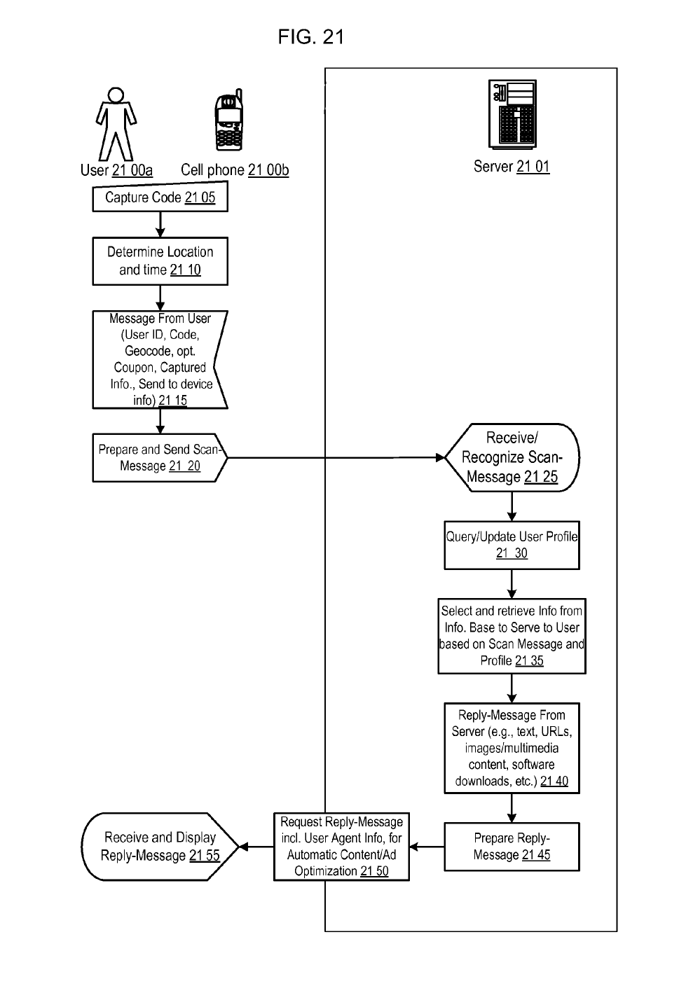

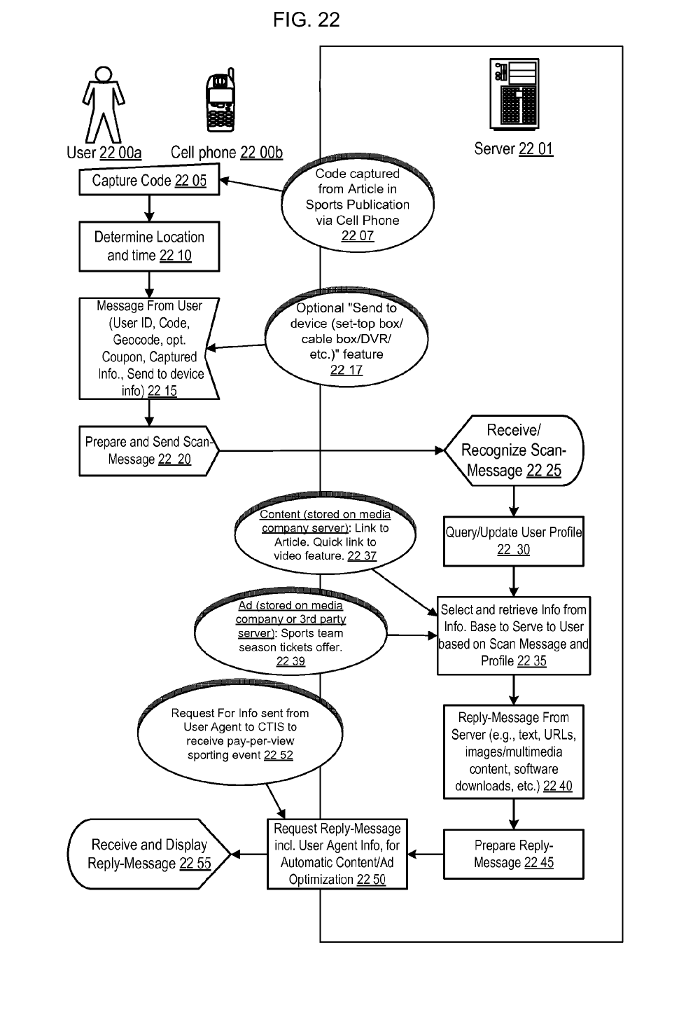

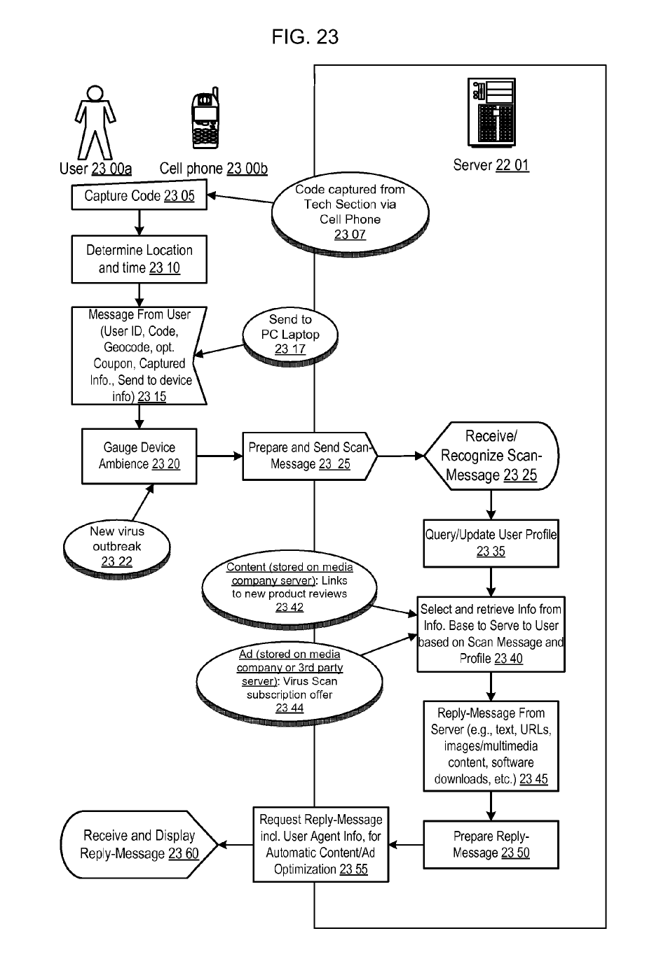

In another embodiment, the CTIS can interface with and optimize Ads for various User Agent devices, which may include PCs, laptops, PDAs, DVRs, cable boxes, Internet-coupled media devices, and generally with programmable electronic devices possessing external data transfer capabilities and/or the like. FIG. 21 provides an illustration of the logic and data flow in one embodiment. At (2115), the Scan Message content further incorporates an optional Send to Device info, which specifies the destination User Agent device for a particular Ad. Then, at (2150), the Ad content selected by the CTIS is configured and/or optimized for the User Agent device. Exemplary embodiments are provided in FIGS. 22 and 23. In FIG. 22, a code from a sports publication is scanned by a cell phone (2207), and a set-top-box/cable box/DVR User Agent device is specified in the optional Send to Device information of the Scan Message (2217).

Consequently, in addition to contextual Ads supplied to the user's cell phone containing article/video links (2237) and season ticket offers (2239), additional content is configured and sent to the User Agent device, such as authorization to descramble a pay-per-view sporting event. In one embodiment, the user's mobile device would provide a signal to the User Agent device to cause it to send a Request for Info to the CTIS. In another embodiment, the CTIS could send an appropriately configured signal to the User Agent device without the need for a Request for Info signal. In FIG. 23, a code is scanned from the Tech section of a media publication using a cell phone (2307), and the optional Send to Device info in the Scan Message specifies to send to a PC laptop (2317). In accordance with the ambient conditions embodiment discussed previously, the CTIS gauges the ambient conditions associated with the device and determines that there has been a recent outbreak of a particular computer virus over the Internet (2322). Consequently, the CTIS supplies an offer for Virus Scan software subscriptions (2344), and may send Virus Scan software directly to the specified PC laptop based on user response.

In another embodiment, the CTIS can connect users based on user profiles. For example, in analogy to the “provider zone” breaches discussed above, the CTIS may also track the intersection of user space-time trajectories. In particular, if one user is within a specified distance of the projected space-time trajectory of another user with whom the first user is associated, a message may be sent to one or both users notifying them of their potential proximity. Further consideration of user profiles may also be utilized in such notifications.

In another embodiment, the CTIS provides targeted coupons to consumers. By scanning a code in an article or advertisement of interest, a user may be provided with a coupon code for a store or establishment near the location where the scan took place, thereby increasing the likelihood that the coupon would be used. Choosing the coupon based on the contents of the user profile may further increase the likelihood of a consummated transaction.

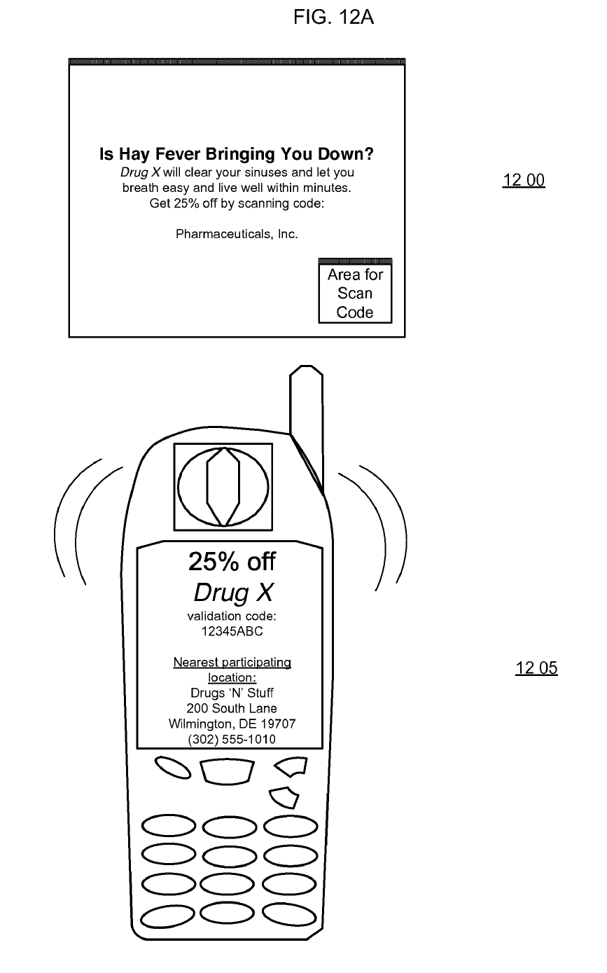

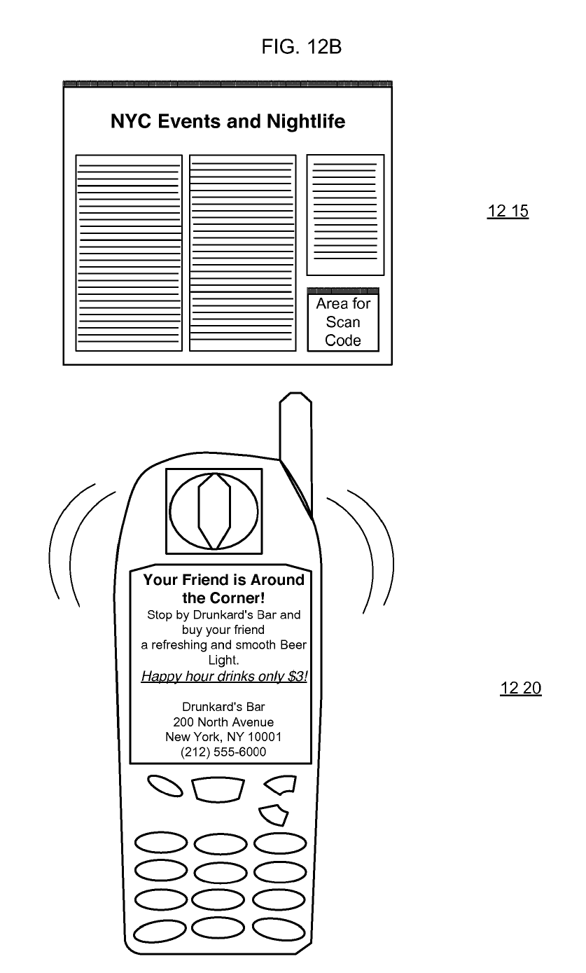

FIGS. 12A and 12B illustrate two examples wherein the CTIS supplies coupons and/or discount info to a user. FIG. 12a illustrates an advertisement (1205) for hay fever medication that contains a scan code. Upon scanning the code, the user's cell phone is supplied with a coupon (1210) for 25% off the advertised medication, along with a nearby store at which to redeem the coupon. FIG. 12B illustrates an article related to events and nightlife in New York City (1215) that contains a scan code. Upon scanning the code to obtain additional content, the user may also be provided with a contextual advertisement for a local bar (1220), including an announcement of happy hour discount prices based on the time of the scan. In an alternative embodiment, the coupon could be provided to the user based on an anticipated provider zone breach rather than a contiguous, causal code scan.

In another embodiment, the CTIS can be used to provide information regarding consumer products that cannot be included on the product packaging. By scanning a code printed on a consumer product package, the user could be provided with nutritional information, ingredients, website links, coupons, etc. Additional advertisements could also be served based on the nature of the product scanned and the user profile. For example, a user who scans a container of mustard and has “grilling” listed among his/her interests may be served an advertisement and/or coupon for hot dogs in addition to the mustard information.

The CTIS provides a targeted information serving system that may be applied to a wide variety of marketing and information dispensation applications. In one embodiment, the CTIS creates enhanced ads with content that cannot be included in a print ad. For example, a user who scans a code related to an automobile ad is provided additional content pertaining to the automobile such as detailed images, video, audio, reviews, and links to additional information. Based on the geocode provided in the Scan Message, the CTIS may provide a list of local dealerships and pricing. Based on the user profile, the CTIS may suggest other automobiles by the same manufacturer that are popular with customers that share the same income bracket, geographic address, number of children, etc. as the user.

In another embodiment, the CTIS provides a means of disseminating targeted information over a large scale. For example, during a widespread emergency, a single 2D matrix code could be broadcast on television. When users scan the code, they are supplied with regional information/instructions, shelter locations, maps, etc. Certain users may be provided even more specific instructions if, for example, their profile lists their occupation as some form of emergency personnel. In an alternative embodiment, the CTIS can provide targeted information to any or all users expected to be in the vicinity of a particular area or event based on their history of space-time trajectories. For example, if a chemical spill occurs and users are projected to be in the vicinity of it, a prior warning to avoid the area can be broadcast to the users' mobile devices. In an alternative embodiment, traffic alerts can be broadcast to the mobile devices of users projected to be in the vicinity of a high-traffic area before they are stuck there. The CTIS may supply targeted Ads, including coupons, for nearby businesses, restaurants, coffee shops, etc. to these users for them to solicit while they wait for traffic to disperse. In general, just as the CTIS can provide information to users about where they should go (e.g., Ad provider locations), it can also warn them to stay out of areas that they should not go, all based on the projected user trajectories.

In another embodiment, the CTIS provides an efficient mechanism of serving real estate listings. For example, when a user scans a code related to real estate listings, the CTIS supplies him/her with advertisements and/or listings that are close to their geographic location and appropriate to their demographic profile (i.e., income, marital status, number of children, etc.). In addition, the CTIS may provide additional listings to the user based on projected breaches of zones corresponding to available homes or apartments that suit the user's profile.

In another embodiment, the CTIS expedites software downloads to a user's mobile device. For example, by scanning a 2D matrix code in an ad for a cell phone ringtone version of a popular song, the user can automatically download the ringtone to the cell phone with which they scan the code. The transaction is recorded in the user profile and may result in the display of an advertisement related to the latest album by the artist who recorded the ringtone song, or an album by a related artist, at some future time.

In another embodiment, the CTIS allows for reduced use of printed space in media publications. For example, an ordinary printed article or advertisement may be supplanted by a 2D matrix code that supplies the content directly to the user's mobile display device. Furthermore, the supplied content may be dressed with additional content that is specifically chosen for the user based on his/her profile or current location, thus increasing the value and utility of the content while still utilizing significantly reduced print space. This increased content value, coupled with the reduction in print space, may translate to significantly increased advertising revenue for media publications. In another embodiment, scan codes may be placed in web-based ads so that users may scan those ads with their mobile device. In another embodiment, scan codes may be placed in television-based ads.

In another embodiment, the CTIS provides a means to supply urgent or breaking information. For example, a breaking news story that arrives too late to be included as a printed article can still be incorporated into a publication via a 2D matrix code. Publications could even have a permanent code in each issue that users can scan in order to access timely breaking and/or supplemental news for which there was a lack of space or time to include in the printed publication.

FIG. 24 of the present disclosure illustrates inventive aspects of a code triggered information server controller (2401) in a block diagram. In this embodiment, the code triggered information server controller (2401) may serve to aggregate, process, store, search, serve, identify, instruct, generate, match, and/or update Scan Messages, Reply Messages, Ads, user profiles, and/or other related data.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Servers, Computers, Clients, Networks, Routers

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer, memory storage into which data may be saved, and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the code triggered information server controller (2401) may be connected to and/or communicate with entities such as, but not limited to: one or more users from user input devices (2411), peripheral devices (2412), a cryptographic processor device (2428), and/or a communications network (2413).

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The code triggered information server controller (2401) may be based on common computer systems that may comprise, but are not limited to, components such as a computer systemization (2402) connected to memory (2429).

Computer Systemization

A computer systemization (2402) may comprise a clock (2430), central processing unit (CPU) (2403), a read only memory (ROM) (2406), a random access memory (RAM) (2405), and/or an interface bus (2407), and most frequently, although not necessarily, are all interconnected and/or communicating through a system bus (2404). Optionally, the computer systemization may be connected to an internal power source (2486). Optionally, a cryptographic processor (2426) may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the code triggered information server controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source (2486) may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell (2486) is connected to at least one of the interconnected subsequent components of the code triggered information server thereby providing an electric current to all subsequent components. In one example, the power source (2486) is connected to the system bus component (2404). In an alternative embodiment, an outside power source (2486) is provided through a connection across the input/output (I/O) (2408) interface. For example, a USB and/or IEEE (1394) connection carries both data and power across the connection and is therefore a suitable source of power.

Interface Adapters

Interface bus(ses) (2407) may accept, connect, and/or communicate to a number of interface adapters, conventionally although not necessarily in the form of adapter cards, such as but not limited to: input output interfaces (I/O) (2408), storage interfaces (2409), network interfaces (2410), and/or the like. Optionally, cryptographic processor interfaces (2427) similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces (2409) may accept, communicate, and/or connect to a number of storage devices such as, but not limited to: storage devices (2414), removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) (1394), fiber channel, Small Computer Systems Interface (SCSI), Universal Serial Bus (USB), and/or the like.

Network interfaces (2410) may accept, communicate, and/or connect to a communications network (2413). Through a communications network (2413), the code triggered information server controller is accessible through remote clients (2433b) (e.g., computers with web browsers) by users (2433a). Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection, the Internet, a Local Area Network (LAN), a Metropolitan Area Network (MAN), an Operating Missions as Nodes on the Internet (OMNI), a secured custom connection, a Wide Area Network (WAN), a wireless network (e.g., employing protocols such as, but not limited to a Wireless Application Protocol (WAP), I-mode, and/or the like), and/or the like. A network interface may be regarded as a specialized form of an input output interface. Further, multiple network interfaces (2410) may be used to engage with various communications network types (2413). For example, multiple network interfaces may be employed to allow for the communication over broadcast, multicast, and/or unicast networks.

Input Output interfaces (I/O) (2408) may accept, communicate, and/or connect to user input devices (2411), peripheral devices (2412), cryptographic processor devices (2428), and/or the like. I/O may employ connection protocols such as, but not limited to: Apple Desktop Bus (ADB), Apple Desktop Connector (ADC), audio: analog, digital, monaural, RCA, stereo, and/or the like, IEEE 1394a-b, infrared, joystick, keyboard, midi, optical, PC AT, PS/2, parallel, radio, serial, USB, video interface: BNC, coaxial, composite, digital, Digital Visual Interface (DVI), RCA, RF antennae, S-Video, VGA, and/or the like, wireless, and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices (2411) may be card readers, dongles, finger print readers, gloves, graphics tablets, joysticks, keyboards, mouse (mice), remote controls, retina readers, trackballs, trackpads, and/or the like.

Peripheral devices (2412) may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the code triggered information server controller may be embodied as an embedded, dedicated, and/or monitor-less (i.e., headless) device, wherein access would be provided over a network interface connection.

Cryptographic units such as, but not limited to, microcontrollers, processors (2426), interfaces (2427), and/or devices (2428) may be attached, and/or communicate with the code triggered information server controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory (2429). However, memory is a fungible technology and resource, thus, any number of memory embodiments may be employed in lieu of or in concert with one another. It is to be understood that the code triggered information server controller and/or a computer systemization may employ various forms of memory (2429). For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory (2429) will include ROM (2406), RAM (2405), and a storage device (2414). A storage device (2414) may be any conventional computer system storage. Storage devices may include a drum, a (fixed and/or removable) magnetic disk drive, a magneto-optical drive, an optical drive (i.e., CD ROM/RAM/Recordable (R), ReWritable (RW), DVD R/RW, etc.), an array of devices (e.g., Redundant Array of Independent Disks (RAID)), and/or other devices of the like. Thus, a computer systemization generally requires and makes use of memory.

Component Collection

The memory (2429) may contain a collection of program and/or database components and/or data such as, but not limited to: operating system component(s) (2415) (operating system), information server component(s) 2416 (information server), user interface component(s) (2417) (user interface), Web browser component(s) (2418) (Web browser), database(s) (2419), mail server component(s) (2421), mail client component(s) (2422), cryptographic server component(s) (2420) (cryptographic server), the code triggered information server component(s) (2435), and/or the like (i.e., collectively a component collection). These components may be stored and accessed from the storage devices and/or from storage devices accessible through an interface bus. Although non-conventional program components such as those in the component collection, typically, are stored in a local storage device (2414), they may also be loaded and/or stored in memory such as: peripheral devices, RAM, remote storage facilities through a communications network, ROM, various forms of memory, and/or the like.

Operating System

The operating system component (2415) is an executable program component facilitating the operation of the code triggered information server controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NTNista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the code triggered information server controller to communicate with other entities through a communications network (2413). Various communication protocols may be used by the code triggered information server system controller as a subcarrier transport mechanism for interaction, such as, but not limited to: multicast, TCP/IP, UDP, unicast, and/or the like.

Information Server

An information server component (2416) is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP), HyperText Transfer Protocol (HTTP), Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the code triggered information server controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the code triggered information server database (2419), operating systems, other program components, user interfaces, Web browsers, and/or the like.

Access to the code triggered information server database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the code triggered information server. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the code triggered information server as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component (2417) is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component (2418) is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the code triggered information server enabled nodes. The combined application may be nugatory on systems employing standard Web browsers.

Mail Server

A mail server component (2421) is a stored program component that is executed by a CPU (2403). The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the code triggered information server.

Access to the code triggered information server mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component (2422) is a stored program component that is executed by a CPU (2403). The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component (2420) is a stored program component that is executed by a CPU (2403), cryptographic processor (2426), cryptographic processor interface (2427), cryptographic processor device (2428), and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the code triggered information server may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the code triggered information server component to engage in secure transactions if so desired. The cryptographic component facilitates the secure accessing of resources on the code triggered information server and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Code Triggered Information Server Database

The code triggered information server database component (2419) may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the code triggered information server database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the code triggered information server database is implemented as a data-structure, the use of the code triggered information server database (2419) may be integrated into another component such as the code triggered information server component (2435). Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component (2419) includes several tables (2419a,b). A user profile table (2419a) includes fields such as, but not limited to: a user ID, name, e-mail address, address, demographic profile, hardware ID, scan history record, scan statistics, and/or the like. The user profile table may support and/or track multiple entity accounts on a code triggered information server. An Information Base table (2419b) includes fields such as, but not limited to: Ad provider ID, Ad ID, Ad content, Ad labels, geographic tags, temporal tags, subject tags, Ad ratings, Ad statistics, and/or the like.

In one embodiment, the code triggered information server database may interact with other database systems. For example, employing a distributed database system, queries and data access by OLBS modules may treat the combination of the code triggered information server database, an integrated data security layer database as a single database entity.

In one embodiment, user programs may contain various user interface primitives, which may serve to update the code triggered information server. Also, various accounts may require custom database tables depending upon the environments and the types of clients the code triggered information server may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components (2419a,b). The code triggered information server may be configured to keep track of various settings, inputs, and parameters via database controllers.

The code triggered information server database may communicate to and/or with other components in a component collection, including itself, and/or facilities of the like. Most frequently, the code triggered information server database communicates with the code triggered information server component, other program components, and/or the like. The database may contain, retain, and provide information regarding other nodes and data.

The Code Triggered Information Server

The code triggered information server component (2435) is a stored program component that is executed by a CPU. The code triggered information server affects accessing, obtaining and the provision of information, services, transactions, and/or the like across various communications networks.

The code triggered information server component enables the identification, generation, and aggregation of Scan Messages and Reply Messages.

The code triggered information server component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the code triggered information server employs a cryptographic server to encrypt and decrypt communications. The code triggered information server component may communicate to and/or with other components in a component collection, including itself, and/or facilities of the like. Most frequently, the code triggered information server component communicates with the code triggered information server database, operating systems, other program components, and/or the like. The code triggered information server may contain, communicate, generate, obtain, and/or provide program component, system, user, and/or data communications, requests, and/or responses.

Distributed Code Triggered Information Server

The structure and/or operation of any of the code triggered information server node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the code triggered information server controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

Any reference to claim elements in the singular, for example, using the articles “a,” “an” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A processor-implemented method to transform image data to a decoded image record, the method comprising:
receiving via a processor target image data from a client device;
receiving via the processor ancillary image data associated with the target image data;
determining via the processor one or more enhancement parameters using the target image data and the ancillary image data;
augmenting via the processor the target image data in accordance with the one or more enhancement parameters;
querying a code database using the augmented target image data;
determining via the processor at least one trending pattern associated with at least one of the target image data and the ancillary image data when the code database returns a plurality of possible matching codes; and
selecting via the processor using the at least one trending pattern a code from the plurality of possible matching codes; and
saving the selected code in a decoded image record.

2. The method of claim 1, wherein the ancillary image data is selected from the group consisting of a client device type, a time of day of the creation of the image data, an image type, ambient conditions of the location from which the image data was captured, an incoming reception method, geographic information, and IP address information.

3. The method of claim 1, wherein the at least one trending pattern is selected from the group consisting of a trending pattern of successfully decoded codes, a trending pattern of unsuccessfully decoded codes, a trending pattern of successfully corrected codes, a trending pattern of a scan location, a trending pattern of a particular code scan, and a trending pattern relating ancillary image data to a particular code scan.

4. The method of claim 1, wherein selecting via the processor using the at least one trending pattern a code from the plurality of possible matching code comprises:
generating a probability distribution of possible match codes; and
selecting the possible matching code having the highest probability of matching the target image.

5. The method of claim 1, wherein determining via the processor one or more enhancement parameters using the target image data and the ancillary data comprises:
determining via the processor whether to apply a preprocessing operation on the target image data;
selecting via the processor at least one preprocessing operation to perform on the target image data when the determination is to apply the preprocessing operation, wherein the selecting is performed at least in part using the ancillary image data; and
using by the processor the selected at least one preprocessing operation to change the target image data.

6. The method of claim 5, wherein the at least one preprocessing operation is selected from the group consisting of changing the image saturation, changing the image orientation, changing the image skew, changing the image color level, changing the image contrast, changing the image brightness, changing the image sharpeness, changing the image blur, cropping the image, and changing the image size.

7. The method of claim 1 further comprising:
receiving by the processor a message from the code database that no possible matching codes were found;
identifying by the processor a code image within a portion of the code image data; and
cropping by the processor the code image data to isolate the code image.

8. The method of claim 7 further comprising:
determining via the processor whether to apply a preprocessing operation on the isolated image;
selecting via the processor at least one preprocessing operation to perform on the isolated image when the determination is to apply the preprocessing operation, wherein the selecting is performed at least in part using the ancillary image data; and
using by the processor the selected at least one preprocessing operation to change the isolated image.

9. The method of claim 8, wherein the at least one preprocessing operation is selected from the group consisting of changing the image saturation, changing the image orientation, changing the image skew, changing the image color level, changing the image contrast, changing the image brightness, changing the image sharpeness, changing the image blur, cropping the image, and changing the image size.

10. A system for transforming image data to a decoded image record comprising:
an image record datastore;
a server comprising a processor and a memory, wherein the memory is in communication with the processor and contains program instructions that when executed by the processor cause the server to perform operations comprising:
receiving target image data from a client device;
receiving ancillary image data associated with the target image data;
determining one or more enhancement parameters using the target image data and the ancillary image data;
augmenting the target image data in accordance with the one or more enhancement parameters;
querying a code database using the augmented target image data;
determining at least one trending pattern associated with at least one of the target image data and the ancillary image data when the code database returns a plurality of possible matching codes; and
selecting using the at least one trending pattern a code from the plurality of possible matching codes; and
saving the selected code in a decoded image record in the image record datastore.

11. The system of claim 10, wherein the ancillary image data is selected from the group consisting of a client device type, a time of day of the creation of the image data, an image type, ambient conditions of the location from which the image data was captured, an incoming reception system, geographic information, and IP address information.

12. The system of claim 10, wherein the at least one trending pattern is selected from the group consisting of a trending pattern of successfully decoded codes, a trending pattern of unsuccessfully decoded codes, a trending pattern of successfully corrected codes, a trending pattern of a scan location, a trending pattern of a particular code scan, and a trending pattern relating ancillary image data to a particular code scan.

13. The system of claim 10, wherein the instruction for selecting via the processor using the at least one trending pattern a code from the plurality of possible matching code comprises instructions for:
generating a probability distribution of possible match codes; and
selecting the possible matching code having the highest probability of matching the target image.

14. The system of claim 10, the instruction for determining via the processor one or more enhancement parameters using the target image data and the ancillary data comprises instructions for:
determining via the processor whether to apply a preprocessing operation on the target image data;
selecting via the processor at least one preprocessing operation to perform on the target image data when the determination is to apply the preprocessing operation, wherein the selecting is performed at least in part using the ancillary image data; and
using by the processor the selected at least one preprocessing operation to change the target image data.

15. The system of claim 14, wherein the at least one preprocessing operation is selected from the group consisting of changing the image saturation, changing the image orientation, changing the image skew, changing the image color level, changing the image contrast, changing the image brightness, changing the image sharpeness, changing the image blur, cropping the image, and changing the image size.

16. The system of claim 10 further comprising program instructions that when executed by the processor cause the server to perform operations comprising:
receiving by the processor a message from the code database that no possible matching codes were found;
identifying by the processor a code image within a portion of the code image data; and
cropping by the processor the code image data to isolate the code image.

17. The system of claim 16 further comprising program instructions that when executed by the processor cause the server to perform operations comprising:
determining via the processor whether to apply a preprocessing operation on the isolated image;
selecting via the processor at least one preprocessing operation to perform on the isolated image when the determination is to apply the preprocessing operation, wherein the selecting is performed at least in part using the ancillary image data; and
using by the processor the selected at least one preprocessing operation to change the isolated image.

18. The system of claim 17, wherein the at least one preprocessing operation is selected from the group consisting of changing the image saturation, changing the image orientation, changing the image skew, changing the image color level, changing the image contrast, changing the image brightness, changing the image sharpeness, changing the image blur, cropping the image, and changing the image size.
